(19) United States
(12) Patent Application Publication
(10) Pub. No.: US 2026/0310464 A1
(43) Pub. Date: Oct. 8, 2026

(54) PROCESSING-IN-MEMORY SYSTEM INCLUDING SCALE-UP ARCHITECTURE

(71) Applicant: SK hynix Inc., Icheon-si Gyeonggi-do (KR)

(72) Inventors: Gu Hyun KIM, Icheon-si Gyeonggi-do (KR); Nah Sung KIM, Icheon-si Gyeonggi-do (KR); Chang Hyun KIM, Icheon-si Gyeonggi-do (KR); Gyeong Cheol SHIN, Icheon-si Gyeonggi-do (KR); Woo Jae SHIN, Icheon-si Gyeonggi-do (KR)

(73) Assignee: SK hynix Inc., Icheon-si Gyeonggi-do (KR)

(21) Appl. No.: 19/320,891

(22) Filed: Sep. 5, 2025

(30) Foreign Application Priority Data
Apr. 8, 2025 (KR) 10-2025-0045743

(51) Int. Cl. G06F 9/30; G06F 7/544; G06F 9/355; G06F 17/16

(52) U.S. Cl. CPC G06F 9/30145; G06F 7/5443; G06F 9/355; G06F 17/16

(57) ABSTRACT

A processing-in-memory (PIM) system includes a plurality of PIM devices, and a PIM-centric system configured to control the plurality of PIM devices. The PIM-centric system includes an instruction decoder and sequencer configured to receive a macro instruction and generate and output a plurality of micro instructions based on the macro instruction, a multicast interconnect configured to output one or more sub-micro instruction sets based on the plurality of micro instructions, and a plurality of PIM controllers each coupled to the plurality of PIM devices via a plurality of channels, the plurality of PIM controllers configured to generate and output one or more PIM command sets based on the one or more sub-micro instruction sets.

### CROSS-REFERENCE TO RELATED APPLICATION

The present application claims priority under 35 U.S.C § 119 (a) to Korean Application number 10-2025-0045743, filed in the Korean Intellectual Property Office on Apr. 8, 2025, the entire contents of which application is incorporated herein by reference.

### BACKGROUND

### 1. Technical Field

Various embodiments of the present teachings generally relate to a processing-in-memory system, and more particularly, to a processing-in-memory system including a scale-up architecture.

### 2. Related Art

Large language model (LLM) systems are complex artificial intelligence (AI) models designed to understand and generate human-like text based on massive volumes of training data. These models utilize deep learning techniques, particularly neural networks, to analyze linguistic patterns and generate coherent and contextually appropriate text. A key feature of LLMs lies in their scale, which enables the models to capture complex linguistic structures and nuances through training on datasets comprising billions of words. Consequently, a scale-up of processing-in-memory (PIM) systems responsible for executing operations applied to LLMs is required. Furthermore, in PIM systems having a scale-up architecture, various approaches for efficiently controlling a large number of PIM devices are also required.

### SUMMARY

A PIM system according to an embodiment of the present disclosure may include a plurality of PIM devices, and a PIM-centric system configured to control the plurality of PIM devices. The PIM-centric system may include an instruction decoder and sequencer configured to receive a macro instruction and generate and output a plurality of micro instructions based on the macro instruction, a multicast interconnect configured to output one or more sub-micro instruction sets based on the plurality of micro instructions, and a plurality of PIM controllers each coupled to the plurality of PIM devices via a plurality of channels, the plurality of PIM controllers configured to generate and output one or more PIM command sets based on the one or more sub-micro instruction sets.

A PIM system according to an embodiment of the present disclosure may include a PIM system comprising a plurality of processing-in-memory (PIM) devices, and a PIM-centric system configured to control the plurality of PIM devices. The PIM-centric system may include a multicast interconnect configured to receive a macro instruction and generate and output one or more sub-macro instructions based on the macro instruction, a plurality of instruction decoders and sequencers configured to generate and output one or more micro instruction sets based on the one or more sub-macro instructions, and a plurality of PIM controllers, each coupled to one of the plurality of PIM devices via a corresponding one of a plurality of channels, configured to generate and output one or more PIM command sets based on the one or more micro instruction sets.

A PIM system according to an embodiment of the present disclosure may include a plurality of processing-in-memory (PIM) devices, and a PIM-centric system configured to control the plurality of PIM devices. The PIM-centric system may include a first-level instruction decoder and sequencer configured to receive a macro instruction and generate and output a first-level micro instruction based on the macro instruction, a second-level instruction decoder and sequencer configured to generate and output a second-level micro instruction set based on the first-level micro instruction, a multicast interconnect configured to generate and output one or more sub-micro instruction sets based on the second-level micro instruction set, and a plurality of PIM controllers configured to generate one or more PIM command sets based on the one or more sub-micro instruction sets and to output the one or more PIM command sets to the plurality of PIM devices.

A PIM system according to an embodiment of the present disclosure may include a plurality of processing-in-memory (PIM) devices, and a PIM-centric system coupled to the plurality of PIM devices via a plurality of channels to control the plurality of PIM devices. The PIM-centric system may include a multicast interconnect configured to receive a macro instruction and to generate and output one or more sub-macro instructions based on the macro instruction, a plurality of first-level instruction decoders and sequencers configured to generate and output one or more first-level micro instructions based on the one or more sub-macro instructions, a plurality of second-level instruction decoders and sequencers configured to generate and output one or more second-level micro instruction sets based on the one or more first-level micro instructions, and a plurality of PIM controllers configured to generate and output one or more PIM command sets based on the one or more second-level micro instruction sets.

### BRIEF DESCRIPTION OF THE DRAWINGS

FIG. 1 is a block diagram illustrating an embodiment of a processing-in-memory (PIM) system according to the present disclosure.

FIG. 2 is a block diagram illustrating an example of a PIM device included in the PIM system of FIG. 1.

FIG. 3 is a diagram illustrating an example of a processing unit included in the PIM device of FIG. 2.

FIGS. 4 to 6 are diagrams illustrating various examples of channel masks included in macro instructions and channel masks included in micro instructions generated by an instruction decoder and sequencer.

FIG. 7 is a diagram illustrating an example of a first macro instruction used in the PIM system according to the present disclosure.

FIGS. 8 to 10 are diagrams illustrating a process of executing the first macro instruction of FIG. 7 in the PIM system of FIG. 1.

FIG. 11 is a diagram illustrating a second macro instruction used in the PIM system according to the present disclosure.

FIGS. 12 to 14 are diagrams illustrating an example process of executing the second macro instruction of FIG. 11 in the PIM system of FIG. 1.

FIGS. 15 to 18 are diagrams illustrating another example process of executing the second macro instruction of FIG. 11 in the PIM system of FIG. 1.

FIG. 19 is a diagram illustrating a third macro instruction used in the PIM system according to the present disclosure.

FIGS. 20 to 23 are diagrams illustrating an example process of executing the third macro instruction of FIG. 19 in the PIM system of FIG. 1.

FIGS. 24 to 27 are diagrams illustrating another example process of executing the third macro instruction of FIG. 19 in the PIM system of FIG. 1.

FIG. 28 is a diagram illustrating a fourth macro instruction used in the PIM system according to the present disclosure.

FIGS. 29 to 31 are diagrams illustrating a process of executing the fourth macro instruction of FIG. 28 in the PIM system of FIG. 1.

FIG. 32 is a block diagram illustrating another embodiment of the PIM system according to the present disclosure.

FIGS. 33 to 35 are diagrams illustrating a process of executing the first macro instruction of FIG. 7 in the PIM system of FIG. 32.

FIGS. 36 to 39 are diagrams illustrating an example process of executing the second macro instruction of FIG. 11 in the PIM system of FIG. 32.

FIGS. 40 to 42 are diagrams illustrating another example process of executing the second macro instruction of FIG. 11 in the PIM system of FIG. 32.

FIGS. 43 to 46 are diagrams illustrating an example process of executing the third macro instruction of FIG. 19 in the PIM system of FIG. 32.

FIGS. 47 to 49 are diagrams illustrating another example process of executing the third macro instruction of FIG. 19 in the PIM system of FIG. 32.

FIGS. 50 to 52 are diagrams illustrating a process of executing the fourth macro instruction of FIG. 28 in the PIM system of FIG. 32.

FIG. 53 is a block diagram illustrating yet another embodiment of the PIM system according to the present disclosure.

FIG. 54 is a diagram illustrating an example operation of a first-level instruction decoder and sequencer included in the PIM system of FIG. 53.

FIG. 55 is a block diagram illustrating another embodiment of the PIM system according to the present disclosure.

FIG. 56 is a diagram illustrating an example operation of a multicast interconnect included in the PIM system of FIG. 55.

FIG. 57 is a block diagram illustrating still another embodiment of the PIM system according to the present disclosure.

### DETAILED DESCRIPTION

Terms such as “first” and “second” are used to distinguish between various elements and do not imply size, order, priority, quantity, or importance of the elements. For example, a first element may be referred to as a second element in one example, and the second element may be referred to as a first element in another example.

When an element is referred to as “connected” or “coupled” to another element, the elements may be connected directly or through one or more intervening elements between the elements. When two elements are referred to as “directly connected” or “directly coupled,” one element is directly connected or directly coupled to the other element without an intervening element between the two elements.

Terms such as “over,” “on,” “inside,” “higher,” “high,” “low,” “left,” “right,” “column,” “row,” “level,” and other terms implying relative spatial relationship or orientation are utilized only for the purpose of ease of description or reference to a drawing and are not otherwise limiting.

Embodiments of the present disclosure are described in detail with reference to the accompanying drawings. Specific structural or functional descriptions of embodiments are provided as examples for illustrative purposes to describe concepts that are disclosed in the present application. Examples or embodiments in accordance with the concepts may be carried out in various forms, and the scope of the present disclosure is not limited to the examples or embodiments described in this specification.

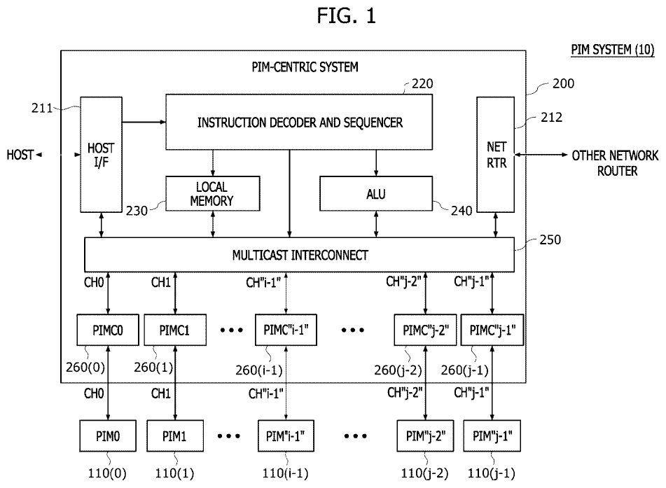

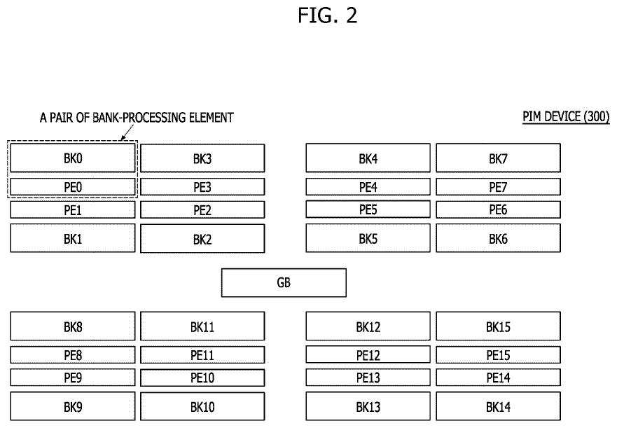

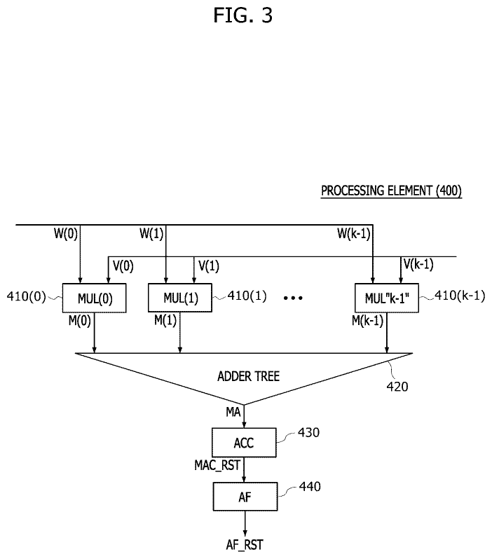

FIG. 1 is a block diagram illustrating an embodiment of a processing-in-memory (PIM) system according to the present disclosure. FIG. 2 is a block diagram illustrating an example of a PIM device included in the PIM system of FIG. 1. And FIG. 3 is a diagram illustrating an example of a processing unit included in the PIM device of FIG. 2.

Referring to FIG. 1, a PIM system 10 includes a plurality of PIM devices, such as first through j-th PIM devices 110(0) to 110(j−1), and a PIM-centric system 200. Here, “j” denotes a natural number equal to or greater than 2. The first through j-th PIM devices 110(0) to 110(j−1) are respectively coupled to the PIM-centric system 200 through first through j-th channels CH0 to CH“j−1.” The first through j-th channels CH0 to CH“j−1” represent physical connections between the first through j-th PIM devices (PIM0 to PIM“j−1”) 110(0) to 110(j−1) and the PIM-centric system 200. Each of the first through j-th channels CH0 to CH“j−1” is configured to have an independent data bus. Accordingly, signal transmission between the first through j-th PIM devices 110(0) to 110(j−1) and the PIM-centric system 200 may be performed in parallel through the respective first through j-th channels CH0 to CH“j−1.” As illustrated in FIG. 1, the first PIM device 110(0) is coupled to the PIM-centric system 200 through the first channel CH0. The second PIM device 110(1) is coupled to the PIM-centric system 200 through the second channel CH1. The third PIM device 110(2) is coupled to the PIM-centric system 200 through the third channel CH2. The “j−1”-th PIM device 110(j−2) is coupled to the PIM-centric system 200 through the “j−1”-th channel CH“j−2.” The j-th PIM device 110(j−1) is coupled to the PIM-centric system 200 through the j-th channel CH“j−1.” Although not shown in the drawing, in another embodiment, two or more PIM devices may share a single channel to be coupled to the PIM-centric system 200. In this case, the PIM system 10 may include a number of PIM devices corresponding to a multiple of “j.”

In one embodiment, each of the first through j-th PIM devices 110(0) to 110(j−1) may be configured in the form of a die. Although not shown in the drawing, in one embodiment, two of the first through j-th PIM devices 110(0) to 110(j−1) may be packaged together into a single package. For example, a first PIM device 110(0) and a second PIM device 110(1) may constitute a first PIM package. A third PIM device 110(2) and a fourth PIM device (not shown) may constitute a second PIM package. In the same manner, a “j−1”-th PIM device 110(“j−2”) and a j-th PIM device 110(j−1) may constitute a “j/2”-th PIM package. In one embodiment, the PIM system 10 may be configured in the form of a card in which the first through j-th PIM devices 110(0) to 110(j−1) and the PIM-centric system 200 are mounted on the same board.

Referring to FIG. 2, a PIM device 300 may include a plurality of memory banks, such as first through sixteenth memory banks BK0 to BK15, a global buffer GB, and a plurality of processing elements, such as first through sixteenth processing elements PE0 to PE15. The following description of the PIM device 300 may be equally applied to the first through j-th PIM devices 110(0) to 110(j−1) included in the PIM system 10 of FIG. 1. In one example, the first through sixteenth memory banks BK0 to BK15 may be memory arrays or groups of memory arrays constituting dynamic random access memory (DRAM). Accordingly, the first through sixteenth memory banks BK0 to BK15 may operate independently of each other. Each of the first through sixteenth memory banks BK0 to BK15 may include a plurality of rows and a plurality of columns. Each of the plurality of rows may be designated by a row address, and each of the plurality of columns may be designated by a column address. In one embodiment, the first through sixteenth memory banks BK0 to BK15 may store weight data used as operands for matrix-vector multiplication operations.

The global buffer GB may include a plurality of storage regions, such as a plurality of registers. Each of the storage regions of the global buffer GB may be designated by a column address. That is, a specific column of the first through sixteenth memory banks BK0 to BK15 and a specific storage region of the global buffer GB may be designated by the column address. In one embodiment, the global buffer GB may store vector data used as operands for matrix-vector multiplication operations. In one embodiment, the global buffer GB may have a storage capacity equal to the page size of each of the first through sixteenth memory banks BK0 to BK15. In another embodiment, the global buffer GB may have a storage capacity smaller than or larger than the page size of each of the first through sixteenth memory banks BK0 to BK15.

The first through sixteenth processing elements PE0 to PE15 are respectively coupled to the first through sixteenth memory banks BK0 to BK15. For example, a first processing element PE0 is coupled to a first memory bank BK0. A second processing element PE1 is coupled to a second memory bank BK1. Similarly, a sixteenth processing element PE15 is coupled to a sixteenth memory bank BK15. On the other hand, the first through sixteenth processing elements PE0 to PE15 are commonly coupled with the global buffer GB.

The first through sixteenth processing elements PE0 to PE15 may respectively receive first operation data, such as sets of weight data, from the first through sixteenth memory banks BK0 to BK15. For example, the first processing element PE0 may receive a first set of weight data from the first memory bank BK0. The second processing element PE1 may receive a second set of weight data from the second memory bank BK1. Similarly, the sixteenth processing element PE15 may receive a sixteenth set of weight data from the sixteenth memory bank BK15. The first through sixteenth processing elements PE0 to PE15 may commonly receive second operation data, such as vector data, from the global buffer GB. Using the sets of weight data received respectively from the first through sixteenth memory banks BK0 to BK15 and the vector data received from the global buffer GB, the first through sixteenth processing elements PE0 to PE15 may perform operation actions such as multiplication-accumulation (MAC).

In the present example, the PIM device 300 is described as including the same number of memory banks BK0 to BK15 and processing elements PE0 to PE15, but this is merely one example. In other embodiments, the PIM device 300 may include different numbers of memory banks and processing elements. For example, the PIM device 300 may have a structure in which two memory banks share one processing element. In this case, the number of processing elements may be half the number of memory banks. Alternatively, the PIM device 300 may have a structure in which four memory banks share one processing element. In this case, the number of processing elements may be one-fourth the number of memory banks.

Referring to FIG. 3, a processing element 400 may include a multiplication circuit, an addition circuit, an accumulator (ACC) 430, and an activation function circuit (AF) 440. The multiplication circuit may include first through “k”-th multipliers (MUL(0) to MUL(k−1)) 410(0) to 410(k−1), where “k” denotes a natural number equal to or greater than 2. The addition circuit may be configured as an adder tree 420 including a plurality of adders. The following description of the processing element 400 may be equally applied to the first through sixteenth processing elements PE0 to PE15 included in the PIM device 300 of FIG. 2.

The first through “k”-th multipliers 410(0) to 410(k−1) respectively receive first through “k”-th weight data W(0) to W(k−1) from the memory banks. The first through “k”-th multipliers 410(0) to 410(k−1) respectively receive first through “k”-th vector data V(0) to V(k−1) from the global buffer. The first through “k”-th multipliers 410(0) to 410(k−1) respectively perform multiplication operations on the corresponding weight data W(0) to W(k−1) and the corresponding vector data V(0) to V(k−1) to output first through “k”-th multiplication data M(0) to M(k−1). Specifically, the first multiplier 410(0) performs a multiplication operation on the first weight data W(0) and the first vector data V(0) to output first multiplication data M(0). The second multiplier 410(1) performs a multiplication operation on the second weight data W(1) and the second vector data V(1) to output second multiplication data M(1). Similarly, the “k”-th multiplier 410(k−1) performs a multiplication operation on the “k”-th weight data W(k−1) and the “k”-th vector data V(k−1) to output “k”-th multiplication data M(k−1).

The adder tree 420 receives the first through “k”-th multiplication data M(0) to M(k−1) output from the first through “k”-th multipliers 410(0) to 410(k−1). The adder tree 420 performs addition operations on the first through “k”-th multiplication data M(0) to M(k−1). The adder tree 420 outputs the resulting data generated by the addition operations as multiplication-accumulation data MA. Although omitted in FIG. 3, the adder tree 420 may include a plurality of adders arranged in a tree structure. The adder tree 420 transmits the multiplication-accumulation data MA to the accumulator 430.

The accumulator 430 may include an accumulation adder and a latch circuit. The accumulation adder performs an accumulation operation by adding the multiplication-accumulation data MA transmitted from the adder tree 420 and the latch data fed back from the latch circuit, thereby generating accumulated addition data. The latch circuit latches the accumulated addition data generated by the accumulation adder. The accumulated addition data latched in the latch circuit is fed back to the accumulation adder as latch data in the next MAC operation process. When all MAC operations are completed, the latch circuit outputs the latched accumulated addition data as MAC result data MAC_RST.

The activation function circuit 440 may receive the MAC result data (MAC_RST) from the accumulator 430. The activation function circuit 440 may perform activation function processing on the MAC result data (MAC_RST) to output activation function processed result data (AF_RST). By the activation function processing, the activation function processed result data (AF_RST) may acquire non-linearity. In one embodiment, the activation function processing may be performed using a sigmoid function, a hyperbolic tangent function, a rectified linear unit (ReLU) function, a leaky ReLU function, or a Swish function.

Referring again to FIG. 1, the PIM-centric system 200 controls operations of the first through j-th PIM devices 110(0) to 110(j−1). The PIM-centric system 200 may be coupled to a host. The PIM-centric system 200 may also be coupled to another PIM-centric system included in a different PIM system. The PIM-centric system 200 may receive a macro instruction from the host. Based on the macro instruction transmitted from the host, the PIM-centric system 200 may generate one or more sets of PIM commands. The PIM-centric system 200 may transmit one or more sets of PIM commands to one or more of the first through j-th PIM devices 110(0) to 110(j−1).

In one embodiment, the macro instruction transmitted to the PIM-centric system 200 may have a payload format that does not include a header or metadata. In other embodiments, the macro instruction may have a format distinguished based on a target address. In one embodiment, the macro instruction may be one of a first macro instruction, a second macro instruction, a third macro instruction, and a fourth macro instruction. The first through fourth macro instructions may each include an operation type. The operation type included in the first macro instruction may be designated as a first operation type, such as “MAC,” which requests execution of a MAC operation in the first through j-th PIM devices 110(0) to 110(j−1). The operation type included in the second macro instruction and the third macro instruction may be designated as a second operation type, such as “WRGB,” which requests a global buffer write operation to store vector data into the global buffers included in the first through j-th PIM devices 110(0) to 110(j−1). In one embodiment, the vector data may be used as operands in a matrix-vector multiplication (GEMV) operation. The operation type included in the fourth macro instruction may be designated as a third operation type, such as “WRBIAS,” which requests a bias data write operation to store bias data into latch circuits included in the first through j-th PIM devices 110(0) to 110(j−1). In one embodiment, the bias data may be defined as data that is added to the result value of the matrix-vector multiplication in a multi-layer perceptron (MLP) operation. In one embodiment, the macro instruction may further include a request for a load operation or a store operation on a local memory.

In one embodiment, the first macro instruction may further include, in addition to the operation type designated as the first operation type “MAC,” a number of iterations, a channel mask, a row address, and a column address. The operation number of iterations included in the first macro instruction may specify the number “m” (where “m” is a natural number equal to or greater than 2) indicating how many times the MAC operation is performed. The channel mask included in the first macro instruction may include first through j-th bits respectively corresponding to first through j-th channels. The row address included in the first macro instruction may specify a row of a memory bank in which weight data used as operands in the MAC operation is stored. The column address included in the first macro instruction may specify the starting column position of the memory bank in which the weight data used in the MAC operation is stored.

In one embodiment, the second macro instruction may further include, in addition to the operation type designated as the second operation type “WRGB,” a number of iterations, a channel mask, a local memory address, a column address, and a broadcast bit. The operation number of iterations included in the second macro instruction may specify the number “m” indicating how many times the global buffer write operation is performed. The channel mask included in the second macro instruction may include first through j-th bits respectively corresponding to first through j-th channels. The local memory address included in the second macro instruction may specify a starting storage location of data to be accessed in the local memory. The column address included in the second macro instruction may specify a starting storage location in the global buffers where the vector data is stored. The broadcast bit included in the second macro instruction may be set to a first binary value indicating a broadcasting operation or a second binary value indicating a non-broadcasting operation. In one embodiment, the first binary value may be binary “1,” and the second binary value may be binary “0.”

In one embodiment, the third macro instruction may further include, in addition to the operation type designated as the second operation type “WRGB,” a number of iterations, a channel mask, a local memory address, a column address, a broadcast bit, and a local memory increment size. The operation number of iterations included in the third macro instruction may specify the number “m” indicating how many times the global buffer write operation is performed. The channel mask included in the third macro instruction may include first through j-th bits respectively corresponding to first through j-th channels. The local memory address included in the third macro instruction may specify a starting storage location of data to be accessed in the local memory. The column address included in the third macro instruction may specify a starting storage location in the global buffers where the vector data is stored. The broadcast bit included in the third macro instruction may be set to a first binary value indicating a broadcasting operation or a second binary value indicating a non-broadcasting operation. The local memory increment size included in the third macro instruction may specify a unit size by which the local memory address is incremented.

In one embodiment, the fourth macro instruction may further include, in addition to the operation type designated as the third operation type “WRBIAS,” a channel mask, a local memory address, and a MAC latch ID (identification). The fourth macro instruction may also further include a broadcast bit. The channel mask included in the fourth macro instruction may include first through j-th bits respectively corresponding to first through j-th channels. The local memory address included in the fourth macro instruction may specify a starting storage location of bias data stored in the local memory. The MAC latch ID included in the fourth macro instruction may specify a latch circuit among a plurality of latch circuits included in each of the first through j-th PIM devices 110(0) to 110(j−1), into which the bias data is latched. When the fourth macro instruction includes a broadcast bit, because the bias data provided to each channel of the PIM system 10 is different, the broadcast bit may have a binary value indicating a non-broadcasting transmission method.

In one embodiment, the PIM-centric system 200 may include a host interface (HOST I/F) 211, a network router (NET RTR) 212, an instruction decoder and sequencer (instruction decoder and sequencer) 220, a local memory (local memory) 230, an arithmetic logic unit (ALU) 240, a multicast interconnect (multicast interconnect) 250, and first through j-th PIM controllers 260(0) to 260(j−1).

The host interface 211 performs interfacing with the host. In one embodiment, the host interface 211 may be a PCIe (PCI Express) end-point (PCIe EP). Although not shown in FIG. 1, the PCIe end-point 211 may receive packets transmitted from a root complex of the host. In one embodiment, the PCIe end-point 211 may perform serial-to-parallel conversion processing, decoding processing, framing symbol removal processing, and error detection processing for the packets. The PCIe end-point 211 may transmit the packets to the instruction decoder and sequencer 220 and/or the multicast interconnect 250. In one embodiment, the packets transmitted from the host to the host interface 211 may include a macro instruction. When the macro instruction is transmitted from the host, the host interface 211 may transmit the macro instruction to the instruction decoder and sequencer 220.

The network router 212 may be coupled to a network router included in another PIM-centric system disposed adjacent to the PIM-centric system 200 (hereinafter referred to as “another network router”) to establish a network connection. In one embodiment, the network router 212 may be a chip-to-chip router that performs network communication between chips. The network router 212 may transmit packets received from the multicast interconnect 250 to another network router. The network router 212 may receive packets from another network router and transmit them to the multicast interconnect 250. When the destination of the packet received from another network router is a PIM-centric system other than the PIM-centric system 200, the network router 212 may further transmit the received packet to yet another network router.

The instruction decoder and sequencer 220 may receive a macro instruction transmitted from the host to the PIM-centric system 200 through the host interface 211. The instruction decoder and sequencer 220 may include an instruction decoder and an instruction sequencer. In one embodiment, the instruction decoder may decode the macro instruction received from the host to generate a plurality of micro instructions. The instruction sequencer may transmit the plurality of micro instructions generated by the instruction decoder to the multicast interconnect 250. In another embodiment, the instruction decoder may decode the macro instruction received from the host to generate a plurality of local memory instructions and a plurality of micro instructions. The instruction sequencer may transmit the local memory instructions generated by the instruction decoder to the local memory 230 and transmit the plurality of micro instructions generated by the instruction decoder to the multicast interconnect 250.

More specifically, the operations of the instruction decoder and sequencer 220 will be described with reference to a first example, a second example, a third example, and a fourth example. In the first example, a first macro instruction including an operation type designated as the first operation type “MAC,” a number of iterations, a channel mask, a row address, and a column address is input to the instruction decoder and sequencer 220. In the second example, a second macro instruction includes an operation type designated as the second operation type “WRGB,” a number of iterations, a channel mask, a local memory address, a column address, and a broadcast bit is input to the instruction decoder and sequencer 220. In the third example, a third macro instruction including an operation type designated as the second operation type “WRGB,” a number of iterations, a channel mask, a local memory address, a column address, a broadcast bit, and a local memory increment size is input to the instruction decoder and sequencer 220. In the fourth example, a fourth macro instruction including an operation type designated as the third operation type “WRBIAS,” a channel mask, a local memory address, a MAC latch ID, and a broadcast bit is input to the instruction decoder and sequencer 220.

In the first example, the instruction decoder and sequencer 220 generates a number of micro instructions equal to the operation number of iterations included in the first macro instruction, based on the first macro instruction. The micro instructions generated in the first example may include an operation type designated as the first operation type “MAC,” a channel mask, a row address, and a column address. The channel masks included in the micro instructions may be configured identically to the channel mask included in the first macro instruction. The row addresses included in the micro instructions may have the same value as the row address included in the first macro instruction. The column addresses included in the micro instructions may be sequentially incremented starting from the column address included in the first macro instruction.

In the second example, the instruction decoder and sequencer 220 generates at least one local memory instruction and at least one micro instruction based on the second macro instruction. When the broadcast bit included in the second macro instruction has a first binary value, for example, a binary value of “1,” the instruction decoder and sequencer 220 generates a number of local memory instructions and micro instructions equal to the operation number of iterations included in the second macro instruction. When the broadcast bit included in the second macro instruction has a second binary value, for example, a binary value of “0,” the instruction decoder and sequencer 220 generates a number of local memory instructions and micro instructions obtained by multiplying the operation number of iterations included in the second macro instruction by the number of bits having a value of “1” in the channel mask included in the second macro instruction.

In the second example, the local memory instructions generated by the instruction decoder and sequencer 220 may include a local memory command and a local memory address. The local memory command included in the local memory instructions may be a command designating a read operation from the local memory, for example, designated as “RD_LM.” The local memory addresses included in the local memory instructions may be sequentially incremented starting from the local memory address included in the second macro instruction. In the second example, the micro instructions generated by the instruction decoder and sequencer 220 may include an operation type designated as the second operation type “WRGB,” a channel mask, a column address, and a broadcast bit. The column addresses included in the micro instructions may be sequentially incremented starting from the column address included in the second macro instruction. The broadcast bits included in the micro instructions may have the same value as the broadcast bit included in the second macro instruction.

The channel masks included in the micro instructions may be configured identically to or differently from the channel mask included in the second macro instruction depending on the bit value of the broadcast bit. In one embodiment, when the broadcast bit included in the second macro instruction has a first binary value, for example, a binary value of “1,” the instruction and data transmission scheme may be designated as a broadcasting transmission scheme, in which the same instruction and data are transmitted to all channels. In one embodiment, the broadcasting transmission scheme may be defined as a scheme in which identical data is transmitted to all channels. In this case, the channel masks included in the micro instructions generated by the instruction decoder and sequencer 220 may be configured identically to the channel mask included in the second macro instruction. On the other hand, when the broadcast bit has a second binary value, for example, a binary value of “0,” the instruction and data transmission scheme may be designated as a non-broadcasting transmission scheme, such as a unicasting or multicasting transmission scheme, in which different instructions or data are transmitted to different channels. In one embodiment, the non-broadcasting transmission scheme may be defined as a scheme in which different data is transmitted to each channel. In this case, the channel masks included in the micro instructions generated by the instruction decoder and sequencer 220 may be configured differently from the channel mask included in the second macro instruction.

Specifically, when the broadcast bit included in the second macro instruction has a binary value of “0,” for each channel mask included in the micro instructions generated by the instruction decoder and sequencer 220, one bit (hereinafter referred to as “channel bit”) among the bits of the channel mask may have the same bit value as the bit at the corresponding position in the channel mask included in the second macro instruction. Accordingly, for each channel mask included in the micro instructions, the channel bit may have a binary value of “0” or “1,” depending on the corresponding bit in the second macro instruction. Meanwhile, all other bits except for the channel bit in the channel mask included in each micro instruction may have a binary value of “0.”

In the third example, the instruction decoder and sequencer 220 generates at least one local memory instruction and at least one micro instruction based on the third macro instruction. When the broadcast bit included in the third macro instruction has a first binary value, for example, a binary value of “1,” the instruction decoder and sequencer 220 generates a number of local memory instructions and micro instructions equal to the operation number of iterations included in the third macro instruction. When the broadcast bit included in the third macro instruction has a second binary value, for example, a binary value of “0,” the instruction decoder and sequencer 220 generates a number of local memory instructions and micro instructions obtained by multiplying the operation number of iterations included in the third macro instruction by the number of bits having a value of “1” in the channel mask included in the third macro instruction.

In the third example, the local memory instructions generated by the instruction decoder and sequencer 220 may include a local memory command and a local memory address. The local memory command included in the local memory instructions may be designated as “RD_LM,” which indicates a read operation from the local memory. The local memory addresses included in the local memory instructions may be sequentially incremented starting from the local memory address included in the third macro instruction, with an increment size specified by the local memory increment size included in the third macro instruction.

In the third example, the micro instructions generated by the instruction decoder and sequencer 220 may include an operation type designated as the second operation type “WRGB,” a channel mask, a column address, and a broadcast bit. The column addresses included in the micro instructions may be sequentially incremented starting from the column address included in the third macro instruction. The broadcast bits included in the micro instructions may have the same value as the broadcast bit included in the third macro instruction.

The channel masks included in the micro instructions may be configured identically to or differently from the channel mask included in the third macro instruction, depending on the bit value of the broadcast bit. In one embodiment, when the broadcast bit included in the third macro instruction has a first binary value, for example, a binary value of “1,” the instruction and data transmission scheme may be designated as a broadcasting transmission scheme. In this case, the channel masks included in the micro instructions generated by the instruction decoder and sequencer 220 may be configured identically to the channel mask included in the third macro instruction. On the other hand, when the broadcast bit has a second binary value, for example, a binary value of “0,” the instruction and data transmission scheme may be designated as a non-broadcasting transmission scheme. In this case, the channel masks included in the micro instructions generated by the instruction decoder and sequencer 220 may be configured differently from the channel mask included in the third macro instruction.

Specifically, when the broadcast bit included in the third macro instruction has a binary value of “0,” for each channel mask included in the micro instructions generated by the instruction decoder and sequencer 220, one bit (hereinafter referred to as “channel bit”) among the bits of the channel mask may have the same bit value as the bit at the corresponding position in the channel mask included in the third macro instruction. Accordingly, for each channel mask included in the micro instructions, the channel bit may have a binary value of “0” or “1” depending on the corresponding bit in the third macro instruction. Meanwhile, all other bits except for the channel bit in the channel mask included in each micro instruction may have a binary value of “0.”

In the fourth example, the instruction decoder and sequencer 220 generates a number of local memory instructions and micro instructions equal to the number of bits having a binary value of “1” among the bits of the channel mask included in the fourth macro instruction. In the fourth example, the local memory instructions generated by the instruction decoder and sequencer 220 may include a local memory command and a local memory address. The local memory command included in the local memory instructions may be designated as “RD_LM,” which indicates a read operation from the local memory. The local memory addresses included in the local memory instructions may be sequentially incremented starting from the local memory address included in the fourth macro instruction.

In the fourth example, the micro instructions generated by the instruction decoder and sequencer 220 may include an operation type designated as the third operation type “WRBIAS,” a channel mask, and a MAC latch ID. The channel masks included in the micro instructions generated by the instruction decoder and sequencer 220 are configured differently from the channel mask included in the fourth macro instruction. Specifically, among the bits of each channel mask included in the micro instructions, one bit (referred to as a “channel bit”) has a binary value of “1,” and all other bits except for the channel bit have a binary value of “0.” The MAC latch ID included in the micro instructions may have the same value as the MAC latch ID included in the fourth macro instruction. When the fourth macro instruction includes a broadcast bit, each of the micro instructions generated in the fourth example may also include a broadcast bit. In this case, the broadcast bit included in each micro instruction may have the same value as the broadcast bit included in the fourth macro instruction.

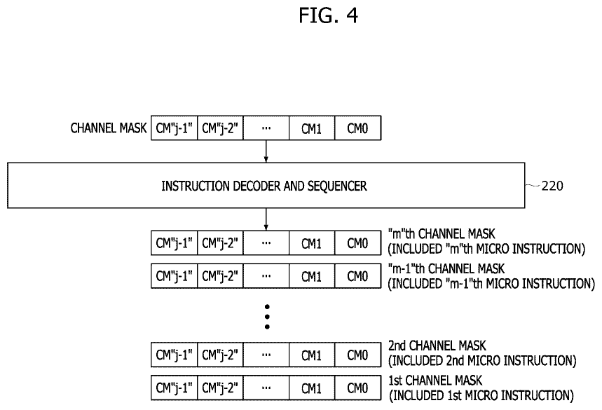

FIGS. 4 to 6 are diagrams illustrating various examples of channel masks included in macro instructions and channel masks included in micro instructions generated by an instruction decoder and sequencer. In the description of FIGS. 4 to 6, it is assumed, for example, that the number of channels is “j” and that the operation number of iterations included in the macro instruction is “m.” Here, “j” and “m” are each natural numbers equal to or greater than 2.

As illustrated in FIGS. 4 to 6, in the following examples, the channel mask included in the macro instruction is configured as a binary stream including a number of bits equal to the number of channels “j,” that is, from a first bit to a j-th bit. The first bit of the channel mask included in the macro instruction, that is, the least significant bit (LSB), has the bit value of “CM0.” “CM0” may be a binary value of “0” or “1.” The second bit of the channel mask included in the macro instruction has the bit value of “CM1,” which may also be a binary value of “0” or “1.” Similarly, the (“j−1”)-th bit of the channel mask included in the macro instruction has the bit value of “CMj−2,” which may also be a binary value of “0” or “1.” The j-th bit of the channel mask, that is, the most significant bit (MSB), has the bit value of “CMj−1,” which may also be a binary value of “0” or “1.”

Referring first to FIG. 4, it is assumed, for example, that a first macro instruction is input to the instruction decoder and sequencer 220. Although not shown in the drawing, the first macro instruction may include an operation type designated as the first operation type “MAC,” a number of iterations designated as “m,” and a channel mask configured as a binary stream of “CMj−1 CMj−2 . . . . CM1 CM0.” The following description according to this example may equally apply to a case where a second macro instruction is input, which includes an operation type designated as the second operation type “WRGB,” a number of iterations designated as “m,” a broadcast bit designated as a binary value of “1,” and a channel mask configured as a binary stream of “CMj−1 CMj−2 . . . . CM1 CM0.” Additionally, the following description may equally apply to a case where a third macro instruction is input, which includes an operation type designated as the second operation type “WRGB,” a number of iterations designated as “m,” a broadcast bit designated as a binary value of “1,” a channel mask configured as a binary stream of “CMj−1 CMj−2 . . . . CM1 CM0,” and a local memory increment size.

The instruction decoder and sequencer 220 generates and outputs a number of micro instructions, for example, first through “m”-th micro instructions, equal to the operation number of iterations “m.” Each of the first through “m”-th micro instructions respectively includes a first through “m”-th channel mask. For example, the first micro instruction includes the first channel mask, the second micro instruction includes the second channel mask, and similarly, the “m”-th micro instruction includes the “m”-th channel mask. Each of the first through “m”-th channel masks includes the first through j-th bits, identical to those included in the channel mask of the first macro instruction. The first through j-th bits of each of the first through “m”-th channel masks have the same bit values as the first through j-th bits of the channel mask included in the first macro instruction. That is, each of the first through “m”-th channel masks is configured as the same binary stream of “CMj−1 CMj−2 . . . . CM1 CM0.”

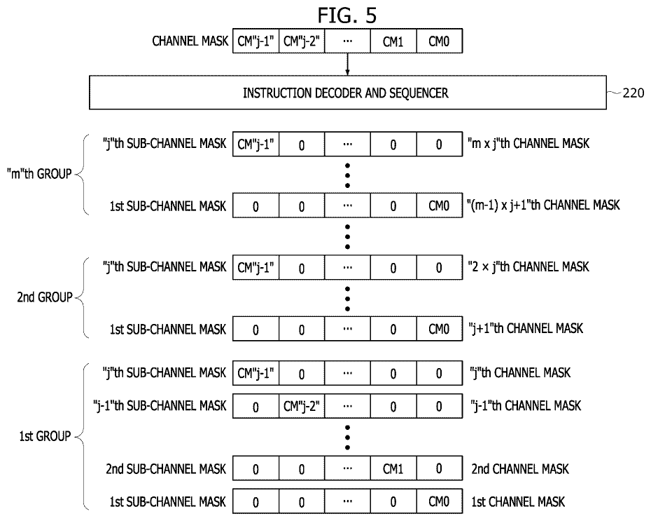

Referring next to FIG. 5, it is assumed, for example, that a second macro instruction having a broadcast bit designated as a binary value of “0” is input to the instruction decoder and sequencer 220. Although not shown in the drawing, the second macro instruction may include an operation type designated as the second operation type “WRGB,” a number of iterations designated as “m,” a broadcast bit designated as a binary value of “0,” and a channel mask configured as a binary stream of “CMj−1 CMj−2 . . . . CM1 CM0.” The following description of this example may equally apply to a case where a third macro instruction having a broadcast bit designated as a binary value of “0” is input to the instruction decoder and sequencer 220. The third macro instruction may include an operation type designated as the second operation type “WRGB,” a number of iterations designated as “m,” a channel mask configured as a binary stream of “CMj−1 CMj−2 . . . . CM1 CM0,” a broadcast bit designated as a binary value of “0,” and a local memory increment size.

The instruction decoder and sequencer 220 generates and outputs a number of micro instructions, for example, first through “m×t”-th micro instructions, where “t” is the number of bits having a value of “1” among the first through j-th bits of the channel mask included in the second macro instruction, and “m” is the operation number of iterations. Here, “t” represents a natural number from 0 to j. In one example, when the i-th bit among the first through j-th bits of the channel mask included in the second macro instruction has a binary value of “1,” the instruction decoder and sequencer 220 generates “m” i-th micro instructions. The “m” i-th micro instructions each include an i-th channel mask. In one example, when all the bit values (CM0 to CMj−1) of the channel mask included in the second macro instruction are “1,” the instruction decoder and sequencer 220 generates and outputs “m×j” micro instructions. That is, when the broadcast bit included in the second macro instruction has a binary value of “0,” the instruction decoder and sequencer 220 may generate and output up to “m×j” micro instructions.

Hereinafter, a case will be described where all of the first through j-th bits of the channel mask included in the second macro instruction have a bit value of “1,” that is, where CM0 to CMj−1 are all binary values of “1.” In this case, the instruction decoder and sequencer 220 outputs first through “m×j”-th micro instructions, each having a corresponding first through “m×j”-th channel mask. The first micro instruction output from the instruction decoder and sequencer 220 includes the first channel mask. The second micro instruction output from the instruction decoder and sequencer 220 includes the second channel mask. Similarly, the “m×j”-th micro instruction output from the instruction decoder and sequencer 220 includes the “m×j”-th channel mask.

When the instruction decoder and sequencer 220 generates “m×t” micro instructions, the “m×t” channel masks may be divided into first through “m”-th groups, each including “t” channel masks. In this example, because “t” is equal to “j,” each of the first through “m”-th groups includes “j” channel masks. Hereinafter, the “j” channel masks included in each of the first through “m”-th groups will be referred to as first through j-th sub-channel masks. The first through j-th sub-channel masks included in the first group correspond to the first through j-th channel masks among the first through “m×t”-th channel masks. The first through j-th sub-channel masks included in the second group correspond to the (j+1)-th through “2×j”-th channel masks among the first through “m×t”-th channel masks. Similarly, the first through j-th sub-channel masks included in the “m”-th group correspond to the (“m×t-t”)-th through “m×t”-th channel masks among the first through “m×t”-th channel masks.

Each of the first through “m”-th groups includes first through j-th sub-channel masks, and each of the sub-channel masks has the same number of bits as the number of bits in the channel mask included in the second macro instruction. Because the channel mask included in the second macro instruction includes first through j-th bits, each of the first through j-th sub-channel masks included in each of the first through “m”-th groups includes first through j-th bits. In each of the first through “m”-th groups, the first bit of each of the first through j-th sub-channel masks corresponds to the LSB, and the j-th bit corresponds to the MSB.

Among the first through j-th sub-channel masks included in each of the first through “m”-th groups, the i-th sub-channel masks (where “i” is a natural number from 1 to “j”) are configured as the same binary stream. In other words, among the first through “m×j”-th channel masks, the “(n−1)×j+i”-th channel mask (i.e., the i-th sub-channel mask of each of the first through “m”-th groups) is configured as the same binary stream. Here, “n” represents the first through “m”-th groups, and “n” is a natural number from 1 to “m.” For example, when “i”=1, the first sub-channel masks of the first through “m”-th groups (i.e., the “(n−1)×j+1”-th channel masks) are all configured as the same binary stream. When “i”=2, the second sub-channel masks of the first through “m”-th groups (i.e., the “(n−1)×j+2”-th channel masks) are all configured as the same binary stream. Similarly, when “i”=“j,” the j-th sub-channel masks of the first through “m”-th groups (i.e., the “(n−1)×j+j”-th channel masks) are all configured as the same binary stream.

Among the first through j-th bits of the i-th sub-channel mask included in each of the first through “m”-th groups, the i-th bit is designated as the channel bit. The channel bit, that is, the i-th bit of each i-th sub-channel mask included in each of the first through “m”-th groups, has the same bit value as the i-th bit among the first through j-th bits of the channel mask included in the second macro instruction, that is, a bit value of “1.” Meanwhile, all bits other than the channel bit among the first through j-th bits of each i-th sub-channel mask included in each of the first through “m”-th groups have a binary value of “0.”

As illustrated in FIG. 5, in the case of the first (“i”=1) sub-channel mask of the first group, the channel bit, that is, the first (“i”=1) bit, has the same bit value as the first bit of the channel mask included in the second macro instruction, CM0, that is, a binary value of “1,” and all of the second through j-th bits have a binary value of “0.” In the case of the second (“i”=2) sub-channel mask of the first group, the channel bit, that is, the second (“i”=2) bit, has the same bit value as the second bit of the channel mask included in the second macro instruction, CM1, that is, a binary value of “1,” and all of the first bit and the third through j-th bits have a binary value of “0.” Similarly, in the case of the (“j−1”)-th (“i”=“j−1”) sub-channel mask of the first group, the channel bit, that is, the (“j−1”)-th (“i”=“j−1”) bit, has the same bit value as the (“j−1”)-th bit of the channel mask included in the second macro instruction, CMj−2, that is, a binary value of “1,” and all of the first through (“j−2”)-th bits and the j-th bit have a binary value of “0.” Likewise, in the case of the j-th (“i”=“j”) sub-channel mask of the first group, the channel bit, that is, the j-th (“i”=“j”) bit, has the same bit value as the j-th bit of the channel mask included in the second macro instruction, CMj−1, that is, a binary value of “1,” and all of the first through (“j−1”)-th bits have a binary value of “0.”

In the case of the first (“i”=1) sub-channel mask of the second group (i.e., the (j+1)-th channel mask), the channel bit, that is, the first (“i”=1) bit, has the same bit value as the first bit of the channel mask included in the second macro instruction, CM0, that is, a binary value of “1,” and all of the second through j-th bits have a binary value of “0.” Similarly, in the case of the j-th (“i”=“j”) sub-channel mask of the second group (i.e., the (j+j)-th channel mask), the channel bit, that is, the j-th (“i”=“j”) bit, has the same bit value as the j-th bit of the channel mask included in the second macro instruction, CMj−1, that is, a binary value of “1,” and all of the first through (“j−1”)-th bits have a binary value of “0.”

Likewise, in the case of the first (“i”=1) sub-channel mask of the “m”-th group (i.e., the ((m−1)×j+1)-th channel mask), the channel bit, that is, the first (“i”=1) bit, has the same bit value as the first bit of the channel mask included in the second macro instruction, CM0, that is, a binary value of “1,” and all of the second through j-th bits have a binary value of “0.” Similarly, in the case of the j-th (“i”=“j”) sub-channel mask of the “m”-th group (i.e., the ((m−1)×j+j)-th channel mask), the channel bit, that is, the j-th (“i”=“j”) bit, has the same bit value as the j-th bit of the channel mask included in the second macro instruction, CMj−1, that is, a binary value of “1,” and all of the first through (“j−1”)-th bits have a binary value of “0.”

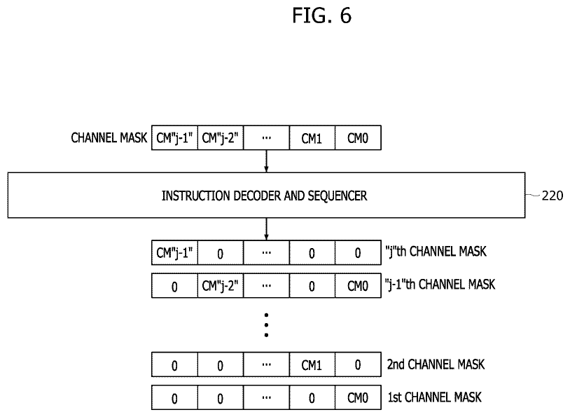

Referring next to FIG. 6, it is assumed, for example, that a fourth macro instruction is input to the instruction decoder and sequencer 220. Although not shown in the drawing, the fourth macro instruction may include an operation type designated as the third operation type “WRBIAS,” a number of iterations designated as “m,” and a channel mask configured as a binary stream of “CMj−1 CMj−2 . . . . CM1 CM0.”

The instruction decoder and sequencer 220 generates a number of micro instructions, for example, “t” micro instructions, equal to the number of bits having a binary value of “1” among the first through j-th bits of the channel mask included in the fourth macro instruction. For example, when the i-th bit among the first through j-th bits of the channel mask included in the fourth macro instruction has a binary value of “1,” the instruction decoder and sequencer 220 generates an i-th micro instruction, and the i-th micro instruction includes an i-th channel mask. As illustrated in FIG. 6, when all of the first through j-th bits of the channel mask included in the fourth macro instruction have a binary value of “1,” that is, when CM0 through CMj−1 are all binary values of “1,” the instruction decoder and sequencer 220 generates first through j-th micro instructions, and each of the first through j-th micro instructions includes a corresponding first through j-th channel mask. For example, the first micro instruction includes the first channel mask, the second micro instruction includes the second channel mask, the (“j−1”)-th micro instruction includes the (“j−1”)-th channel mask, and similarly, the j-th micro instruction includes the j-th channel mask.

Each of the first through j-th channel masks includes the first through j-th bits, similarly to the channel mask included in the fourth macro instruction. Among the first through j-th channel masks, the i-th channel mask (where “i” is a natural number from 1 to “j”) has the i-th bit designated as a channel bit. The channel bit, that is, the i-th bit of the i-th channel mask, has the same bit value as the i-th bit among the first through j-th bits of the channel mask included in the fourth macro instruction, that is, a binary value of “1.” Meanwhile, all bits of the i-th channel mask other than the channel bit, that is, the bits other than the i-th bit among the first through j-th bits, have a binary value of “0.” As illustrated in FIG. 6, in the case of the first (“i”=1) channel mask, the channel bit, that is, the first bit, has the same bit value as CM0 of the fourth macro instruction, that is, a binary value of “1,” and all of the second through j-th bits have a binary value of “0.” In the case of the second (“i”=2) channel mask, the channel bit, that is, the second bit, has the same bit value as CM1 of the fourth macro instruction, that is, a binary value of “1,” and all of the first, and third through j-th bits have a binary value of “0.” Similarly, in the case of the (“j−1”)-th (“i”=“j−1”) channel mask, the channel bit, that is, the (“j−1”)-th bit, has the same bit value as CMj−2 of the fourth macro instruction, that is, a binary value of “1,” and all of the first through (“j−2”)-th bits and the j-th bit have a binary value of “0.” In the case of the j-th (“i”=“j”) channel mask, the channel bit, that is, the j-th bit, has the same bit value as CMj−1 of the fourth macro instruction, that is, a binary value of “1,” and all of the first through (“j−1”)-th bits have a binary value of “0.”

Referring again to FIG. 1, the local memory 230 is coupled to the instruction decoder and sequencer 220 and the multicast interconnect 250. The local memory 230 may receive local memory instructions output from the instruction decoder and sequencer 220. The local memory 230 performs local memory operations, such as local memory read operations and local memory write operations, based on the local memory instructions. In one embodiment, in the case of the second example or the third example including an operation type designated as the second operation type “WRGB,” that is, when the local memory instructions are generated by the second macro instruction or the third macro instruction, the local memory 230 may output data stored at storage locations designated by local memory addresses included in the local memory instructions, i.e., vector data, and transmit the vector data to the multicast interconnect 250. In one embodiment, in the case of the fourth example including an operation type designated as the third operation type “WRBIAS,” that is, when the local memory instructions are generated by the fourth macro instruction, the local memory 230 may output data stored at storage locations designated by local memory addresses included in the local memory instructions, i.e., bias data, and transmit the bias data to the multicast interconnect 250. In one example, the local memory 230 may include static random access memory (SRAM).

The arithmetic logic unit (ALU) 240 may perform additional operations that assist operations performed in the first through j-th PIM devices 110(0) to 110(j−1). The ALU 240 may receive an ALU instruction requesting additional operations from the instruction decoder and sequencer 220. In one example, the ALU 240 may perform collective communication operations or collective communication computations, such as gather operations, all-gather operations, reduce operations, reduce-scatter operations, and all-reduce operations. The ALU 240 may receive data used for collective communication operations or collective communication computations from the network router 212 through the multicast interconnect 250. The ALU 240 may also transmit data generated as a result of collective communication computations to the network router 212 through the multicast interconnect 250.

The multicast interconnect 250 is coupled to the instruction decoder and sequencer 220 and the local memory 230. The multicast interconnect 250 may also be coupled to the host interface 211, the network router 212, and the arithmetic logic unit (ALU) 240. The multicast interconnect 250 is respectively coupled to the first through j-th PIM controllers 260(0) to 260(j−1) through the first through j-th channels CH0 to CH“j−1.” As illustrated in FIG. 1, The multicast interconnect 250 is coupled to the first PIM controller 260(0) through the first channel CH0. The multicast interconnect 250 is coupled to the second PIM controller 260(1) through the second channel CH1. The multicast interconnect 250 is coupled to the “i”-th PIM controller 260(i−1) through the “i”-th channel CH“i−1.” Similarly, the multicast interconnect 250 is coupled to the (“j−1”)-th PIM controller 260(j−2) through the (“j−1”)-th channel CH“j−2.” The multicast interconnect 250 is coupled to the j-th PIM controller 260(j−1) through the j-th channel CH“j−1.”

The multicast interconnect 250 may receive micro instructions output from the instruction decoder and sequencer 220. The multicast interconnect 250 may receive local memory data output from the local memory 230, and may also transmit data to the local memory 230. The multicast interconnect 250 may receive data from the ALU 240 and may also transmit data to the ALU 240. In one embodiment, when micro instructions are transmitted from the instruction decoder and sequencer 220 to the multicast interconnect 250, the multicast interconnect 250 may generate one or more sub-micro instruction sets based on the micro instructions. In another embodiment, when the micro instructions and the local memory data are transmitted respectively from the instruction decoder and sequencer 220 and the local memory 230 to the multicast interconnect 250, the multicast interconnect 250 may generate one or more sub-micro instruction sets based on the micro instructions and the local memory data.

In one embodiment, the multicast interconnect 250 may generate “t” sub-micro instruction sets, where “t” is the number of bits having a binary value of “1” among the first through j-th bits of the channel masks included in the first through “m”-th micro instructions. In this case, the multicast interconnect 250 may generate up to “j” sub-micro instruction sets. In another embodiment, when “m×t” micro instructions are input to the multicast interconnect 250, the multicast interconnect 250 may generate “m×t” sub-micro instruction sets corresponding to the number of micro instructions. In this case, the multicast interconnect 250 may generate up to “m×j” sub-micro instruction sets. In yet another embodiment, when “t” micro instructions are input to the multicast interconnect 250, the multicast interconnect 250 may generate “t” sub-micro instruction sets corresponding to the number of micro instructions. In this case, the multicast interconnect 250 may generate up to “j” sub-micro instruction sets.

More specifically, in the first example where the first macro instruction is input to the PIM-centric system 200, the multicast interconnect 250 receives the first through “m”-th micro instructions from the instruction decoder and sequencer 220. As previously described, “m” represents the operation number of iterations included in the first macro instruction. When the i-th bit among the first through j-th bits of the channel masks included in each of the first through “m”-th micro instructions has a binary value of “1,” the multicast interconnect 250 generates the i-th sub-micro instruction set. Conversely, when the i-th bit among the first through j-th bits of the channel masks included in each of the first through “m”-th micro instructions has a binary value of “0,” the multicast interconnect 250 does not generate the i-th sub-micro instruction set.

For example, in the first example, when each of the channel masks included in the first through “m”-th micro instructions is “1111 1111 1111 1111,” that is, when all of the first through sixteenth bits of each channel mask have a binary value of “1,” the multicast interconnect 250 generates first through sixteenth sub-micro instruction sets. In another example, when each of the channel masks included in the first through “m”-th micro instructions is “0000 1111 0000 1111,” that is, when the first through fourth bits and the ninth through twelfth bits of each channel mask have a binary value of “1,” the multicast interconnect 250 generates first through fourth sub-micro instruction sets and ninth through twelfth sub-micro instruction sets. Meanwhile, the fifth through eighth sub-micro instruction sets and the thirteenth through sixteenth sub-micro instruction sets are not generated. Each of the sub-micro instruction sets generated in the first example may include first through “m”-th sub-micro instructions. Each of the first through “m”-th sub-micro instructions may include an operation type designated as the first operation type “MAC,” a row address, and a column address.

In the second example where the second macro instruction is input to the PIM-centric system 200, and in the third example where the third macro instruction is input to the PIM-centric system 200, when both the second macro instruction and the third macro instruction include a broadcast bit designated as a binary value of “1,” the multicast interconnect 250 receives the first through “m”-th local memory data from the local memory 230 and the first through “m”-th micro instructions from the instruction decoder and sequencer 220. The multicast interconnect 250 generates “t” sub-micro instruction sets, where “t” is the number of bits having a binary value of “1” among the first through j-th bits of the channel masks included in the first through “m”-th micro instructions. For example, when the i-th bit among the first through j-th bits of the channel masks included in the first through “m”-th micro instructions has a binary value of “1,” the multicast interconnect 250 generates the i-th sub-micro instruction set. Conversely, when the i-th bit has a binary value of “0,” the multicast interconnect 250 does not generate the i-th sub-micro instruction set. Each i-th sub-micro instruction set may include first through “m”-th sub-micro instructions. Each of the first through “m”-th sub-micro instructions may include an operation type designated as the second operation type “WRGB,” local memory data, and a column address.

In the second example and the third example where both the second macro instruction and the third macro instruction include a broadcast bit designated as a binary value of “0,” the multicast interconnect 250 generates “m×t” sub-micro instruction sets corresponding to the number of “m×t” micro instructions. Specifically, when the i-th micro instruction among the “m×t” micro instructions is input to the multicast interconnect 250, the multicast interconnect 250 generates the “(n−1)×j+i”-th sub-micro instruction sets for the i-th channel CH“i−1.” Conversely, when the i-th micro instruction among the “m×t” micro instructions is not input, the multicast interconnect 250 does not generate the “(n−1)×j+i”-th sub-micro instruction sets. In one embodiment, each of the “(n−1)×j+i”-th sub-micro instruction sets may include an operation type designated as the second operation type “WRGB,” local memory data, and a column address.

In the fourth example where the fourth macro instruction is input to the PIM-centric system 200, the multicast interconnect 250 receives the first through j-th local memory data from the local memory 230 and the first through j-th micro instructions from the instruction decoder and sequencer 220. When the i-th micro instruction among the first through j-th micro instructions is input to the multicast interconnect 250, the multicast interconnect 250 generates the i-th sub-micro instruction set. Conversely, when the i-th micro instruction among the first through j-th micro instructions is not input to the multicast interconnect 250, the multicast interconnect 250 does not generate the i-th sub-micro instruction set. In one embodiment, the i-th sub-micro instruction set may include an operation type designated as the third operation type “WRBIAS,” local memory data, and a MAC latch ID.

The multicast interconnect 250 transmits the sub-micro instruction sets to one or more of the first through j-th PIM controllers 260(0) to 260(j−1). First, in the first example where the operation type included in the macro instruction is designated as the first operation type “MAC,” it is assumed, for example, that the multicast interconnect 250 generates the i-th sub-micro instruction set. In this case, the multicast interconnect 250 transmits the i-th sub-micro instruction set to the i-th PIM controller 260(i−1) through the i-th channel CH“i−1.” Similarly, in the second and third examples where the broadcast bit has a binary value of “1” and the operation type is designated as the second operation type “WRGB,” the multicast interconnect 250 transmits the i-th sub-micro instruction set to the i-th PIM controller 260(i−1) through the i-th channel CH“i−1.” In these cases, the multicast interconnect 250 sequentially transmits the first through “m”-th sub-micro instructions included in the i-th sub-micro instruction set to the i-th PIM controller 260(i−1).

Next, in the second and third examples where the macro instruction has a broadcast bit of “0” and an operation type designated as “WRGB,” it is assumed, for example, that the multicast interconnect 250 generates “(n−1)×j+i”-th sub-micro instruction sets. In this case, the multicast interconnect 250 transmits the “(n−1)×j+i”-th sub-micro instruction sets to the i-th PIM controller 260(i−1) through the i-th channel CH“i−1.” For example, first, the multicast interconnect 250 transmits the i-th sub-micro instruction set of the first group (“n”=1) to the i-th PIM controller 260(i−1) through the i-th channel CH“i−1.” Next, the multicast interconnect 250 transmits the (j+i)-th sub-micro instruction set of the second group (“n”=2) to the i-th PIM controller 260(i−1) through the i-th channel CH“i−1.” Next, the multicast interconnect 250 transmits the (2×j+i)-th sub-micro instruction set of the third group (“n”=3) to the i-th PIM controller 260(i−1) through the i-th channel CH“i−1.” Likewise, the multicast interconnect 250 sequentially transmits the (3×j+i)-th sub-micro instruction set of the fourth group (“n”=4) through the ((m−2)×j+i)-th sub-micro instruction set of the (“m−1”)-th group to the i-th PIM controller 260(i−1) through the i-th channel CH“i−1.” Finally, the multicast interconnect 250 transmits the ((m−1)×j+i)-th sub-micro instruction set to the i-th PIM controller 260(i−1) through the i-th channel CH“i−1.”

Next, in the fourth example where the operation type included in the macro instruction is designated as the third operation type “WRBIAS,” it is assumed, for example, that the multicast interconnect 250 generates the i-th sub-micro instruction set. In this case, the multicast interconnect 250 transmits the i-th sub-micro instruction set to the i-th PIM controller 260(i−1) through the i-th channel CH“i−1.” For example, when the first through j-th sub-micro instruction sets are generated in the fourth example, the multicast interconnect 250 respectively transmits the first through j-th sub-micro instruction sets to the first through j-th PIM controllers 260(0) to 260(j−1) through the first through j-th channels CH0 to CH“j−1.”

The first through j-th PIM controllers 260(0) to 260(j−1) are respectively coupled to the first through j-th PIM devices 110(0) to 110(j−1) through the first through j-th channels CH0 to CH“j−1.” As illustrated in FIG. 1, the first PIM controller 260(0) is coupled to the first PIM device 110(0) through the first channel CH0. The second PIM controller 260(1) is coupled to the second PIM device 110(1) through the second channel CH1. The i-th PIM controller 260(i−1) is coupled to the i-th PIM device 110(i−1) through the i-th channel CH“i−1.” Similarly, the (“j−1”)-th PIM controller 260(j−2) is coupled to the (“j−1”)-th PIM device 110(j−2) through the (“j−1”)-th channel CH“j−2.” The j-th PIM controller 260(j−1) is coupled to the j-th PIM device 110(j−1) through the j-th channel CH“j−1.”

In one embodiment, each of the first through j-th PIM controllers 260(0) to 260(j−1) may receive one sub-micro instruction set from the multicast interconnect 250. In this case, each of the first through j-th PIM controllers 260(0) to 260(j−1) may generate a PIM command set based on the received sub-micro instruction set. In another embodiment, each of the first through j-th PIM controllers 260(0) to 260(j−1) may receive one or more sub-micro instruction sets from the multicast interconnect 250. In this case, each of the first through j-th PIM controllers 260(0) to 260(j−1) may generate one or more PIM command sets based on the one or more sub-micro instruction sets.

More specifically, in the first example where the macro instruction has an operation type designated as the first operation type “MAC,” when the i-th sub-micro instruction set is transmitted from the multicast interconnect 250, the i-th PIM controller 260(i−1) generates an i-th PIM command set corresponding to the i-th sub-micro instruction set. In this case, the i-th PIM command set includes an active PIM command and first through “m”-th PIM commands. The active PIM command may include a command, such as an “ACT” command, to activate a row of a memory bank designated by a row address, and a row address itself. Each of the first through “m”-th PIM commands may include an operation type designated as the first operation type “MAC” and a column address. The i-th PIM controller 260(i−1) transmits the i-th PIM command set to the i-th PIM device 110(i−1) through the i-th channel CH“i−1.”

In the second and third examples where the macro instruction includes an operation type designated as the second operation type “WRGB” and a broadcast bit designated as a binary value of “1,” when the i-th sub-micro instruction set is transmitted from the multicast interconnect 250, the i-th PIM controller 260(i−1) generates an i-th PIM command set corresponding to the i-th sub-micro instruction set. In this case, the i-th PIM command set includes first through “m”-th PIM commands. Each of the first through “m”-th PIM commands includes an operation type designated as “WRGB,” local memory data, and a column address. The i-th PIM controller 260(i−1) transmits the i-th PIM command set to the i-th PIM device 110(i−1) through the i-th channel CH“i−1.”

In the second and third examples where the macro instruction includes an operation type designated as the second operation type “WRGB” and a broadcast bit designated as a binary value of “0,” when the “(n−1)×j+i”-th sub-micro instruction sets are transmitted from the multicast interconnect 250 to the i-th PIM controller 260(i−1), the i-th PIM controller 260(i−1) generates the corresponding “(n−1)×j+i”-th PIM command sets. In this case, each of the “(n−1)×j+i”-th PIM command sets includes an operation type designated as “WRGB,” local memory data, and a column address. The i-th PIM controller 260(i−1) transmits each “(n−1)×j+i”-th PIM command set to the i-th PIM device 110(i−1) through the i-th channel CH“i−1.”

In the fourth example where the macro instruction includes an operation type designated as the third operation type “WRBIAS,” when the i-th sub-micro instruction set is transmitted from the multicast interconnect 250, the i-th PIM controller 260(i−1) generates an i-th PIM command set corresponding to the i-th sub-micro instruction set. In this case, the i-th PIM command set includes an operation type designated as “WRBIAS,” local memory data, and a MAC latch ID. The i-th PIM controller 260(i−1) transmits the i-th PIM command set to the i-th PIM device 110(i−1) through the i-th channel CH“i−1.”

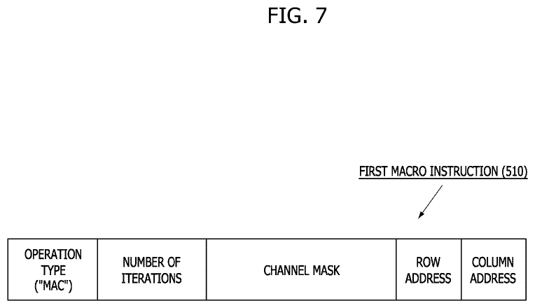

FIG. 7 is a diagram illustrating an example of a first macro instruction used in the PIM system according to the present disclosure.

Referring to FIG. 7, the first macro instruction 510 may include an operation type, a number of iterations, a channel mask, a row address, and a column address. In one embodiment, the column address, the row address, the channel mask, the number of iterations, and the operation type may be sequentially arranged from the LSB to the MSB of the first macro instruction 510.

In one embodiment, the operation type may be designated as a first operation type “MAC,” which requests a MAC operation to be performed in the PIM devices. The number of iterations specifies the number of times the MAC operation is to be performed in the PIM devices. The channel mask includes bits respectively corresponding to the channels included in the PIM system. For example, when the PIM system includes sixteen channels, the first bit of the channel mask, that is, the LSB, corresponds to the first channel CH0 among the first through sixteenth channels CH0 to CH15. The second bit of the channel mask corresponds to the second channel CH1 among the first through sixteenth channels. Similarly, the sixteenth bit of the channel mask, that is, the MSB, corresponds to the sixteenth channel CH15.

According to the binary values of the bits included in the channel mask, the channels through which sub-micro instruction sets and PIM command sets are transmitted may be determined. For example, among the first through j-th bits of the channel mask, when the i-th bit has a first binary value, such as “1,” the sub-micro instruction set and the PIM command set may be transmitted through the i-th channel CH“i.” Conversely, when the i-th bit has a second binary value, such as “0,” no sub-micro instruction set or PIM command set is transmitted through the i-th channel. The row address designates a row of a memory bank in which weight data used for the MAC operation in the PIM device is stored. The column address designates a starting column address of the memory bank storing the weight data for the MAC operation and a starting storage location of the global buffer storing the vector data.

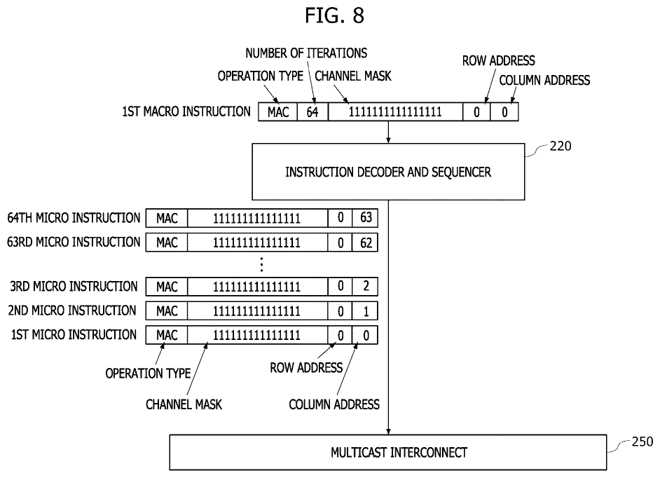

FIGS. 8 to 10 are diagrams illustrating a process of executing the first macro instruction of FIG. 7 in the PIM system of FIG. 1. In this example, it is assumed that the PIM system 10 includes the first through sixteenth channels CH0 to CH15. Furthermore, it is assumed, for example, that the operation type, number of iterations, channel mask, row address, and column address of the first macro instruction are respectively set as operation type “MAC,” number of iterations “64,” channel mask “1111 1111 1111 1111,” row address “0,” and column address “0.”

Referring to FIG. 8, upon receiving the first macro instruction, the instruction decoder and sequencer 220 decodes the first macro instruction and generates a number of micro instructions equal to the number of iterations “m” (i.e., 64). Because the number of iterations in the first macro instruction is set to “64,” the instruction decoder and sequencer 220 generates sixty-four micro instructions, namely, the first through sixty-fourth micro instructions. Each of the first through sixty-fourth micro instructions includes an operation type, a channel mask, a row address, and a column address. The number of iterations included in the first macro instruction is excluded from the first through sixty-fourth micro instructions. The operation type, channel mask, and row address included in each of the first through sixty-fourth micro instructions are identical to those included in the first macro instruction. Specifically, the first through sixty-fourth micro instructions have the operation type designated as the first operation type “MAC,” the channel mask designated as “1111 1111 1111 1111,” and the row address designated as “0.”

The column addresses included in the first through sixty-fourth micro instructions have different values. That is, starting from the first micro instruction to the sixty-fourth micro instruction, the column addresses sequentially increase by one, beginning from the column address “0” included in the first macro instruction. As illustrated in FIG. 8, the column address included in the first micro instruction is “0,” identical to the starting column address of the first macro instruction. The column address included in the second micro instruction is “1,” the next value after the first micro instruction's column address “0.” The column address included in the third micro instruction is “2,” the next value after the second micro instruction's column address “1.” Similarly, the column address included in the sixty-third micro instruction is “62,” which follows the sixty-second micro instruction's column address “61” (not shown). The column address included in the sixty-fourth micro instruction is “63,” following the sixty-third micro instruction's column address “62.” The instruction decoder and sequencer 220 transmits the first through sixty-fourth micro instructions to the multicast interconnect 250.

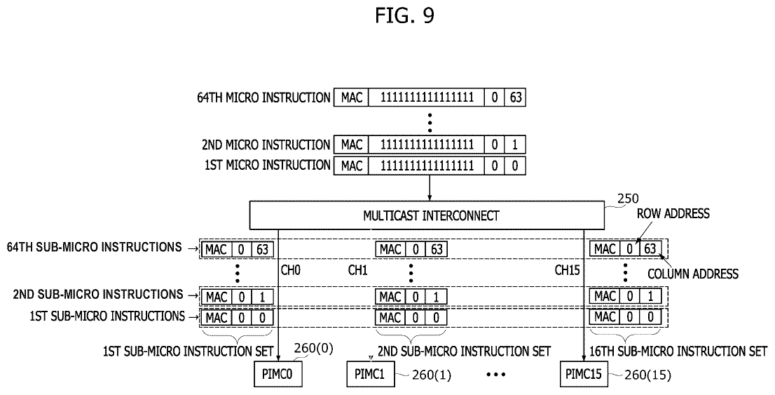

Referring to FIG. 9, the multicast interconnect 250 generates and outputs one or more sub-micro instruction sets based on the first through sixty-fourth micro instructions transmitted from the instruction decoder and sequencer 220. The number of sub-micro instruction sets output by the multicast interconnect 250 may be determined by the channel masks included in each of the first through sixty-fourth micro instructions. As described with reference to FIG. 1, each of the first through sixty-fourth micro instructions includes a corresponding channel mask. The first through sixty-fourth channel masks are identical and have the same binary stream as the channel mask included in the first macro instruction. The multicast interconnect 250 outputs a number of sub-micro instruction sets equal to the number of bits having a binary value of “1” in any one of the channel masks included in the first through sixty-fourth micro instructions. In this example, the first through sixty-fourth channel masks all have the value “1111 1111 1111 1111,” meaning that the first through sixteenth bits all have a binary value of “1.” Thus, the multicast interconnect 250 outputs the first through sixteenth sub-micro instruction sets.

Each of the first through sixteenth sub-micro instruction sets includes the first through sixty-fourth sub-micro instructions. Each of the first through sixty-fourth sub-micro instructions includes an operation type, a row address, and a column address. The operation type, row address, and column address included in each of the first through sixty-fourth sub-micro instructions are identical to those included in the corresponding first through sixty-fourth micro instructions. Accordingly, each of the first sub-micro instructions included in the first through sixteenth sub-micro instruction sets has an operation type “MAC,” a row address “0,” and a column address “0.” Each of the second sub-micro instructions included in the first through sixteenth sub-micro instruction sets has an operation type “MAC,” a row address “0,” and a column address “1.” Similarly, each of the sixty-fourth sub-micro instructions included in the first through sixteenth sub-micro instruction sets has an operation type “MAC,” a row address “0,” and a column address “63.”

The multicast interconnect 250 sequentially transmits the first through sixteenth sub-micro instruction sets to the first through sixteenth PIM controllers 260(0) to 260(15), respectively. Specifically, the first through sixty-fourth sub-micro instructions included in the first sub-micro instruction set are sequentially transmitted to the first PIM controller 260(0). The first through sixty-fourth sub-micro instructions included in the second sub-micro instruction set are sequentially transmitted to the second PIM controller 260(1). Similarly, the first through sixty-fourth sub-micro instructions included in the sixteenth sub-micro instruction set are sequentially transmitted to the sixteenth PIM controller 260(15). Accordingly, the first through sixteenth PIM controllers (PIMC0 to PIMC15) sequentially receive the first sub-micro instructions from the multicast interconnect 250. Subsequently, the first through sixteenth PIM controllers (PIMC0 to PIMC15) sequentially receive the second sub-micro instructions from the multicast interconnect 250. Although omitted in the drawings, in the same manner, the first through sixteenth PIM controllers sequentially receive the third through sixty-fourth sub-micro instructions from the multicast interconnect 250. Finally, the first through sixteenth PIM controllers sequentially receive the sixty-fourth sub-micro instructions.

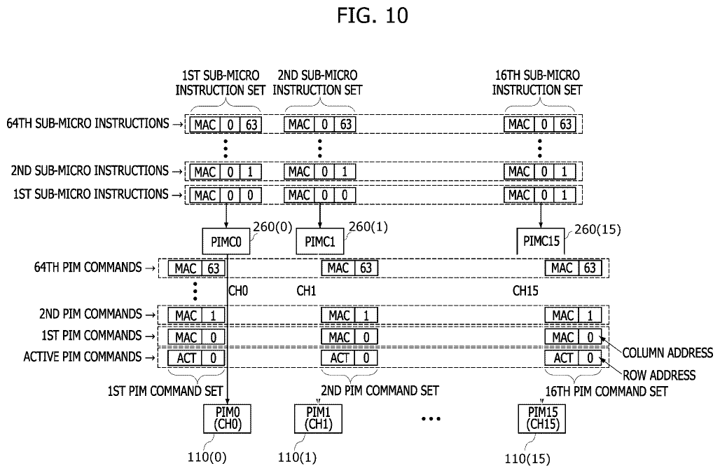

Referring to FIG. 10, the first through sixteenth PIM controllers 260(0) to 260(15) respectively generate the first through sixteenth PIM command sets based on the first through sixteenth sub-micro instruction sets. The first through sixteenth PIM controllers 260(0) to 260(15) respectively transmit the first through sixteenth PIM command sets to the first through sixteenth PIM devices 110(0) to 110(15). As illustrated in FIG. 10, the first PIM controller 260(0) transmits the first PIM command set, generated based on the first sub-micro instruction set, to the first PIM device 110(0). The second PIM controller 260(1) transmits the second PIM command set, generated based on the second sub-micro instruction set, to the second PIM device 110(1). Similarly, the sixteenth PIM controller 260(15) transmits the sixteenth PIM command set, generated based on the sixteenth sub-micro instruction set, to the sixteenth PIM device 110(15). The transmissions of the first through sixteenth PIM command sets from the first through sixteenth PIM controllers to the first through sixteenth PIM devices are performed in parallel.

In one embodiment, each of the first through sixteenth PIM command sets includes an active PIM command and the first through sixty-fourth PIM commands. The active PIM command includes an activate command (ACT) and a row address. Each of the first through sixty-fourth PIM commands includes an operation type and a column address. The row address included in the active PIM command is identical to the row address included in the first through sixty-fourth sub-micro instructions. The operation type and column address included in each of the first through sixty-fourth PIM commands are respectively identical to the operation type and column address included in the corresponding first through sixty-fourth sub-micro instructions. Accordingly, the active PIM command includes an activate command “ACT” and a row address “0.” Each of the first PIM commands included in the first through sixteenth PIM command sets includes an operation type “MAC” and a column address “0.” Each of the second PIM commands included in the first through sixteenth PIM command sets includes an operation type “MAC” and a column address “1.” Similarly, each of the sixty-fourth PIM commands included in the first through sixteenth PIM command sets includes an operation type “MAC” and a column address “63.”

Although not illustrated in the drawings, upon receiving the first through sixteenth PIM command sets, the first through sixteenth PIM devices 110(0) to 110(15) activate the rows of the memory banks designated by the row address “0” included in the active PIM command. Subsequently, the processing elements included in the first through sixteenth PIM devices 110(0) to 110(15) receive weight data stored in the columns of the activated rows of the memory banks, where the columns are designated by the column addresses, and vector data stored in the storage locations of the global buffer designated by the column addresses in response to the first through sixty-fourth PIM commands. The processing elements included in the first through sixteenth PIM devices 110(0) to 110(15) perform MAC (multiplication-accumulation) operations using the received weight data and vector data.

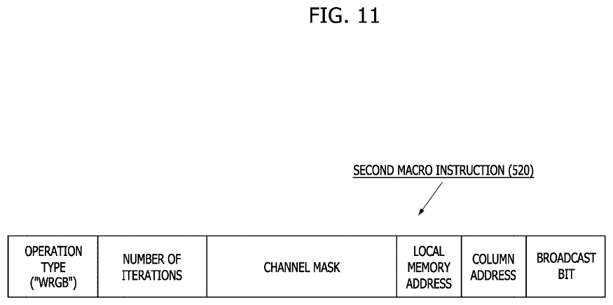

FIG. 11 is a diagram illustrating a second macro instruction used in the PIM system according to the present disclosure.

Referring to FIG. 11, a second macro instruction 520 may include an operation type, a number of iterations, a channel mask, a local memory address, a column address, and a broadcast bit. In one embodiment, the broadcast bit, column address, local memory address, channel mask, number of iterations, and operation type may be sequentially arranged from a LSB to a MSB direction within the second macro instruction 520. The operation type may be designated as a second operation type, “WRGB,” which instructs writing data, for example, vector data, into the global buffer GB of a PIM device (e.g., as illustrated in FIG. 2). The number of iterations specifies the number of times the write operation of vector data into the global buffer of the PIM device is to be performed. The channel mask may have a plurality of bits, each corresponding to one of the channels included in the PIM system. Depending on the binary values of the bits included in the channel mask, the channels to which sub-micro instruction sets and PIM command sets are transmitted may be determined. The local memory address designates a start address in the local memory where the vector data to be written into the global buffer of the PIM device is stored. The column address designates a starting storage location in the storage regions of the global buffer where the vector data is to be written. The broadcast bit may be set to a first binary value, such as “1,” or a second binary value, such as “0.” When the broadcast bit has the first binary value, e.g., “1,” the instruction and data transmission mode may be specified as a broadcasting transmission mode. In contrast, when the broadcast bit has the second binary value, e.g., “0,” the instruction and data transmission mode may be specified as a non-broadcasting transmission mode, such as a unicasting or multicasting transmission mode.

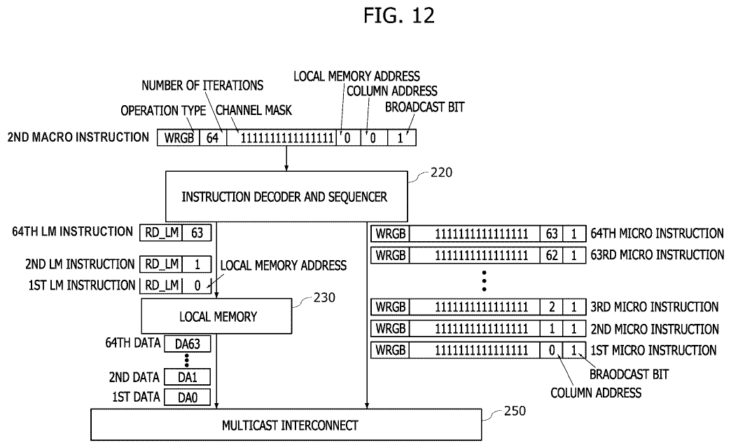

FIGS. 12 to 14 are diagrams illustrating an example process of executing the second macro instruction of FIG. 11 in the PIM system of FIG. 1. In this example, it is assumed that the PIM system 10 includes first through sixteenth channels CH0 to CH15. It is further assumed that, in the second macro instruction 520, the operation type is set to “WRGB,” the number of iterations is set to “64,” the channel mask is set to “1111 1111 1111 1111,” the local memory address is set to “0,” the column address is set to “0,” and the broadcast bit is set to “1.”

Referring to FIG. 12, the instruction decoder and sequencer 220, upon receiving the second macro instruction, decodes the second macro instruction and generates a number of local memory instructions and micro instructions equal to the number of iterations. Because the number of iterations specified in the second macro instruction is “64,” the instruction decoder and sequencer 220 generates sixty-four local memory instructions and sixty-four micro instructions. The instruction decoder and sequencer 220 transmits the sixty-four local memory instructions to the local memory 230 and transmits the sixty-four micro instructions to the multicast interconnect 250.

Each of the sixty-four local memory instructions includes a local memory read command RD_LM and a local memory address. The local memory addresses included in the sixty-four local memory instructions have different values from each other. Specifically, the local memory address included in the first local memory instruction is equal to the starting address of the local memory specified in the second macro instruction, that is, “0.” The local memory address included in the second local memory instruction is “1,” which is the next address after “0.” Similarly, although not shown, the local memory address included in the third local memory instruction is “2,” the next address after “1,” and so forth. The local memory address included in the sixty-fourth local memory instruction is “63,” which is the next address after “62.” In other words, the local memory addresses sequentially increment by “1” starting from “0.”

Each of the sixty-four micro instructions includes an operation type, a channel mask, a column address, and a broadcast bit. The number of iterations is excluded from the micro instructions. Because the broadcast bit is set to “1,” the channel masks included in the sixty-four micro instructions all have the same binary stream. The operation type, channel mask, and broadcast bit included in each micro instruction are identical to those included in the second macro instruction. Thus, all sixty-four micro instructions have the same operation type (“WRGB”), the same channel mask (“1111 1111 1111 1111”), and the same broadcast bit (“1”). However, the column addresses included in the sixty-four micro instructions differ from each other.

Specifically, the column address included in the first micro instruction is “0,” which is the same as the starting column address specified in the second macro instruction. The column address included in the second micro instruction is “1,” which is the next column address after “0,” and so forth. Although not shown, the column address of the sixty-third micro instruction is “62,” and the column address of the sixty-fourth micro instruction is “63.” Thus, the column addresses increment sequentially by “1” starting from “0.”

Upon receiving the sixty-four local memory instructions from the instruction decoder and sequencer 220, the local memory 230 sequentially outputs sixty-four data values DA0 to DA63 in response and transmits them to the multicast interconnect 250. Specifically, the first data DA0 output by the local memory 230 corresponds to the data stored in the first region of the local memory addressed by “0.” The second data DA1 corresponds to the data stored in the second region addressed by “1.” Similarly, although not shown, the sixty-fourth data DA63 corresponds to the data stored in the sixty-fourth region addressed by “63.” The first to sixty-fourth regions of the local memory 230 may be arranged adjacently and continuously.

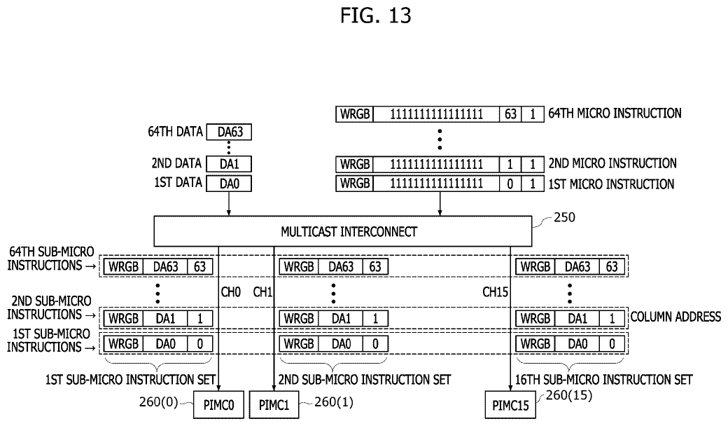

Referring to FIG. 13, the multicast interconnect 250 generates and outputs one or more sub-micro instruction sets based on the first through sixty-fourth data DA0 to DA63 transmitted from the local memory 230 and the first through sixty-fourth micro instructions transmitted from the instruction decoder and sequencer 220. The number of sub-micro instruction sets output from the multicast interconnect 250 may be determined according to the bit values of the channel masks included in the first through sixty-fourth micro instructions. In particular, the multicast interconnect 250 outputs a number of sub-micro instruction sets equal to the number of bits having a binary value of “1” in the channel mask. In the present example, because the channel mask included in each of the first through sixty-fourth micro instructions has the value “1111 1111 1111 1111,” which designates all of the first through sixteenth channels, the multicast interconnect 250 outputs the first through sixteenth sub-micro instruction sets.

Each of the first through sixteenth sub-micro instruction sets includes the first through sixty-fourth sub-micro instructions. Each of the first through sixty-fourth sub-micro instructions includes an operation type, data, and a column address. The operation type included in each of the first through sixty-fourth sub-micro instructions is the same as the operation type included in the first through sixty-fourth micro instructions. The data included in the first through sixty-fourth sub-micro instructions corresponds respectively to the first through sixty-fourth data transmitted from the local memory 230 to the multicast interconnect 250. The column addresses included in the first through sixty-fourth sub-micro instructions are respectively identical to the column addresses included in the first through sixty-fourth micro instructions. Accordingly, each first sub-micro instruction included in each of the first through sixteenth sub-micro instruction sets includes an operation type of “WRGB,” data DA0, and a column address of “0.” Each second sub-micro instruction includes an operation type of “WRGB,” data DA1, and a column address of “1.” Similarly, each sixty-fourth sub-micro instruction includes an operation type of “WRGB,” data DA63, and a column address of “63.”

The multicast interconnect 250 sequentially transmits the first through sixteenth sub-micro instruction sets to the first through sixteenth PIM controllers 260(0) to 260(15), respectively. Specifically, the multicast interconnect 250 sequentially transmits the first through sixty-fourth sub-micro instructions included in the first sub-micro instruction set to the first PIM controller 260(0). The multicast interconnect 250 sequentially transmits the first through sixty-fourth sub-micro instructions included in the second sub-micro instruction set to the second PIM controller 260(1). Similarly, the multicast interconnect 250 sequentially transmits the first through sixty-fourth sub-micro instructions included in the sixteenth sub-micro instruction set to the sixteenth PIM controller 260(15).

The transmission of the first through sixteenth sub-micro instruction sets to the first through sixteenth PIM controllers 260(0) to 260(15) may be performed in a parallel manner. Specifically, the multicast interconnect 250 first transmits the first sub-micro instructions included in the first through sixteenth sub-micro instruction sets to the respective first through sixteenth PIM controllers 260(0) to 260(15). Then, the multicast interconnect 250 transmits the second sub-micro instructions to the respective first through sixteenth PIM controllers. This sequence is continued for the third through sixty-third sub-micro instructions. Finally, the multicast interconnect 250 transmits the sixty-fourth sub-micro instructions included in the first through sixteenth sub-micro instruction sets to the respective first through sixteenth PIM controllers.

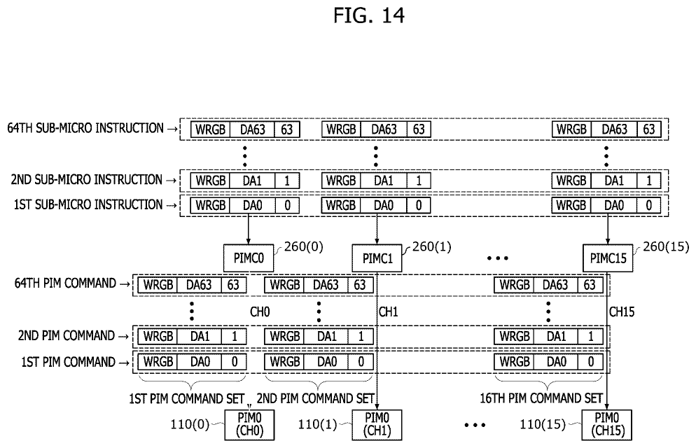

Referring to FIG. 14, the first through sixteenth PIM controllers 260(0) to 260(15) generate the first through sixteenth PIM command sets based on the first through sixteenth sub-micro instruction sets, respectively. Each of the first through sixteenth PIM controllers 260(0) to 260(15) transmits the corresponding PIM command set to the first through sixteenth PIM devices 110(0) to 110(15) through the first through sixteenth channels CH0 to CH15, respectively. Specifically, the first PIM controller 260(0) generates the first PIM command set based on the first sub-micro instruction set and transmits the generated first PIM command set to the first PIM device 110(0). The second PIM controller 260(1) generates the second PIM command set based on the second sub-micro instruction set and transmits the generated second PIM command set to the second PIM device 110(1). Similarly, the sixteenth PIM controller 260(15) generates the sixteenth PIM command set based on the sixteenth sub-micro instruction set and transmits the generated sixteenth PIM command set to the sixteenth PIM device 110(15).

In one embodiment, each of the first through sixteenth PIM command sets may include the first through sixty-fourth PIM commands. Each of the first through sixty-fourth PIM commands may include an operation type, local memory data, and a column address. The operation type, local memory data, and column address included in each of the first through sixty-fourth PIM commands are identical to those included in the first through sixty-fourth sub-micro instructions. Accordingly, each first PIM command included in the first through sixteenth PIM command sets includes an operation type of “WRGB,” local memory data DA0, and a column address “0.” Each second PIM command includes an operation type of “WRGB,” local memory data DA1, and a column address “1.” Similarly, each sixty-fourth PIM command includes an operation type of “WRGB,” local memory data DA63, and a column address “63.”

The transmission of the first through sixteenth PIM command sets from the first through sixteenth PIM controllers 260(0) to 260(15) to the first through sixteenth PIM devices 110(0) to 110(15) may be performed in a parallel manner. Specifically, the first through sixteenth PIM controllers 260(0) to 260(15) each transmit the first PIM commands included in the respective first through sixteenth PIM command sets to the corresponding first through sixteenth PIM devices 110(0) to 110(15). Then, the first through sixteenth PIM controllers transmit the second PIM commands included in the respective command sets. This process continues sequentially for the third through sixty-third PIM commands. Finally, the first through sixteenth PIM controllers transmit the sixty-fourth PIM commands included in the respective command sets.

Although not shown in the drawing, each of the first through sixteenth PIM devices 110(0) to 110(15) stores the first through sixty-fourth data DA0 to DA63 included in the first through sixty-fourth PIM commands at sixty-four designated storage locations of the global buffer specified by the corresponding column addresses. The first through sixty-fourth data stored in the global buffers of the first through sixteenth PIM devices 110(0) to 110(15) may be used as operand data, i.e., vector data, during operations performed by the processing elements included in the respective PIM devices.

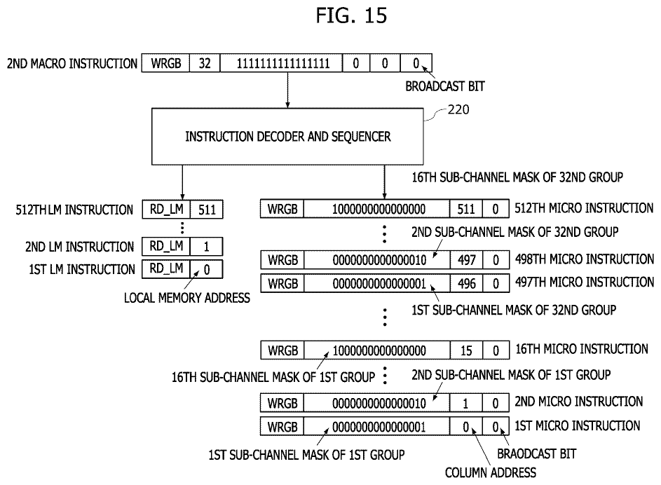

FIGS. 15 to 18 are diagrams illustrating another example process of executing the second macro instruction of FIG. 11 in the PIM system of FIG. 1. In the present example, it is assumed that the PIM system 10 includes the first to sixteenth channels CH0 to CH15. It is further assumed that the operation type of the second macro instruction is set to “WRGB,” the number of iterations is set to “32,” the channel mask is set to “1111 1111 1111 1111,” the local memory address is set to “0,” the column address is set to “0,” and the broadcast bit is set to “0.” In contrast to the example described with reference to FIGS. 9 to 11, where the number of iterations is set to “64” and the broadcast bit is set to a binary value of “1,” in the present example, the number of iterations is set to “32” and the broadcast bit is set to a binary value of “0.” Thus, the differences between the two examples include the reduced number of iterations and the use of a non-broadcasting transmission mode in the present example.

Referring to FIG. 15, when the second macro instruction having a broadcast bit set to a binary value of “0” is transmitted, the instruction decoder and sequencer 220 performs decoding of the second macro instruction to generate a number of local memory instructions and micro instructions equal to the product of the number of iterations and the number of bits having a binary value of “1” in the channel mask. Because the number of iterations is set to “32” and the number of bits having a binary value of “1” in the channel mask is “16” in the second macro instruction, the instruction decoder and sequencer 220 generates 32×16, i.e., 512 local memory instructions and 512 micro instructions, such as the first to 512th local memory instructions and the first to 512th micro instructions. The instruction decoder and sequencer 220 transmits the first to 512th local memory instructions to the local memory 230, and transmits the first to 512th micro instructions to the multicast interconnect 250.

Each of the first to 512th local memory instructions include a command designating a local memory read operation, for example, “RD_LM,” and a local memory address. The local memory addresses included in the first to 512th local memory instructions have mutually different values. In one embodiment, from the first to the 512th local memory instruction, the local memory addresses sequentially increment by “1” starting from the initial address “0” specified in the second macro instruction. Specifically, the first local memory instruction includes the local memory address “0,” corresponding to the initial address. The second local memory instruction includes the local memory address “1,” which is the next address following “0.” Similarly, although not shown in the figure, the 512th local memory instruction includes the local memory address “511,” which follows the 511th address “510.”

Each of the first to 512th micro instructions include an operation type, a channel mask, a column address, and a broadcast bit. The operation types and broadcast bits included in the first to 512th micro instructions are identical to those included in the second macro instruction. Accordingly, each micro instruction is configured with the operation type set to the second operation type “WRGB” and the broadcast bit set to “0.” The column addresses included in the first to 512th micro instructions have different values from one another.

Specifically, the column addresses sequentially increment by “1” starting from the initial column address “0” specified in the second macro instruction. Thus, the first micro instruction has a column address of “0.” The second micro instruction has a column address of “1,” following the first. Although not explicitly illustrated, the third micro instruction has a column address of “2,” following the second. The 16th micro instruction has a column address of “15,” following the 15th (“14”). The 497th micro instruction has a column address of “496,” following the 496th (“495”). The 498th micro instruction has a column address of “497,” following the 497th (“496”). Finally, the 512th micro instruction has a column address of “511,” following the 511th (“510”).

As described with reference to FIG. 5, the channel masks included in the first to 512th micro instructions may be classified into thirty-two groups, for example, the first to thirty-second groups, each including first to sixteenth sub-channel masks. The first group includes the first to sixteenth channel masks, respectively included in the first to sixteenth micro instructions, as the first to sixteenth sub-channel masks. Although not explicitly shown in FIG. 15, the second group includes the seventeenth to thirty-second channel masks, respectively included in the seventeenth to thirty-second micro instructions, as the first to sixteenth sub-channel masks. Similarly, the thirty-second group includes the four hundred ninety-seventh to five hundred twelfth channel masks, respectively included in the four hundred ninety-seventh to five hundred twelfth micro instructions, as the first to sixteenth sub-channel masks.

In the present example, because the number of channels “j” is “16” and the number of iterations “m” is “32,” the “i”-th (“i” being a natural number from “1” to “16”) sub-channel masks included in the first to thirty-second groups are all configured with the same binary stream. Further, in each of the “i”-th sub-channel masks included in the first to thirty-second groups, only the “i”-th bit designated as a channel bit has a binary value of “1,” and all other bits have a binary value of “0.”

As illustrated in FIG. 15, in the first sub-channel masks of the first to thirty-second groups (that is, the channel masks included in the first, seventeenth, thirty-third, forty-ninth, . . . , four hundred eighty-first, and four hundred ninety-seventh micro instructions), only the first bit designated as a channel bit has a binary value of “1,” while all of the second to sixteenth bits have a binary value of “0.” Accordingly, the first sub-channel masks of the first to thirty-second groups are configured with a binary stream of “0000 0000 0000 0001.” In the second sub-channel masks of the first to thirty-second groups (that is, the channel masks included in the second, eighteenth, thirty-fourth, fiftieth, . . . , four hundred eighty-second, and four hundred ninety-eighth micro instructions), only the second bit designated as a channel bit has a binary value of “1,” while the first and third to sixteenth bits have binary values of “0.” Thus, the second sub-channel masks of the first to thirty-second groups are configured with a binary stream of “0000 0000 0000 0010.” Similarly, in the sixteenth sub-channel masks of the first to thirty-second groups (that is, the channel masks included in the sixteenth, thirty-second, forty-eighth, sixty-fourth, . . . , four hundred ninety-sixth, and five hundred twelfth micro instructions), only the sixteenth bit designated as a channel bit has a binary value of “1,” while the first to fifteenth bits have binary values of “0.” Accordingly, the sixteenth sub-channel masks of the first to thirty-second groups are configured with a binary stream of “1000 0000 0000 0000.”

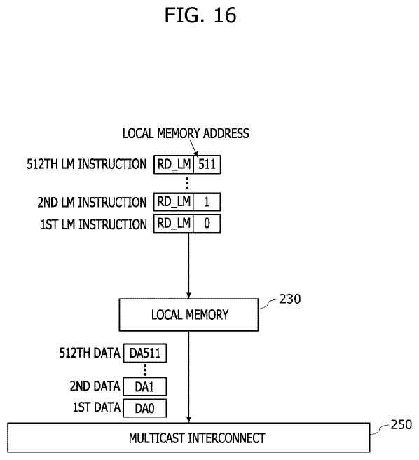

Referring to FIG. 16, when the local memory 230 receives the first to five hundred twelfth local memory instructions from the instruction decoder and sequencer 220, the local memory 230 sequentially outputs the first to five hundred twelfth local memory data DA0 to DA511 in response to the local memory instructions and transmits them to the multicast interconnect 250. Specifically, the first local memory data DA0 output from the local memory 230 corresponds to the data stored in the first region of the local memory 230 designated by the local memory address “0” included in the first local memory instruction. Subsequently, the second local memory data DA1 output from the local memory 230 corresponds to the data stored in the second region of the local memory 230 designated by the local memory address “1” included in the second local memory instruction. Similarly, the five hundred twelfth local memory data DA511 output from the local memory 230 corresponds to the data stored in the five hundred twelfth region of the local memory 230 designated by the local memory address “511” included in the five hundred twelfth local memory instruction. Thus, the local memory 230 transmits the first to five hundred twelfth local memory data DA0 to DA511 to the multicast interconnect 250.

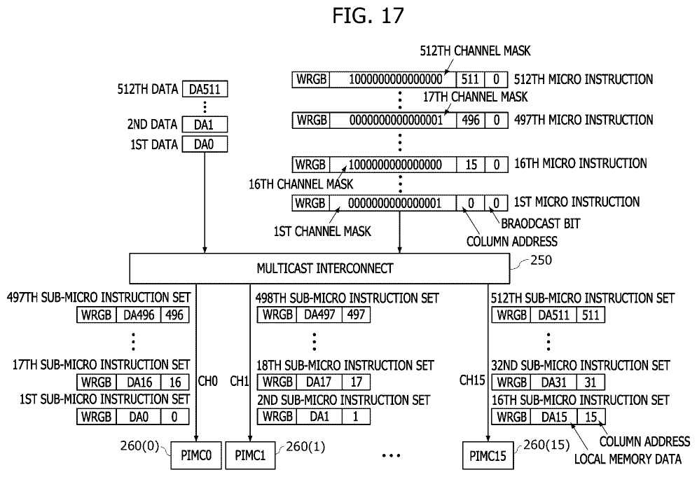

Referring to FIG. 17, the multicast interconnect 250 receives the first to five hundred twelfth local memory data DA0 to DA511 from the local memory 230 and receives the first to five hundred twelfth micro instructions from the instruction decoder and sequencer 220. Because the broadcast bits included in the first to five hundred twelfth micro instructions are set to a binary value of “0,” the multicast interconnect 250 generates and outputs one or more sub-micro instruction sets based on the first to five hundred twelfth micro instructions and the first to five hundred twelfth local memory data DA0 to DA511. The number of sub-micro instruction sets output from the multicast interconnect 250 is the same as the number of micro instructions input to the multicast interconnect 250. Because the first to five hundred twelfth micro instructions are input to the multicast interconnect 250, the multicast interconnect 250 generates and outputs the first to five hundred twelfth sub-micro instruction sets.

Each of the first to five hundred twelfth sub-micro instruction sets includes an operation type, local memory data, and a column address. The operation type included in each of the first to five hundred twelfth sub-micro instruction sets is designated as the second operation type “WRGB,” identical to the operation type included in the first to five hundred twelfth micro instructions. The local memory data included in each of the first to five hundred twelfth sub-micro instruction sets is identical to the local memory data DA0 to DA511 transmitted from the local memory 230 to the multicast interconnect 250. Accordingly, as illustrated in FIG. 17, the first sub-micro instruction set includes the first local memory data DA0. The second sub-micro instruction set includes the second local memory data DA1. Similarly, the sixteenth sub-micro instruction set includes the sixteenth local memory data DA15. The seventeenth sub-micro instruction set includes the seventeenth local memory data DA16. The eighteenth sub-micro instruction set includes the eighteenth local memory data DA17. Likewise, the thirty-second sub-micro instruction set includes the thirty-second local memory data DA31. Similarly, the four hundred ninety-seventh sub-micro instruction set includes the four hundred ninety-sixth local memory data DA496. The four hundred ninety-eighth sub-micro instruction set includes the four hundred ninety-seventh local memory data DA497. Finally, the five hundred twelfth sub-micro instruction set includes the five hundred eleventh local memory data DA511.

The column addresses included in the first to five hundred twelfth sub-micro instruction sets are identical to the column addresses included in the first to five hundred twelfth micro instructions. As illustrated in FIG. 17, the first sub-micro instruction set includes the operation type “WRGB,” the local memory data DA0, and the column address “0.” The second sub-micro instruction set includes the operation type “WRGB,” the local memory data DA1, and the column address “1.” The sixteenth sub-micro instruction set includes the operation type “WRGB,” the local memory data DA15, and the column address “15.” The seventeenth sub-micro instruction set includes the operation type “WRGB,” the local memory data DA16, and the column address “16.” The eighteenth sub-micro instruction set includes the operation type “WRGB,” the local memory data DA17, and the column address “17.” Similarly, the thirty-second sub-micro instruction set includes the operation type “WRGB,” the local memory data DA31, and the column address “31.” Likewise, the four hundred ninety-seventh sub-micro instruction set includes the operation type “WRGB,” the local memory data DA496, and the column address “496.” The four hundred ninety-eighth sub-micro instruction set includes the operation type “WRGB,” the local memory data DA497, and the column address “497.” Similarly, the five hundred twelfth sub-micro instruction set includes the operation type “WRGB,” the local memory data DA511, and the column address “511.”

Because the broadcast bits included in the first to five hundred twelfth micro instructions are set to a binary value of “0,” the multicast interconnect 250 determines the channel over which each of the first to five hundred twelfth sub-micro instruction sets is transmitted based on the corresponding channel masks included in the first to five hundred twelfth micro instructions. Specifically, the multicast interconnect 250 transmits the “(n−1)×j+i”-th sub-micro instruction sets over the i-th channel CH“i−1” to the i-th PIM controller 260(i−1). In this example, n represents a natural number ranging from 1 to 32, indicating the group number, the channel count j is 16, and “i” is a natural number ranging from 1 to 16.

As illustrated in FIG. 17, when i is “1,” the multicast interconnect 250 transmits the first sub-micro instruction set corresponding to “n=1” over the first channel CH0 to the first PIM controller 260(0). Subsequently, the multicast interconnect 250 transmits the seventeenth sub-micro instruction set corresponding to n=2 over the first channel CH0 to the first PIM controller 260(0). In the same manner, the multicast interconnect 250 sequentially transmits the “(n−1)×16+1”-th sub-micro instruction sets corresponding to n=3 through n=31 over the first channel CH0 to the first PIM controller 260(0). Finally, the multicast interconnect 250 transmits the four hundred ninety-seventh sub-micro instruction set corresponding to n=32 over the first channel CH0 to the first PIM controller 260(0).

When i is “2,” the multicast interconnect 250 transmits the second sub-micro instruction set corresponding to n=1 over the second channel CH1 to the second PIM controller 260(1). Next, the multicast interconnect 250 transmits the eighteenth sub-micro instruction set corresponding to n=2 over the second channel CH1 to the second PIM controller 260(1). In the same manner, the multicast interconnect 250 sequentially transmits the “(n−1)×16+2”-th sub-micro instruction sets corresponding to n=3 through n=31 over the second channel CH1 to the second PIM controller 260(1). Finally, the multicast interconnect 250 transmits the four hundred ninety-eighth sub-micro instruction set corresponding to n=32 over the second channel CH1 to the second PIM controller 260(1).

Similarly, when i is “16,” the multicast interconnect 250 transmits the sixteenth sub-micro instruction set corresponding to n=1 over the sixteenth channel CH15 to the sixteenth PIM controller 260(15). Subsequently, the multicast interconnect 250 transmits the thirty-second sub-micro instruction set corresponding to n=2 over the sixteenth channel CH15 to the sixteenth PIM controller 260(15). In the same manner, the multicast interconnect 250 sequentially transmits the “(n−1)×16+16”-th sub-micro instruction sets corresponding to n=3 through n=31 over the sixteenth channel CH15 to the sixteenth PIM controller 260(15). Finally, the multicast interconnect 250 transmits the five hundred twelfth sub-micro instruction set corresponding to n=32 over the sixteenth channel CH15 to the sixteenth PIM controller 260(15).

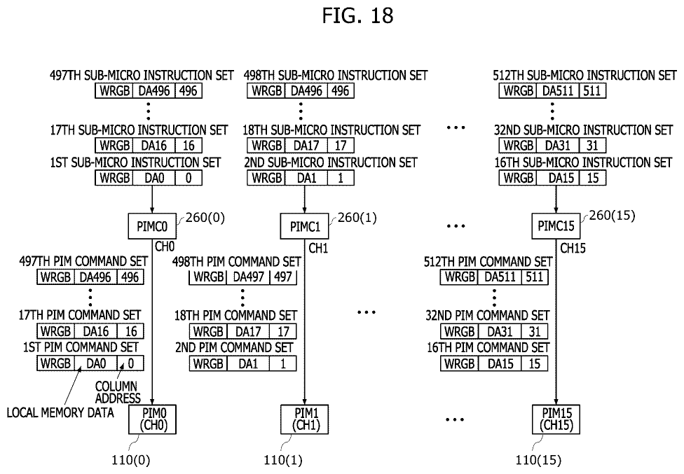

Referring to FIG. 18, the first through sixteenth PIM controllers 260(0)-260(15) each generate the first through five hundred twelfth PIM command sets based on the first through five hundred twelfth sub-micro instruction sets. The first through sixteenth PIM controllers 260(0)-260(15) respectively transmit the first through five hundred twelfth PIM command sets to the first through sixteenth PIM devices 110(0)-110(15). The transmission of the first through five hundred twelfth PIM command sets from the first through sixteenth PIM controllers 260(0)-260(15) to the first through sixteenth PIM devices 110(0)-110(15) is performed in the same manner as the transmission of the first through five hundred twelfth sub-micro instruction sets from the multicast interconnect 250 to the first through sixteenth PIM controllers 260(0)-260(15). Accordingly, the i-th PIM controller 260(i−1) transmits the “(n−1)×j+i”-th PIM command sets over the i-th channel CH (i−1) to the i-th PIM device 110(i−1).

As illustrated in FIG. 18, when i is “1,” the first PIM controller 260(0) transmits the first PIM command set corresponding to n=1 over the first channel CH0 to the first PIM device 110(0). Subsequently, the first PIM controller 260(0) transmits the seventeenth PIM command set corresponding to n=2 over the first channel CH0 to the first PIM device 110(0). In the same manner, the first PIM controller 260(0) sequentially transmits the “(n−1)×16+1”-th PIM command sets corresponding to n=3 through n=31 over the first channel CH0 to the first PIM device 110(0). Finally, the first PIM controller 260(0) transmits the four hundred ninety-seventh PIM command set corresponding to n=32 over the first channel CH0 to the first PIM device 110(0).

When i is “2,” the second PIM controller 260(1) transmits the second PIM command set corresponding to n=1 over the second channel CH1 to the second PIM device 110(1). Subsequently, the second PIM controller 260(1) transmits the eighteenth PIM command set corresponding to n=2 over the second channel CH1 to the second PIM device 110(1). In the same manner, the second PIM controller 260(1) sequentially transmits the “(n−1)×16+2”-th PIM command sets corresponding to n=3 through n=31 over the second channel CH1 to the second PIM device 110(1). Finally, the second PIM controller 260(1) transmits the four hundred ninety-eighth PIM command set corresponding to n=32 over the second channel CH1 to the second PIM device 110(1).

Similarly, when i is “16,” the sixteenth PIM controller 260(15) transmits the sixteenth PIM command set corresponding to n=1 over the sixteenth channel CH15 to the sixteenth PIM device 110(15). Subsequently, the sixteenth PIM controller 260(15) transmits the thirty-second PIM command set corresponding to n=2 over the sixteenth channel CH15 to the sixteenth PIM device 110(15). In the same manner, the sixteenth PIM controller 260(15) sequentially transmits the “(n−1)×16+16”-th PIM command sets corresponding to n=3 through n=31 over the sixteenth channel CH15 to the sixteenth PIM device 110(15). Finally, the sixteenth PIM controller 260(15) transmits the five hundred twelfth PIM command set corresponding to n=32 over the sixteenth channel CH15 to the sixteenth PIM device 110(15).

In one embodiment, each of the first through five hundred twelfth PIM command sets includes an operation type, local memory data, and a column address. The operation type, local memory data, and column address included in each of the first through thirty-second PIM command sets are identical to the operation type, local memory data, and column address included in each of the first through five hundred twelfth sub-micro instruction sets.

As illustrated in FIG. 18, the first PIM command set includes an operation type set to “WRGB,” local memory data set to “DA0,” and a column address set to “0.” The second PIM command set includes an operation type set to “WRGB,” local memory data set to “DA1,” and a column address set to “1.” The sixteenth PIM command set includes an operation type set to “WRGB,” local memory data set to “DA15,” and a column address set to “15.” The seventeenth PIM command set includes an operation type set to “WRGB,” local memory data set to “DA16,” and a column address set to “16.” The eighteenth PIM command set includes an operation type set to “WRGB,” local memory data set to “DA17,” and a column address set to “17.” Similarly, the thirty-second PIM command set includes an operation type set to “WRGB,” local memory data set to “DA31,” and a column address set to “31.” In the same manner, the four hundred ninety-seventh PIM command set includes an operation type set to “WRGB,” local memory data set to “DA496,” and a column address set to “496.” The four hundred ninety-eighth PIM command set includes an operation type set to “WRGB,” local memory data set to “DA497,” and a column address set to “497.” Similarly, the five hundred twelfth PIM command set includes an operation type set to “WRGB,” local memory data set to “DA511,” and a column address set to “511.”

Although not illustrated in the drawings, when the first through five hundred twelfth PIM command sets are transmitted, the first through sixteenth PIM devices 110(0)-110(15) store the first through five hundred twelfth local memory data DA0-DA511 as vector data in the storage locations of the global buffer specified by the column addresses included in the corresponding PIM command sets. Specifically, when the first through sixteenth PIM command sets are transmitted, the first through sixteenth PIM devices 110(0)-110(15) respectively store the first through sixteenth local memory data DA0-DA15 as vector data in the storage locations of the global buffer specified by the column addresses included in the respective first through sixteenth PIM command sets. Subsequently, when the seventeenth through thirty-second PIM command sets are transmitted, the first through sixteenth PIM devices 110(0)-110(15) respectively store the seventeenth through thirty-second local memory data DA16-DA31 as vector data in the storage locations of the global buffer specified by the corresponding column addresses. In the same manner, the thirty-third through four hundred ninety-sixth PIM command sets are processed similarly. Finally, when the four hundred ninety-seventh through five hundred twelfth PIM command sets are transmitted, the first through sixteenth PIM devices 110(0)-110(15) respectively store the four hundred ninety-seventh through five hundred twelfth local memory data DA496-DA511 as vector data in the storage locations of the global buffer specified by the corresponding column addresses.

Accordingly, in the global buffer of the first PIM device 110(0), the local memory data corresponding to the column addresses “0,” “16,” . . . , and “496,” namely, DA0, DA16, . . . , and DA496, are respectively stored. In the global buffer of the second PIM device 110(1), the local memory data corresponding to the column addresses “1,” “17,” . . . , and “497,” namely, DA1, DA17, . . . , and DA497, are respectively stored. Similarly, in the global buffer of the sixteenth PIM device 110(15), the local memory data corresponding to the column addresses “15,” “31,” . . . , and “511,” namely, DA15, DA31, . . . , and DA511, are respectively stored.

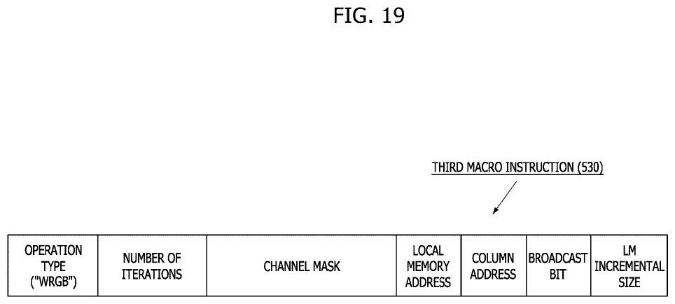

FIG. 19 is a diagram illustrating a third macro instruction used in the PIM system according to the present disclosure.

Referring to FIG. 19, a third macro instruction 530 may include an operation type, a number of iterations, a channel mask, a local memory address, a column address, a broadcast bit, and a local memory incremental size. In one embodiment, the local memory incremental size, the broadcast bit, the column address, the local memory address, the channel mask, the number of iterations, and the operation type may be sequentially arranged from the LSB to the MSB in the third macro instruction 530. The operation type, the channel mask, the local memory address, the column address, and the broadcast bit included in the third macro instruction 530 may be configured identically to those included in the second macro instruction 520 described with reference to FIG. 11. The local memory incremental size included in the third macro instruction 530 designates the increment size by which the local memory address is increased.

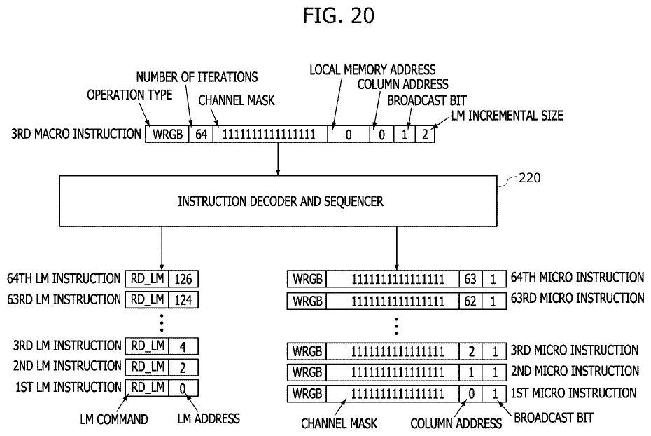

FIGS. 20 to 23 are diagrams illustrating an example process of executing the third macro instruction of FIG. 19 in the PIM system of FIG. 1. In this embodiment, it is assumed that the PIM system 10 includes first to sixteenth channels CH0 to CH15. Furthermore, it is assumed, for example, that the operation type, number of iterations, channel mask, local memory address, column address, broadcast bit, and local memory incremental size included in the third macro instruction are set respectively as “WRGB,” “64,” “1111 1111 1111 1111,” “0,” “0,” “1,” and “2.”

Referring to FIG. 20, when the third macro instruction is received, the instruction decoder and sequencer 220 decodes the third macro instruction and generates the same number of local memory instructions and micro instructions as the number of iterations specified in the third macro instruction. Because the number of iterations is set to “64,” the instruction decoder and sequencer 220 generates 64 local memory instructions, i.e., the first through sixty-fourth local memory instructions, and 64 micro instructions, i.e., the first through sixty-fourth micro instructions. The instruction decoder and sequencer 220 transmits the first through sixty-fourth local memory instructions to the local memory 230, and transmits the first through sixty-fourth micro instructions to the multicast interconnect 250.

Each of the first through sixty-fourth local memory instructions includes a local memory command and a local memory address. The local memory command is set to “RD_LM,” which indicates a read operation from the local memory. The local memory addresses included in the first through sixty-fourth local memory instructions are all different from one another. Specifically, the local memory addresses increment sequentially by the size specified in the local memory incremental size field, i.e., by “2,” starting from the local memory address “0” specified in the third macro instruction.

As illustrated in FIG. 20, the first local memory instruction includes the local memory address “0,” which is identical to the starting local memory address specified in the third macro instruction. The second local memory instruction includes the local memory address “2,” obtained by incrementing “2” from the address of the first local memory instruction. The third local memory instruction includes the local memory address “4,” obtained by further incrementing “2” from the address of the second local memory instruction. Similarly, the sixty-third local memory instruction includes the local memory address “124,” which is obtained by incrementing “2” from the address “122” (not shown) included in the sixty-second local memory instruction. The sixty-fourth local memory instruction includes the local memory address “126,” which is obtained by incrementing “2” from the address “124” included in the sixty-third local memory instruction.

Each of the first through sixty-fourth micro instructions includes an operation type, a channel mask, a column address, and a broadcast bit. The operation type, the channel mask, and the broadcast bit included in each of the first through sixty-fourth micro instructions are identical to those included in the third macro instruction. That is, the channel masks included in each of the first through sixty-fourth micro instructions are all configured with the same binary stream “1111 1111 1111 1111,” which is identical to the channel mask included in the third macro instruction. On the other hand, the column addresses included in the first through sixty-fourth micro instructions have different values from one another.

Specifically, the column address included in the first micro instruction is identical to the starting column address included in the third macro instruction, i.e., “0.” The column address included in the second micro instruction is the next column address value “1,” incremented from the column address “0” of the first micro instruction. The column address included in the third micro instruction is the next column address value “2,” incremented from the column address “1” of the second micro instruction. Similarly, the column address included in the sixty-fourth micro instruction is the next column address value “63,” incremented from the column address “62” of the sixty-third micro instruction. Thus, the column addresses included in the first through sixty-fourth micro instructions sequentially increment by “1,” starting from the starting column address “0” included in the third macro instruction.

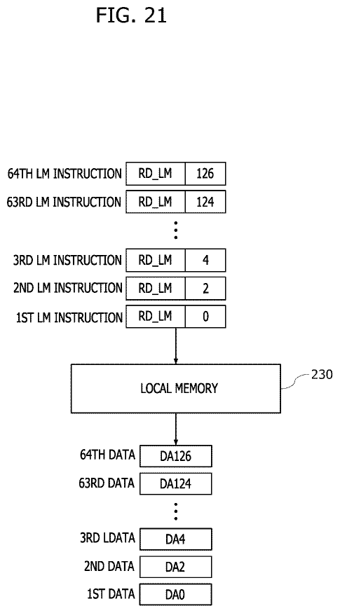

Referring to FIG. 21, the local memory 230, having received the first through sixty-fourth local memory instructions from the instruction decoder and sequencer 220, sequentially outputs the first through sixty-fourth local memory data DA0, DA2, . . . , DA126 in response to the local memory instructions, and transmits the data to the multicast interconnect 250. The first local memory data DA0, which is output first from the local memory 230, is data stored in a first area of the local memory 230 designated by the local memory address “0” included in the first local memory instruction. Subsequently, the second local memory data DA2, which is output from the local memory 230, is data stored in a second area of the local memory 230 designated by the local memory address “2” included in the second local memory instruction. Then, the third local memory data DA4, which is output from the local memory 230, is data stored in a third area of the local memory 230 designated by the local memory address “4” included in the third local memory instruction. Similarly, the sixty-third local memory data DA124, which is output as the sixty-third data from the local memory 230, is data stored in a sixty-third area of the local memory 230 designated by the local memory address “124” included in the sixty-third local memory instruction. Finally, the sixty-fourth local memory data DA126, which is output last from the local memory 230, is data stored in a sixty-fourth area of the local memory 230 designated by the local memory address “126” included in the sixty-fourth local memory instruction.

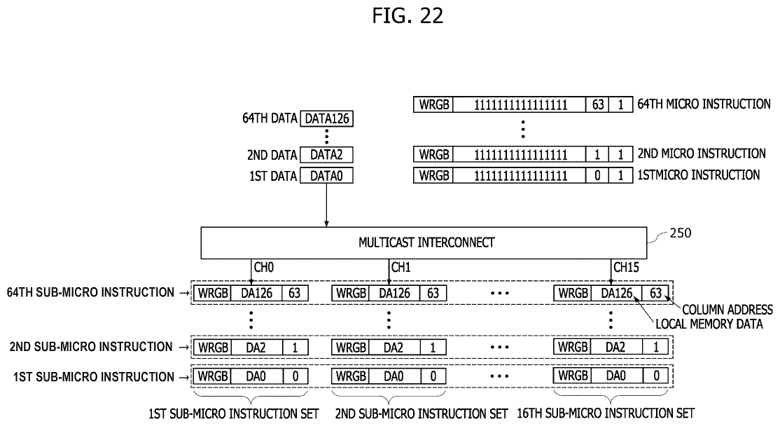

Referring to FIG. 22, the multicast interconnect 250, based on the first through sixty-fourth data DA0, DA2, . . . , DA126 transmitted from the local memory 230 and the first through sixty-fourth micro instructions transmitted from the instruction decoder and sequencer 220, generates and outputs one or more sub-micro instruction sets. The number of sub-micro instruction sets output by the multicast interconnect 250 may be determined according to the bit values of any one of the channel masks included in the first through sixty-fourth micro instructions. Specifically, the multicast interconnect 250 outputs the number of sub-micro instruction sets corresponding to the number of bits set to a binary value of “1” among the first through sixteenth bits of the channel mask. In the present example, because the channel masks included in the first through sixty-fourth micro instructions all have a value of “1111 1111 1111 1111” that designates all of the first through sixteenth channels, the multicast interconnect 250 outputs the first through sixteenth sub-micro instruction sets.

Each of the first through sixteenth sub-micro instruction sets includes the first through sixty-fourth sub-micro instructions. Each of the first through sixty-fourth sub-micro instructions includes an operation type, data, and a column address. The operation type included in each of the first through sixty-fourth sub-micro instructions is identical to the operation type included in the first through sixty-fourth micro instructions. The data included in the first through sixty-fourth sub-micro instructions is identical to the first through sixty-fourth local memory data transmitted from the local memory 230 to the multicast interconnect 250. The column addresses included in the first through sixty-fourth sub-micro instructions are identical to the column addresses included in the first through sixty-fourth micro instructions. Accordingly, each of the first sub-micro instructions included in the first through sixteenth sub-micro instruction sets includes the second operation type “WRGB,” the data DA0, and the column address “0.” Each of the second sub-micro instructions included in the first through sixteenth sub-micro instruction sets includes “WRGB,” the data DA2, and the column address “1.” Similarly, each of the sixty-fourth sub-micro instructions included in the first through sixteenth sub-micro instruction sets includes “WRGB,” the data DA126, and the column address “63.”

The multicast interconnect 250 transmits the first through sixteenth sub-micro instruction sets to the first through sixteenth PIM controllers 260(0) to 260(15), respectively. Specifically, the multicast interconnect 250 sequentially transmits the first through sixty-fourth sub-micro instructions included in the first sub-micro instruction set to the first PIM controller 260(0). The multicast interconnect 250 sequentially transmits the first through sixty-fourth sub-micro instructions included in the second sub-micro instruction set to the second PIM controller 260(1). Similarly, the multicast interconnect 250 sequentially transmits the first through sixty-fourth sub-micro instructions included in the sixteenth sub-micro instruction set to the sixteenth PIM controller 260(15).

The transmission of the first through sixteenth sub-micro instruction sets to the first through sixteenth PIM controllers 260(0) to 260(15) may be performed in parallel. Specifically, the multicast interconnect 250 simultaneously transmits the first sub-micro instructions included in the first through sixteenth sub-micro instruction sets to the first through sixteenth PIM controllers 260(0) to 260(15), respectively. Next, the multicast interconnect 250 simultaneously transmits the second sub-micro instructions included in the first through sixteenth sub-micro instruction sets to the first through sixteenth PIM controllers 260(0) to 260(15), respectively. Similarly, the third through sixty-third sub-micro instructions included in the first through sixteenth sub-micro instruction sets are transmitted in the same manner to the corresponding PIM controllers. Finally, the multicast interconnect 250 transmits the sixty-fourth sub-micro instructions included in the first through sixteenth sub-micro instruction sets to the first through sixteenth PIM controllers 260(0) to 260(15), respectively. The words “simultaneous” and “simultaneously” as used herein with respect to processes mean that the processes take place on overlapping intervals of time. For example, if a first process takes place over a first interval of time and a second process takes place simultaneously over a second interval of time, then the first and second intervals at least partially overlap each other such that there exists a time at which the first and second processes are both taking place.

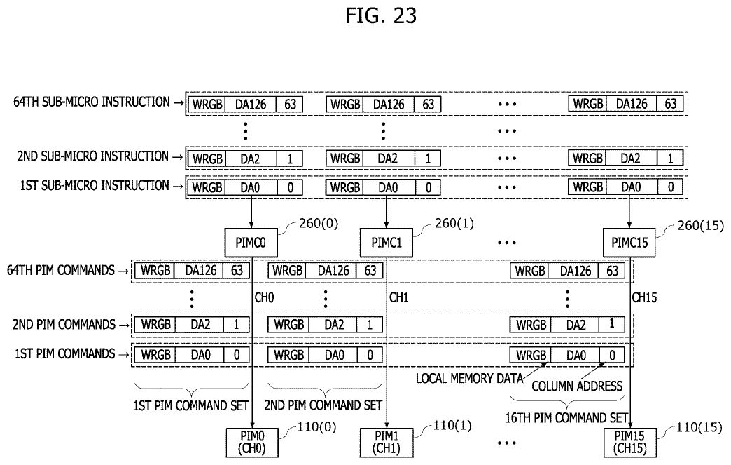

Referring to FIG. 23, the first through sixteenth PIM controllers 260(0) to 260(15) generate the first through sixteenth PIM command sets, respectively, based on the first through sixteenth sub-micro instruction sets. The first through sixteenth PIM controllers 260(0) to 260(15) respectively transmit the first through sixteenth PIM command sets to the first through sixteenth PIM devices 110(0) to 110(15) via the first through sixteenth channels CH0 to CH15. Specifically, the first PIM controller 260(0) generates the first PIM command set based on the first sub-micro instruction set, and transmits the generated first PIM command set to the first PIM device 110(0). The second PIM controller 260(1) generates the second PIM command set based on the second sub-micro instruction set, and transmits the generated second PIM command set to the second PIM device 110(1). Similarly, the sixteenth PIM controller 260(15) generates the sixteenth PIM command set based on the sixteenth sub-micro instruction set, and transmits the generated sixteenth PIM command set to the sixteenth PIM device 110(15).

In one embodiment, each of the first through sixteenth PIM command sets may include the first through sixty-fourth PIM commands. Each of the first through sixty-fourth PIM commands includes an operation type, local memory data, and a column address. The operation type, local memory data, and column address included in each of the first through sixty-fourth PIM commands are identical to the operation type, local memory data, and column address included in the first through sixty-fourth sub-micro instructions, respectively. Accordingly, each of the first PIM commands included in the first through sixteenth PIM command sets includes the operation type “WRGB,” the local memory data DA0, and the column address 0. Each of the second PIM commands included in the first through sixteenth PIM command sets includes the operation type “WRGB,” the local memory data DA2, and the column address 1. Similarly, each of the sixty-fourth PIM commands included in the first through sixteenth PIM command sets includes the operation type “WRGB,” the local memory data DA126, and the column address 63.

The transmission of the first through sixteenth PIM command sets from the first through sixteenth PIM controllers 260(0) to 260(15) to the first through sixteenth PIM devices 110(0) to 110(15) is performed in parallel. Specifically, the first through sixteenth PIM controllers 260(0) to 260(15) respectively transmit the first PIM commands included in the first through sixteenth PIM command sets to the first through sixteenth PIM devices 110(0) to 110(15). Subsequently, the first through sixteenth PIM controllers 260(0) to 260(15) respectively transmit the second PIM commands included in the first through sixteenth PIM command sets to the first through sixteenth PIM devices 110(0) to 110(15). The third through sixty-third PIM commands included in the first through sixteenth PIM command sets are transmitted in the same manner to the first through sixteenth PIM devices 110(0) to 110(15). Finally, the first through sixteenth PIM controllers 260(0) to 260(15) respectively transmit the sixty-fourth sub-micro instructions included in the first through sixteenth sub-micro instruction sets to the first through sixteenth PIM devices 110(0) to 110(15).

Although not illustrated in the drawings, each of the first through sixteenth PIM devices 110(0) to 110(15) that receives the first through sixteenth PIM command sets stores the first through sixty-fourth data DA0, DA2, . . . , DA126 in the sixty-four storage locations of a global buffer designated by the column addresses included in the first through sixty-fourth PIM commands. The first through sixty-fourth data DA0, DA2, . . . , DA126 stored in the global buffers of the first through sixteenth PIM devices 110(0) to 110(15) may be used as operand data, i.e., vector data, during operations performed by processing elements included in the first through sixteenth PIM devices 110(0) to 110(15).

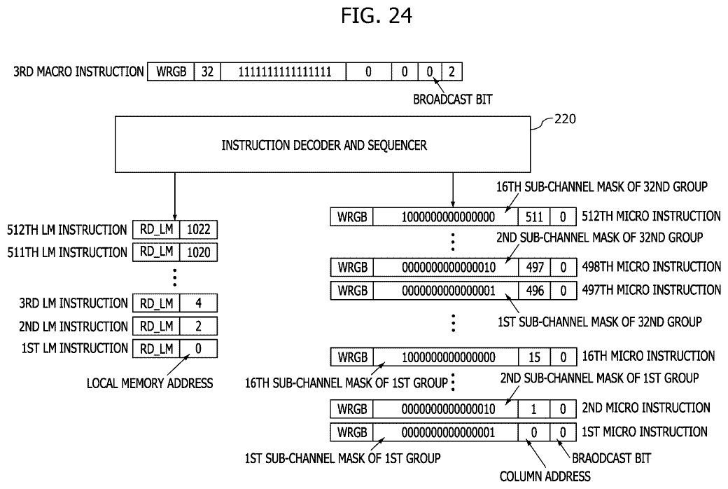

FIGS. 24 to 27 are diagrams illustrating another example process of executing the third macro instruction of FIG. 19 in the PIM system of FIG. 1. In this example, it is assumed that the PIM system 10 includes the first to sixteenth channels CH0 to CH15. The operation type, number of iterations, channel mask, local memory address, column address, broadcast bit, and local memory incremental size included in the third macro instruction are respectively set to “WRGB,” “64,” “1111 1111 1111 1111,” “0,” “0,” “0,” and “2.” Unlike the example explained with reference to FIGS. 20 to 23, in which the broadcast bit of the third macro instruction is set to a binary value of “1,” in this example, the broadcast bit of the third macro instruction is set to a binary value of “0.”

Referring to FIG. 24, when the third macro instruction having a broadcast bit set to a binary value of “0” is transmitted, the instruction decoder and sequencer 220 decodes the third macro instruction and generates a number of local memory instructions and micro instructions equal to the product of the number of iterations and the number of bits having a binary value of “1” in the channel mask. Because the number of iterations in the third macro instruction is set to “32” and the number of bits having a binary value of “1” in the channel mask is “16,” the instruction decoder and sequencer 220 generates 512 local memory instructions, namely, first to 512th local memory instructions, and 512 micro instructions, namely, first to 512th micro instructions. The instruction decoder and sequencer 220 transmits the first to 512th local memory instructions to the local memory 230 and transmits the first to 512th micro instructions to the multicast interconnect 250.

The process of generating the first to 512th local memory instructions may be performed substantially in the same manner as the process described with reference to FIG. 15. Accordingly, each of the first to 512th local memory instructions includes a local memory command, which is a read command (RD_LM) for the local memory, and a local memory address. From the first to the 512th local memory instructions, the local memory addresses sequentially increase from the local memory address “0” included in the third macro instruction, incremented by the local memory incremental size “2.”

As illustrated in FIG. 24, the local memory address included in the first local memory instruction has the same value as the local memory address included in the third macro instruction, that is, “0.” The local memory address included in the second local memory instruction has a value of “2,” which is obtained by incrementing the first local memory address “0” by the local memory incremental size “2.” The local memory address included in the third local memory instruction has a value of “4,” obtained by incrementing the second local memory address “2” by the local memory incremental size “2.” In the same manner, the local memory address included in the 511th local memory instruction has a value of “1020,” obtained by incrementing the 510th local memory address “1018” (not shown) by “2.” The local memory address included in the 512th local memory instruction has a value of “1022,” obtained by incrementing the 511th local memory address “1020” by “2.”

The process for generating the first to 512th micro instructions may be performed substantially in the same manner as the process described with reference to FIG. 15. Accordingly, each of the first to 512th micro instructions includes an operation type, a channel mask, a column address, and a broadcast bit. The operation types and broadcast bits included in the first to 512th micro instructions are respectively set to the second operation type “WRGB” and the binary value “0.”

From the first to the 512th micro instructions, the column addresses sequentially increase by one, starting from the column address “0” included in the third macro instruction. Thus, the column address included in the first micro instruction has the same value as the starting column address, that is, “0.” The column address included in the second micro instruction has a value of “1,” which is the next column address following the column address “0” included in the first micro instruction. Although omitted from FIG. 24, the column address included in the third micro instruction has a value of “2,” following the column address “1” of the second micro instruction. Similarly, the column address included in the 16th micro instruction has a value of “15,” following the column address “14” of the 15th micro instruction (not shown). In the same manner, the column address included in the 497th micro instruction has a value of “496,” following the column address “495” of the 496th micro instruction (not shown). The column address included in the 498th micro instruction has a value of “497,” following the column address “496” of the 497th micro instruction. Finally, the column address included in the 512th micro instruction has a value of “511,” following the column address “510” of the 511th micro instruction.

As described with reference to FIG. 5, the channel masks included in the first to 512th micro instructions may be grouped into 32 groups, for example, the first to the thirty-second groups, each including first to sixteenth sub-channel masks. The first group includes the first to sixteenth sub-channel masks, which correspond to the first to sixteenth channel masks included in the first to sixteenth micro instructions. Although omitted from FIG. 24, the second group includes the first to sixteenth sub-channel masks, which correspond to the seventeenth to thirty-second channel masks included in the seventeenth to thirty-second micro instructions. Similarly, the thirty-second group includes the first to sixteenth sub-channel masks, which correspond to the 497th to 512th channel masks included in the 497th to 512th micro instructions.

In this embodiment, because the number of channels “j” is “16” and the number of iterations “m” is “32,” the “i”-th sub-channel masks (where “i” is a natural number from 1 to 16) among the first to sixteenth sub-channel masks of each of the first to thirty-second groups are configured with identical binary streams. Specifically, the “i”-th sub-channel masks have a binary stream in which only the “i”-th channel bit is set to the binary value “1,” and all other bits are set to the binary value “0.”

As illustrated in FIG. 24, in the first sub-channel masks of the first to thirty-second groups (that is, the channel masks included in the first, seventeenth, thirty-third, forty-ninth, . . . , 481st, and 497th micro instructions), only the first channel bit has the binary value “1,” while the second to sixteenth channel bits have the binary value “0.” That is, the first sub-channel masks of the first to thirty-second groups are each configured with the binary stream “0000 0000 0000 0001.” In the second sub-channel masks of the first to thirty-second groups (that is, the channel masks included in the second, eighteenth, thirty-fourth, fiftieth, . . . , 482nd, and 498th micro instructions), only the second channel bit has the binary value “1,” while the first and third to sixteenth channel bits have the binary value “0.” That is, the second sub-channel masks of the first to thirty-second groups are each configured with the binary stream “0000 0000 0000 0010.” In the same manner, in the sixteenth sub-channel masks of the first to thirty-second groups (that is, the channel masks included in the sixteenth, thirty-second, forty-eighth, sixty-fourth, . . . , 496th, and 512th micro instructions), only the sixteenth channel bit has the binary value “1,” while the first to fifteenth channel bits have the binary value “0.” Thus, the sixteenth sub-channel masks of the first to thirty-second groups are each configured with the binary stream “1000 0000 0000 0000.”

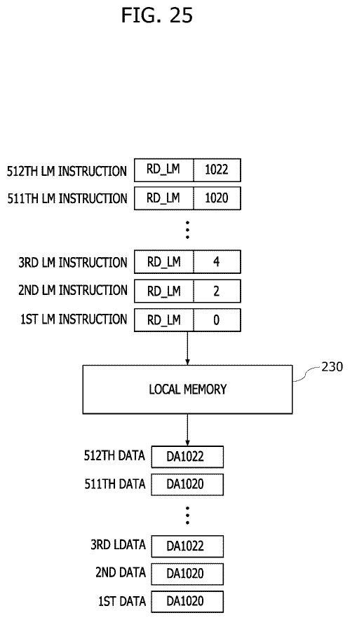

Referring to FIG. 25, the local memory 230, having received the first to 512th local memory instructions from the instruction decoder and sequencer 220, sequentially outputs the first to 512th data DA0, DA2, . . . , DA1022 in response to the corresponding local memory instructions. The local memory 230 transmits the first to 512th data DA0, DA2, . . . , DA1022 to the multicast interconnect 250. The first data DA0 output from the local memory 230 corresponds to the data stored in a first region of the local memory 230 designated by the local memory address “0” included in the first local memory instruction. The second data DA2 output from the local memory 230 corresponds to the data stored in a second region of the local memory 230 designated by the local memory address “2” included in the second local memory instruction. Similarly, the third data DA4 output from the local memory 230 corresponds to the data stored in a third region of the local memory 230 designated by the local memory address “4” included in the third local memory instruction. In the same manner, the 511th data DA1020 output from the local memory 230 corresponds to the data stored in the 511th region of the local memory 230 designated by the local memory address “1018” included in the 510th local memory instruction (not illustrated). Finally, the 512th data DA1022 output from the local memory 230 corresponds to the data stored in the 512th region of the local memory 230 designated by the local memory address “1020” included in the 511th local memory instruction.

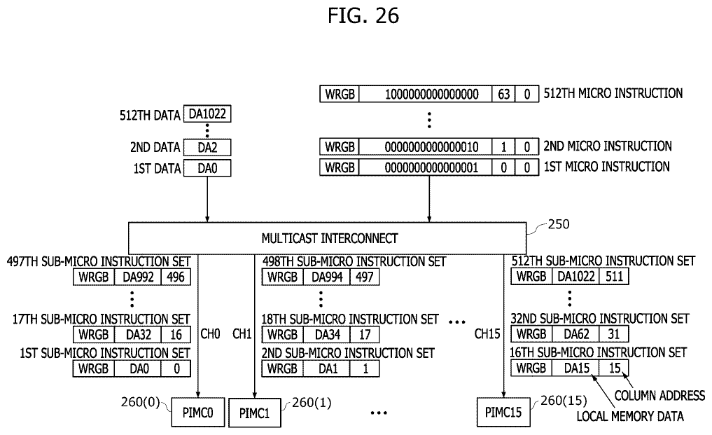

Referring to FIG. 26, the multicast interconnect 250 receives the first to 512th data DA0, DA2, . . . , DA1022 from the local memory 230 and the first to 512th micro instructions from the instruction decoder and sequencer 220. Because the broadcast bits included in the first to 512th micro instructions are set to a binary value of “0,” the multicast interconnect 250 generates and outputs one or more sub-micro instruction sets based on the first to 512th micro instructions and the first to 512th data DA0, DA2, . . . , DA1022. The number of sub-micro instruction sets output from the multicast interconnect 250 is the same as the number of micro instructions input to the multicast interconnect 250. Because the first to 512th micro instructions are input to the multicast interconnect 250, the multicast interconnect 250 generates and outputs the first to 512th sub-micro instruction sets.

Each of the first to 512th sub-micro instruction sets includes an operation type, local memory data, and a column address. The operation type included in each of the first to 512th sub-micro instruction sets is set to the second operation type “WRGB,” identical to the operation type included in the first to 512th micro instructions. The local memory data included in each of the first to 512th sub-micro instruction sets corresponds respectively to the first to 512th data DA0, DA2, . . . , DA1022 transmitted from the local memory 230 to the multicast interconnect 250. As illustrated in FIG. 26, the first sub-micro instruction set includes the first local memory data DA0, the second sub-micro instruction set includes the second local memory data DA2, and similarly, the 16th sub-micro instruction set includes the 16th local memory data DA30. The 17th sub-micro instruction set includes the 17th local memory data DA32, the 18th sub-micro instruction set includes the 18th local memory data DA34, and similarly, the 32nd sub-micro instruction set includes the 32nd local memory data DA62. In the same manner, the 497th sub-micro instruction set includes the 497th local memory data DA992, the 498th sub-micro instruction set includes the 498th local memory data DA994, and the 512th sub-micro instruction set includes the 512th local memory data DA1022.

The column addresses included in the first to 512th sub-micro instruction sets are respectively identical to the column addresses included in the first to 512th micro instructions. As illustrated in FIG. 26, the first sub-micro instruction set includes column address “0,” the second sub-micro instruction set includes column address “1,” and the 16th sub-micro instruction set includes column address “15.” The 17th sub-micro instruction set includes column address “16,” the 18th sub-micro instruction set includes column address “17,” and similarly, the 32nd sub-micro instruction set includes column address “31.” The 33rd sub-micro instruction set includes column address “32.” In the same manner, the 497th sub-micro instruction set includes column address “496,” the 498th sub-micro instruction set includes column address “497,” and the 512th sub-micro instruction set includes column address “511.”

Because the broadcast bits included in the first to 512th micro instructions are set to a binary value of “0,” the multicast interconnect 250 determines the transmission channel for each of the first to 512th sub-micro instruction sets based on the channel masks included in the corresponding micro instructions. Specifically, the multicast interconnect 250 transmits the “(n−1)×j+i”-th sub-micro instruction set to the ith PIM controller 260(i−1) through the ith channel CH (i−1), where “n” represents a natural number ranging from 1 to 32, “j” represents the number of channels, which is 16, and “i” represents a natural number ranging from 1 to 16.

As illustrated in FIG. 26, when “i” is equal to 1, the multicast interconnect 250 transmits the first sub-micro instruction set corresponding to “n” equal to 1 to the first PIM controller 260(0) through the first channel CH0. Subsequently, the multicast interconnect 250 transmits the 17th sub-micro instruction set corresponding to “n” equal to 2 to the first PIM controller 260(0) through the first channel CH0. In the same manner, the multicast interconnect 250 transmits the “(n−1)×16+1”-th sub-micro instruction sets corresponding to “n” ranging from 3 to 31 to the first PIM controller 260(0) through the first channel CH0. Finally, the multicast interconnect 250 transmits the 497th sub-micro instruction set corresponding to “n” equal to 32 to the first PIM controller 260(0) through the first channel CH0.

When “i” is equal to 2, the multicast interconnect 250 transmits the second sub-micro instruction set corresponding to “n” equal to 1 to the second PIM controller 260(1) through the second channel CH1. Next, the multicast interconnect 250 transmits the 18th sub-micro instruction set corresponding to “n” equal to 2 to the second PIM controller 260(1) through the second channel CH1. Similarly, the multicast interconnect 250 transmits the “(n−1)×16+2”-th sub-micro instruction sets corresponding to “n” ranging from 3 to 31 to the second PIM controller 260(1) through the second channel CH1. Finally, the multicast interconnect 250 transmits the 498th sub-micro instruction set corresponding to “n” equal to 32 to the second PIM controller 260(1) through the second channel CH1.

In the same manner, when “i” is equal to 16, the multicast interconnect 250 transmits the 16th sub-micro instruction set corresponding to “n” equal to 1 to the sixteenth PIM controller 260(15) through the sixteenth channel CH15. Subsequently, the multicast interconnect 250 transmits the 32nd sub-micro instruction set corresponding to “n” equal to 2 to the sixteenth PIM controller 260(15) through the sixteenth channel CH15. Similarly, the multicast interconnect 250 transmits the “(n−1)×16+16”-th sub-micro instruction sets corresponding to “n” ranging from 3 to 31 to the sixteenth PIM controller 260(15) through the sixteenth channel CH15. Finally, the multicast interconnect 250 transmits the 512th sub-micro instruction set corresponding to “n” equal to 32 to the sixteenth PIM controller 260(15) through the sixteenth channel CH15.

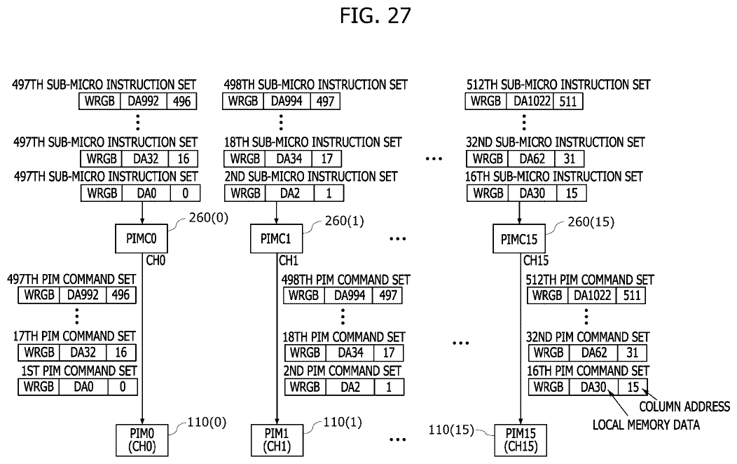

Referring to FIG. 27, the first to sixteenth PIM controllers 260(0) to 260(15) respectively generate the first to 512th PIM command sets based on the first to 512th sub-micro instruction sets. The first to sixteenth PIM controllers 260(0) to 260(15) respectively transmit the first to 512th PIM command sets to the first to sixteenth PIM devices 110(0) to 110(15). The method of transmitting the first to 512th PIM command sets from the first to sixteenth PIM controllers 260(0) to 260(15) to the first to sixteenth PIM devices 110(0) to 110(15) may be performed in the same manner as the method of transmitting the first to 512th sub-micro instruction sets from the multicast interconnect 250 to the first to sixteenth PIM controllers 260(0) to 260(15). Accordingly, the “i”th PIM controller 260(i−1) transmits the “(n−1)×j+i”-th PIM command sets to the “i”th PIM device 110(i−1) via the “i”th channel CH (i−1).

As illustrated in FIG. 27, when “i” is equal to 1, the first PIM controller 260(0) transmits the first PIM command set corresponding to “n” equal to 1 to the first PIM device 110(0) via the first channel CH0. Next, the first PIM controller 260(0) transmits the 17th PIM command set corresponding to “n” equal to 2 to the first PIM device 110(0) via the first channel CH0. Similarly, the first PIM controller 260(0) transmits the “(n−1)×16+1”-th PIM command sets corresponding to “n” ranging from 3 to 31 to the first PIM device 110(0) via the first channel CH0. Finally, the first PIM controller 260(0) transmits the 497th PIM command set corresponding to “n” equal to 32 to the first PIM device 110(0) via the first channel CH0.

When “i” is equal to 2, the second PIM controller 260(1) transmits the second PIM command set corresponding to “n” equal to 1 to the second PIM device 110(1) via the second channel CH1. Next, the second PIM controller 260(1) transmits the 18th PIM command set corresponding to “n” equal to 2 to the second PIM device 110(1) via the second channel CH1. Similarly, the second PIM controller 260(1) transmits the “(n−1)×16+2”-th PIM command sets corresponding to “n” ranging from 3 to 31 to the second PIM device 110(1) via the second channel CH1. Finally, the second PIM controller 260(1) transmits the 498th PIM command set corresponding to “n” equal to 32 to the second PIM device 110(1) via the second channel CH1.

In the same manner, when “i” is equal to 16, the sixteenth PIM controller 260(15) transmits the 16th PIM command set corresponding to “n” equal to 1 to the sixteenth PIM device 110(15) via the sixteenth channel CH15. Next, the sixteenth PIM controller 260(15) transmits the 32nd PIM command set corresponding to “n” equal to 2 to the sixteenth PIM device 110(15) via the sixteenth channel CH15. Similarly, the sixteenth PIM controller 260(15) transmits the “(n−1)×16+16”-th PIM command sets corresponding to “n” ranging from 3 to 31 to the sixteenth PIM device 110(15) via the sixteenth channel CH15. Finally, the sixteenth PIM controller 260(15) transmits the 512th PIM command set corresponding to “n” equal to 32 to the sixteenth PIM device 110(15) via the sixteenth channel CH15.

In one embodiment, each of the first to 512th PIM command sets includes an operation type, local memory data, and a column address. The operation types included in the first to 512th PIM command sets are identical to the operation types included in the first to 512th sub-micro instruction sets. The local memory data included in the first to 512th PIM command sets are identical to the local memory data included in the first to 512th sub-micro instruction sets. The column addresses included in the first to 512th PIM command sets are identical to the column addresses included in the first to 512th sub-micro instruction sets.

As illustrated in FIG. 24, the operation types included in the first to 512th PIM command sets are all set to “WRGB.” The first PIM command set includes the data and the column address set to “DA0” and “0,” respectively. The second PIM command set includes the data and the column address set to “DA2” and “1,” respectively. Similarly, the sixteenth PIM command set includes the data and the column address set to “DA30” and “15,” respectively. The seventeenth PIM command set includes the data and the column address set to “DA32” and “16,” respectively. The eighteenth PIM command set includes the data and the column address set to “DA34” and “17,” respectively. Likewise, the thirty-second PIM command set includes the data and the column address set to “DA62” and “31,” respectively. In the same manner, the 497th PIM command set includes the operation type, the local memory data, and the column address set to “WRGB,” “DA992,” and “496,” respectively. The 498th PIM command set includes the operation type, the local memory data, and the column address set to “WRGB,” “DA994,” and “497,” respectively. Similarly, the 512th PIM command set includes the operation type, the local memory data, and the column address set to “WRGB,” “DA1022,” and “511,” respectively.

Although not illustrated in the drawings, when the first to 512th PIM command sets are transmitted, the first to sixteenth PIM devices 110(0) to 110(15) respectively store the first to 512th local memory data DA0, DA2, . . . , DA1022, designated by the column addresses included in the first to 512th PIM command sets, as vector data in storage locations of a global buffer.

Specifically, when the first to sixteenth PIM command sets are transmitted, the first to sixteenth PIM devices 110(0) to 110(15) respectively store the first to sixteenth local memory data DA0, DA2, . . . , DA30, designated by the column addresses included in the first to sixteenth PIM command sets, as vector data in the corresponding storage locations of the global buffer. Subsequently, when the seventeenth to thirty-second PIM command sets are transmitted, the first to sixteenth PIM devices 110(0) to 110(15) respectively store the seventeenth to thirty-second local memory data DA32, DA34, . . . , DA62, designated by the column addresses included in the seventeenth to thirty-second PIM command sets, as vector data. In the same manner, the thirty-third to 496th PIM command sets are processed. Finally, when the 497th to 512th PIM command sets are transmitted, the first to sixteenth PIM devices 110(0) to 110(15) respectively store the 497th to 512th local memory data DA992, DA994, . . . , DA1022, designated by the column addresses included in the 497th to 512th PIM command sets, as vector data.

Accordingly, in the first PIM device 110(0), the local memory data DA0, DA32, . . . , DA992 are respectively stored in the storage locations of the global buffer designated by the column addresses “0,” “16,” . . . , and “496.” In the second PIM device 110(1), the local memory data DA2, DA34, . . . , DA994 are respectively stored in the storage locations of the global buffer designated by the column addresses “1,” “17,” . . . , and “497.” Similarly, in the sixteenth PIM device 110(15), the local memory data DA30, DA62, . . . , DA1022 are respectively stored in the storage locations of the global buffer designated by the column addresses “15,” “31,” . . . , and “511.”

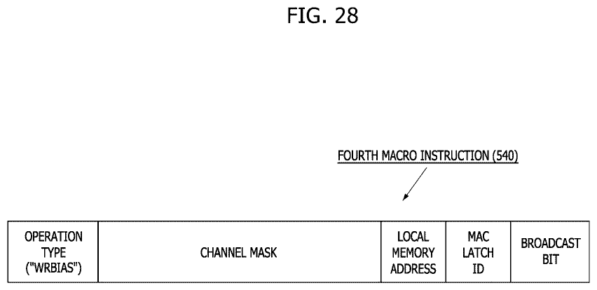

FIG. 28 is a diagram illustrating a fourth macro instruction used in the PIM system according to the present disclosure.

Referring to FIG. 28, a fourth macro instruction 540 may include an operation type, a channel mask, a local memory address, a MAC latch ID, and a broadcast bit. In one embodiment, the broadcast bit may optionally be omitted from the fourth macro instruction 540. In one embodiment, the broadcast bit, the MAC latch ID, the local memory address, the channel mask, and the operation type may be sequentially arranged from the LSB to the MSB within the fourth macro instruction 540.

In one embodiment, the operation type may be set to “WRBIAS,” which specifies an operation to latch data, such as bias data, into a latch circuit included in a processing element of a target PIM device. The channel mask may include bits respectively corresponding to channels included in the PIM system. Depending on the binary values of the bits included in the channel mask, the channels to which the sub-micro instruction sets and the PIM command sets are transmitted may be designated. The local memory address may designate a starting address of a local memory where the bias data to be latched into the latch circuit of the PIM device is stored. The MAC latch ID may designate a specific latch circuit, among the circuits included in the processing element of the PIM device, into which the bias data is latched. The broadcast bit may be set to a first binary value, e.g., “1,” or a second binary value, e.g., “0.” When the broadcast bit is set to the first binary value “1,” the instruction and data transmission method may be designated as a broadcasting transmission method that transmits data identically to all channels. In contrast, when the broadcast bit is set to the second binary value “0,” the instruction and data transmission method may be designated as a unicasting transmission method or a multicasting transmission method, in which transmission is performed differently for each channel.

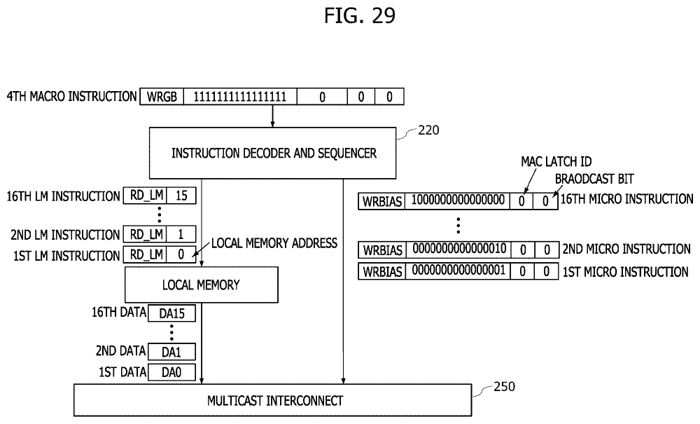

FIGS. 29 to 31 are diagrams illustrating a process of executing the fourth macro instruction of FIG. 28 in the PIM system of FIG. 1. In this example, it is assumed that the PIM system 10 includes first through sixteenth channels CH0-CH15. Further, it is assumed, for example, that the operation type, the channel mask, the local memory address, the MAC latch ID, and the broadcast bit included in the fourth macro instruction are respectively set as “WRBIAS,” “1111 1111 1111 1111,” “0,” “0,” and “0.”

Referring to FIG. 29, when the fourth macro instruction is transmitted, the instruction decoder and sequencer 220 decodes the fourth macro instruction to generate one or more local memory instructions and micro instructions. The number of local memory instructions and micro instructions generated by the instruction decoder and sequencer 220 corresponds to the number of bits having a binary value of “1” in the channel mask included in the fourth macro instruction. Because the channel mask “1111 1111 1111 1111” included in the fourth macro instruction has sixteen bits each having a binary value of “1,” the instruction decoder and sequencer 220 generates sixteen local memory instructions, that is, first to sixteenth local memory instructions, and sixteen micro instructions, that is, first to sixteenth micro instructions. The instruction decoder and sequencer 220 transmits the first to sixteenth local memory instructions to the local memory 230 and transmits the first to sixteenth micro instructions to the multicast interconnect 250.

Each of the first to sixteenth local memory instructions includes a read command “RD_LM” for the local memory and a local memory address. The local memory addresses included in the first to sixteenth local memory instructions have different values from each other. Specifically, the local memory address for the first local memory instruction has the same value as the start address of the local memory included in the fourth macro instruction, that is, “0.” The local memory address for the second local memory instruction has the next address value “1” following the address “0” included in the first local memory instruction. Although not shown in the drawing, the local memory address for the third local memory instruction is “2,” which is the next address following the address “1” of the second local memory instruction. Similarly, the local memory address for the sixteenth local memory instruction is “15,” which is the next address following “14” of the fifteenth local memory instruction.

Each of the first to sixteenth micro instructions includes an operation type, a channel mask, a MAC latch ID, and a broadcast bit. The operation type, MAC latch ID, and broadcast bit included in each of the first to sixteenth micro instructions are identical to the operation type, MAC latch ID, and broadcast bit included in the fourth macro instruction. Accordingly, in the first to sixteenth micro instructions, the operation type, MAC latch ID, and broadcast bit are set to “WRBIAS,” “0,” and “0,” respectively.

Each of the channel masks included in the first to sixteenth micro instructions consists of a binary stream having sixteen bits, corresponding to the number of channels, that is, the number of bits of the channel mask included in the fourth macro instruction. Because the broadcast bit included in the fourth macro instruction is set to “0,” as described with reference to FIG. 6, each of the first to sixteenth channel masks has only one bit set to “1,” and all other bits set to “0.”

As illustrated in FIG. 29, the first channel mask included in the first micro instruction has only the first bit (LSB) set to “1,” and all of the second to sixteenth bits set to “0.” In other words, the channel mask of the first micro instruction is composed of the binary stream “0000 0000 0000 0001.” The second channel mask included in the second micro instruction has only the second bit set to “1,” while the first bit (LSB) and the third to sixteenth bits are all set to “0.” Thus, the channel mask of the second micro instruction is composed of the binary stream “0000 0000 0000 0010.” Similarly, the sixteenth channel mask included in the sixteenth micro instruction has only the sixteenth bit (MSB) set to “1,” and the first to fifteenth bits are all set to “0.” Thus, the channel mask of the sixteenth micro instruction is composed of the binary stream “1000 0000 0000 0000.”

The local memory 230, upon receiving the first to sixteenth local memory instructions from the instruction decoder and sequencer 220, outputs the first to sixteenth local memory data DA0 to DA15 sequentially in response to the respective local memory instructions and transmits the output data to the multicast interconnect 250. Specifically, the first local memory data DA0 output from the local memory 230 corresponds to the data stored in a first region of the local memory 230 designated by the local memory address “0” included in the first local memory instruction. Next, the second local memory data DA1 output from the local memory 230 corresponds to the data stored in a second region designated by the local memory address “1” included in the second local memory instruction. Similarly, the sixteenth local memory data DA15 output last from the local memory 230 corresponds to the data stored in a sixteenth region designated by the local memory address “15” included in the sixteenth local memory instruction.

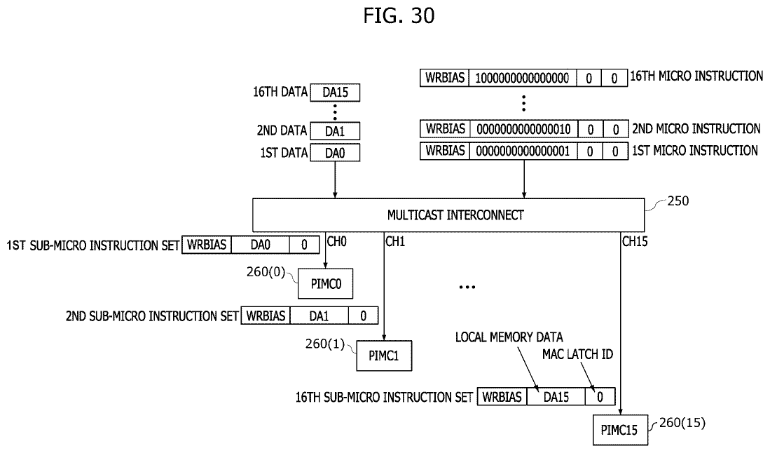

Referring to FIG. 30, the multicast interconnect 250 receives the first to sixteenth data DA0 to DA15 from the local memory 230 and also receives the first to sixteenth micro instructions from the instruction decoder and sequencer 220. The multicast interconnect 250 generates and outputs one or more sub-micro instruction sets based on the first to sixteenth micro instructions and the first to sixteenth data DA0 to DA15. The number of sub-micro instruction sets output from the multicast interconnect 250 is the same as the number of micro instructions input to the multicast interconnect 250. In this example, because the first to sixteenth micro instructions are input to the multicast interconnect 250, the multicast interconnect 250 outputs the first to sixteenth sub-micro instruction sets, each corresponding to the respective first to sixteenth micro instructions.

Each of the first to sixteenth sub-micro instruction sets includes an operation type, local memory data, and a MAC latch ID. The operation type included in each of the first to sixteenth sub-micro instruction sets is set to “WRBIAS,” which is identical to the operation type included in the corresponding micro instruction. The local memory data included in each of the first to sixteenth sub-micro instruction sets corresponds respectively to the first to sixteenth data DA0 to DA15 transmitted from the local memory 230 to the multicast interconnect 250. Further, the MAC latch ID included in each of the first to sixteenth sub-micro instruction sets is identical to the MAC latch ID included in the corresponding micro instruction.

As illustrated in FIG. 30, the first sub-micro instruction set includes an operation type, data, and a MAC latch ID respectively set to “WRBIAS,” “DA0,” and “0.” The second sub-micro instruction set includes an operation type, data, and a MAC latch ID respectively set to “WRBIAS,” “DA1,” and “0.” Similarly, the sixteenth sub-micro instruction set includes an operation type, data, and a MAC latch ID respectively set to “WRBIAS,” “DA15,” and “0.” Because the broadcast bits included in the first to sixteenth micro instructions have a value of “0,” the multicast interconnect 250 transmits the first to sixteenth sub-micro instruction sets respectively to the first to sixteenth PIM controllers 260(0) to 260(15). Specifically, the multicast interconnect 250 transmits the first sub-micro instruction set to the first PIM controller 260(0) via the first channel CH0. The multicast interconnect 250 transmits the second sub-micro instruction set to the second PIM controller 260(1) via the second channel CH1. Similarly, the multicast interconnect 250 transmits the sixteenth sub-micro instruction set to the sixteenth PIM controller 260(15) via the sixteenth channel CH15. The transmission of the first to sixteenth sub-micro instruction sets to the respective first to sixteenth PIM controllers 260(0) to 260(15) is performed in parallel.

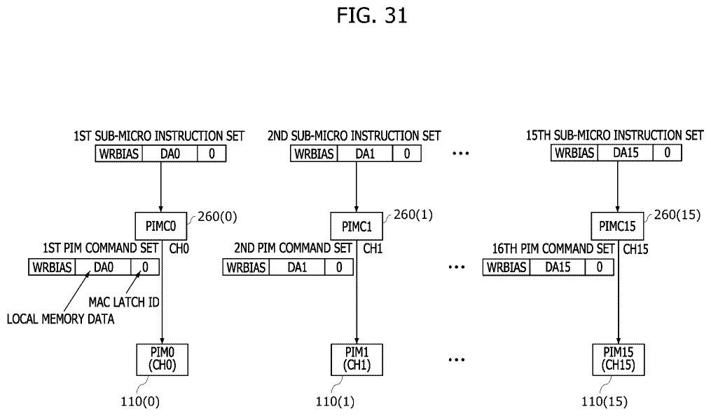

Referring to FIG. 31, the first to sixteenth PIM controllers 260(0) to 260(15) respectively generate first to sixteenth PIM command sets based on the first to sixteenth sub-micro instruction sets. Each of the first to sixteenth PIM controllers 260(0) to 260(15) transmits the corresponding PIM command set to a corresponding one of the first to sixteenth PIM devices 110(0) to 110(15) via the first to sixteenth channels, respectively. Specifically, the first PIM controller 260(0) transmits the first PIM command set to the first PIM device 110(0) via the first channel CH0. The second PIM controller 260(1) transmits the second PIM command set to the second PIM device 110(1) via the second channel CH1. Similarly, the sixteenth PIM controller 260(15) transmits the sixteenth PIM command set to the sixteenth PIM device 110(15) via the sixteenth channel CH15.

The transmission of the first to sixteenth PIM command sets to the corresponding PIM devices 110(0) to 110(15) is performed in parallel. In one embodiment, each of the first to sixteenth PIM command sets includes an operation type, local memory data, and a MAC latch ID. The operation type, local memory data, and MAC latch ID included in each of the first to sixteenth PIM command sets are identical to the operation type, local memory data, and MAC latch ID included in the corresponding first to sixteenth sub-micro instruction sets.

Although not explicitly illustrated in the drawings, each of the first to sixteenth PIM devices 110(0) to 110(15), after receiving the corresponding first to sixteenth PIM command sets, respectively stores the first to sixteenth local memory data DA0 to DA15, included in the respective PIM command sets, into latch circuits designated by the MAC latch IDs included in the corresponding PIM command sets. Accordingly, the first PIM device 110(0) latches the first local memory data DA0 as bias data into the latch circuit designated by the MAC latch ID “0.” The second PIM device 110(1) latches the second local memory data DA1 as bias data into the latch circuit designated by the MAC latch ID “0.” Similarly, the sixteenth PIM device 110(15) latches the sixteenth local memory data DA15 into the latch circuit designated by the MAC latch ID “0.”

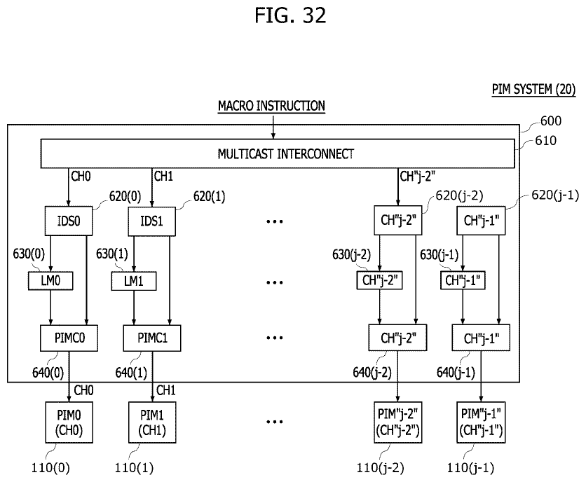

FIG. 32 is a block diagram illustrating another embodiment of the PIM system according to the present disclosure.

Referring to FIG. 32, a PIM system 20 includes a plurality of PIM devices, for example, first to j-th PIM devices 110(0) to 110(j−1), and a PIM-centric system 600. Here, j is a natural number equal to or greater than 2. In one embodiment, the first to j-th PIM devices 110(0) to 110(j−1) are respectively coupled to the PIM-centric system 600 through corresponding first to j-th channels CH0 to CH“j−1.” As illustrated in FIG. 32, the first PIM device 110(0) is coupled to the PIM-centric system 600 through the first channel CH0. The second PIM device 110(1) is coupled to the PIM-centric system 600 through the second channel CH1. The (j−1)-th PIM device 110(j−2) is coupled to the PIM-centric system 600 through the (j−1)-th channel CH“j−2,” and the j-th PIM device 110(j−1) is coupled to the PIM-centric system 600 through the j-th channel CH“j−1.”

Although not explicitly illustrated in FIG. 32, in another embodiment, two or more PIM devices may share a single channel to couple to the PIM-centric system 600. In such a case, the PIM system 20 may include a number of PIM devices that is a multiple of j. It should be noted that the descriptions regarding the first to j-th PIM devices 110(0) to 110(j−1) provided with reference to FIG. 1, as well as the descriptions regarding the PIM device and the processing circuit provided with reference to FIGS. 2 and 3, are equally applicable to the first to j-th PIM devices 110(0) to 110(j−1) illustrated in FIG. 32.

The PIM-centric system 600 controls the operations of the first to j-th PIM devices 110(0) to 110(j−1). The PIM-centric system 600 may be coupled to a host. Additionally, the PIM-centric system 600 may be coupled to another PIM-centric system included in a different PIM system. The PIM-centric system 600 may receive a macro instruction from the host. The PIM-centric system 600 may convert the received macro instruction into a plurality of sub-macro instructions. Further, the PIM-centric system 600 may convert the plurality of sub-macro instructions into a plurality of sets of micro instructions. The PIM-centric system 600 may generate a plurality of PIM command sets corresponding to the plurality of sets of micro instructions and transmit the generated PIM command sets to the first to j-th PIM devices 110(0) to 110(j−1).

In one embodiment, the PIM-centric system 600 may include a multicast interconnect 610, first to j-th instruction decoders and sequencers (IDSO to IDS“j−1”) 620(0) to 620(j−1), first to j-th local memories (LM0 to LM“j−1”) 630(0) to 630(j−1), and first to j-th PIM controllers (PIMC0 to PIMC“j−1”) 640(0) to 640(j−1).

The multicast interconnect 610 is coupled to the first to j-th instruction decoders and sequencers 620(0) to 620(j−1) via corresponding first to j-th channels CH0 to CH“j−1.” That is, the multicast interconnect 610 is coupled to the i-th instruction decoder and sequencer 620(i−1) through the i-th channel CH“i−1.” Each of the first to j-th instruction decoders and sequencers 620(0) to 620(j−1) is coupled to a corresponding local memory among the first to j-th local memories 630(0) to 630(j−1). Furthermore, each of the first to j-th instruction decoders and sequencers 620(0) to 620(j−1) are also coupled to a corresponding PIM controller among the first to j-th PIM controllers 640(0) to 640(j−1). Specifically, the i-th instruction decoder and sequencer 620(i−1) are coupled to the i-th local memory 630(i−1) and the i-th PIM controller 640(i−1).

Each of the first to j-th local memories 630(0) to 630(j−1) is coupled to a corresponding one of the first to j-th PIM controllers 640(0) to 640(j−1). Specifically, among the first to j-th local memories 630(0) to 630(j−1), the i-th local memory 630(i−1) is coupled to the i-th PIM controller 640(i−1). Each of the first to j-th PIM controllers 640(0) to 640(j−1) is coupled to a corresponding one of the first to j-th PIM devices 110(0) to 110(j−1) through corresponding first to j-th channels CH0 to CH“j−1.” That is, among the first to j-th PIM controllers 640(0) to 640(j−1), the i-th PIM controller 640(i−1) is coupled to the i-th PIM device 110(i−1) through the i-th channel CH“i−1.” Although not illustrated in the drawings, the PIM-centric system 600 may further include a host interface, a network router, and a computation unit, similar to the PIM-centric system 200 described with reference to FIG. 1.

The multicast interconnect 610 may receive a macro instruction transmitted from a host. The multicast interconnect 610 may generate and output one or more sub-macro instructions based on the received macro instruction. The number of sub-macro instructions generated by the multicast interconnect 610 may be determined according to bit values included in the channel mask of the macro instruction. In one embodiment, the number of bits included in the channel mask of the macro instruction may be equal to the number of channels “j” included in the PIM system 20. Each of the “j” bits of the channel mask, specifically the first to j-th bits, corresponds to the first to j-th channels CH0 to CH“j−1,” respectively. That is, the i-th bit of the channel mask, when counted from the LSB to the MSB, corresponds to the i-th channel CH“i−1.”

The multicast interconnect 610 may generate and output a number of sub-macro instructions corresponding to the number of bits having a value of “1” in the channel mask of the macro instruction. Specifically, when the i-th bit in the “j” bits of the channel mask has a binary value of “1,” the multicast interconnect 610 generates and outputs an i-th sub-macro instruction. Conversely, when the i-th bit has a binary value of “0,” the multicast interconnect 610 does not generate a corresponding sub-macro instruction. For example, when the channel mask of the macro instruction is set to “0000 0000 1111 1111,” the multicast interconnect 610 generates and outputs the first through eighth sub-macro instructions. In another example, when the channel mask is set to “1111 1111 0000 0000,” the multicast interconnect 610 generates and outputs the ninth through sixteenth sub-macro instructions. In yet another example, when the channel mask is set to “1010 1010 1010 1010,” the multicast interconnect 610 generates and outputs the second, fourth, sixth, eighth, tenth, twelfth, fourteenth, and sixteenth sub-macro instructions.

When the i-th sub-macro instruction is generated by the multicast interconnect 610, the multicast interconnect 610 transmits the i-th sub-macro instruction to the i-th instruction decoder and sequencer 620(i−1) through the i-th channel CH (i−1). For example, when the channel mask of the macro instruction is set to “0000 0000 1111 1111,” the multicast interconnect 610 generates the first through eighth sub-macro instructions and transmits the first through eighth sub-macro instructions to the first through eighth instruction decoders and sequencers, respectively. In another example, when the channel mask of the macro instruction is set to “1111 1111 0000 0000,” the multicast interconnect 610 generates the ninth through sixteenth sub-macro instructions and transmits the ninth through sixteenth sub-macro instructions to the ninth through sixteenth instruction decoders and sequencers, respectively. In yet another example, when the channel mask of the macro instruction is set to “1010 1010 1010 1010,” the multicast interconnect 610 generates the second, fourth, sixth, eighth, tenth, twelfth, fourteenth, and sixteenth sub-macro instructions, and transmits them to the second, fourth, sixth, eighth, tenth, twelfth, fourteenth, and sixteenth instruction decoders and sequencers, respectively.

In a first example, it is assumed that the macro instruction transmitted to the multicast interconnect 610 includes an operation type designated as “MAC,” a number of iterations, a channel mask, a row address, and a starting column address. When the macro instruction including a channel mask in which the i-th bit is set to “1” is transmitted, the multicast interconnect 610 generates and outputs an i-th sub-macro instruction. The i-th sub-macro instruction output from the multicast interconnect 610 may include the operation type, number of iterations, row address, and starting column address. In the first example, the operation type, number of iterations, row address, and starting column address included in the i-th sub-macro instruction may be identical to those included in the macro instruction.

In a second example, it is assumed that the macro instruction transmitted to the multicast interconnect 610 includes an operation type designated as “WRGB,” a number of iterations, a channel mask, a local memory address, a starting column address, and a broadcast bit. When the macro instruction including a channel mask in which the i-th bit is set to “1” is transmitted, the multicast interconnect 610 generates and outputs an i-th sub-macro instruction. The i-th sub-macro instruction output from the multicast interconnect 610 may include the operation type, number of iterations, local memory starting address, starting column address, and broadcast bit. In the second example, the operation type, number of iterations, local memory starting address, starting column address, and broadcast bit included in the i-th sub-macro instruction may be identical to those included in the macro instruction. Additionally, in the second example, the macro instruction transmitted to the multicast interconnect 610 may further include a local memory incremental size. In this case, the i-th sub-macro instruction output from the multicast interconnect 610 may also include the local memory incremental size, which may be identical to that included in the macro instruction.

In a third example, it is assumed that the macro instruction transmitted to the multicast interconnect 610 includes an operation type designated as “WRGB,” a number of iterations, a channel mask, a local memory address, a starting column address, a broadcast bit, and a local memory incremental size. When the macro instruction including a channel mask in which the i-th bit is set to “1” is transmitted, the multicast interconnect 610 generates and outputs an i-th sub-macro instruction. The i-th sub-macro instruction output from the multicast interconnect 610 may include the operation type, number of iterations, local memory starting address, starting column address, broadcast bit, and local memory incremental size. In the third example, the operation type, number of iterations, local memory starting address, starting column address, broadcast bit, and local memory incremental size included in the i-th sub-macro instruction may be identical to those included in the macro instruction.

In a fourth example, it is assumed that the macro instruction transmitted to the multicast interconnect 610 includes an operation type designated as “WRBIAS,” a channel mask, a local memory address, and a MAC latch ID. The macro instruction may further include a broadcast bit. When the macro instruction including a channel mask in which the i-th bit is set to “1” is transmitted, the multicast interconnect 610 generates and outputs an i-th sub-macro instruction. The i-th sub-macro instruction output from the multicast interconnect 610 may include the operation type, local memory address, and MAC latch ID. In the fourth example, the operation type and MAC latch ID included in the i-th sub-macro instruction may be identical to the operation type and MAC latch ID included in the macro instruction. The local memory address included in the i-th sub-macro instruction may be determined by incrementing the starting local memory address included in the macro instruction by a size specified by the local memory incremental size.

The first to j-th instruction decoder and sequencers 620(0)-620(j−1) may receive the sub-macro instructions output from the multicast interconnect 610. In one embodiment, when a sub-macro instruction is transmitted from the multicast interconnect 610, each of the first to j-th instruction decoder and sequencers 620(0)-620(j−1) may decode the sub-macro instruction and generate a micro instruction set to output. For example, when the i-th sub-macro instruction is transmitted from the multicast interconnect 610, the i-th instruction decoder and sequencer 620(i−1) may generate and output the i-th micro instruction set. The i-th instruction decoder and sequencer 620(i−1) may transmit the i-th micro instruction set to the i-th PIM controller 640(i−1).

In another embodiment, when a sub-macro instruction is transmitted from the multicast interconnect 610, each of the first to j-th instruction decoder and sequencers 620(0)-620(j−1) may decode the sub-macro instruction and generate a local memory instruction set and a micro instruction set. Specifically, when the i-th sub-macro instruction is transmitted from the multicast interconnect 610, the i-th instruction decoder and sequencer 620(i−1) may generate the i-th local memory instruction set and the i-th micro instruction set. The i-th instruction decoder and sequencer 620(i−1) may respectively transmit the i-th local memory instruction set and the i-th micro instruction set to the i-th local memory 630(i−1) and the i-th PIM controller 640(i−1).

In another embodiment, when a sub-macro instruction is transmitted from the multicast interconnect 610, each of the first to j-th instruction decoder and sequencers 620(0)-620(j−1) may decode the sub-macro instruction and generate a plurality of local memory instructions and a plurality of micro instructions. Specifically, when the i-th sub-macro instruction is transmitted from the multicast interconnect 610, the i-th instruction decoder and sequencer 620(i−1) may generate the “(n−1)×j+i”-th local memory instructions and the “(n−1)×j+i”-th micro instructions. Here, n is a natural number from 1 to m/j. The i-th instruction decoder and sequencer 620(i−1) may respectively transmit the “(n−1)×j+i”-th local memory instructions and the “(n−1)×j+i”-th micro instructions to the i-th local memory 630(i−1) and the i-th PIM controller 640(i−1).

In still another embodiment, when a sub-macro instruction is transmitted from the multicast interconnect 610, each of the first to j-th instruction decoder and sequencers 620(0)-620(j−1) may decode the sub-macro instruction and generate a local memory instruction and a micro instruction. Specifically, when the i-th sub-macro instruction is transmitted from the multicast interconnect 610, the i-th instruction decoder and sequencer 620(i−1) may generate the i-th local memory instruction and the i-th micro instruction. The i-th instruction decoder and sequencer 620(i−1) may respectively transmit the i-th local memory instruction and the i-th micro instruction to the i-th local memory 630(i−1) and the i-th PIM controller 640(i−1).

In the first example, where the macro instruction transmitted to the multicast interconnect 610 includes an operation type designated as “MAC,” a number of iterations, a channel mask, a row address, and a start column address, the i-th instruction decoder and sequencer 620(i−1) that receives the i-th sub-macro instruction may generate and output the i-th micro instruction set. In this case, the i-th micro instruction set may include a first to m-th micro instructions, where m represents the number of iterations. Each of the first to m-th micro instructions may include an operation type, a row address, and a column address. The operation types and row addresses included in the first to m-th micro instructions may be identical to the operation type and the row address included in the i-th sub-macro instruction. The column addresses included in the first to m-th micro instructions may sequentially increase starting from the start column address included in the i-th sub-macro instruction.

In the second example, where the macro instruction transmitted to the multicast interconnect 610 includes an operation type designated as “WRGB,” a number of iterations, a channel mask, a local memory address, a column address, and a broadcast bit, when the broadcast bit is set to “1,” the i-th instruction decoder and sequencer 620(i−1) that receives the i-th sub-macro instruction may generate and output a first to m-th local memory instructions and the i-th micro instruction set. In this case, each of the first to m-th local memory instructions output from the i-th instruction decoder and sequencer 620(i−1) may include a local memory command and a local memory address. The local memory command may be designated as “RD_LM,” indicating a read operation for the i-th local memory. The local memory addresses may sequentially increase starting from the local memory address included in the i-th sub-macro instruction. The i-th micro instruction set output from the i-th instruction decoder and sequencer 620(i−1) may include a first to m-th micro instructions. Each of the first to m-th micro instructions may include an operation type and a column address. The operation types included in the first to m-th micro instructions may be identical to the operation type included in the i-th sub-macro instruction. The column addresses included in the first to m-th micro instructions may sequentially increase starting from the start column address included in the i-th sub-macro instruction.

In the second example, when the broadcast bit value is set to “0,” the i-th instruction decoder and sequencer 620(i−1) that receives the i-th sub-macro instruction may generate and output “(n−1)×j+i”-th local memory instructions and “(n−1)×j+i”-th micro instructions. In this case, each of the “(n−1)×j+i”-th local memory instructions output from the i-th instruction decoder and sequencer 620(i−1) may include a local memory command and a local memory address. The local memory command may be designated as “RD_LM,” indicating a read operation for the i-th local memory. The local memory address may be specified as (n−1)×j+i+c₁, where c₁ represents the local memory address included in the i-th sub-macro instruction. Each of the “(n−1)×j+i”-th micro instructions output from the i-th instruction decoder and sequencer 620(i−1) may include an operation type and a column address. The operation types included in the “(n−1)×j+i”-th micro instructions may be identical to the operation type included in the i-th sub-macro instruction. The column addresses included in the “(n−1)×j+i”-th micro instructions may be specified as (n−1)×j+i+c₂, where c₂ represents the start column address included in the i-th sub-macro instruction.

In the third example, when the broadcast bit value is set to “1” in a macro instruction transmitted to the multicast interconnect 610, the i-th instruction decoder and sequencer 620(i−1) that receives the i-th sub-macro instruction may generate and output a first to m-th set of local memory instructions and an i-th micro instruction set. Each of the first to m-th local memory instructions output from the i-th instruction decoder and sequencer 620(i−1) may include a local memory command and a local memory address. The local memory command may be designated as “RD_LM,” indicating a read operation for the i-th local memory. The local memory address may sequentially increase from the starting local memory address included in the i-th sub-macro instruction, with an incremental step size defined by the local memory incremental size. The i-th micro instruction set output from the i-th instruction decoder and sequencer 620(i−1) may include the first to m-th micro instructions. Each of the first to m-th micro instructions may include an operation type and a column address. The operation types included in the first to m-th micro instructions may be identical to the operation type included in the i-th sub-macro instruction. The column addresses included in the first to m-th micro instructions may sequentially increase starting from the column address included in the i-th sub-macro instruction.

In the third example, when the broadcast bit value is set to “0,” the i-th instruction decoder and sequencer 620(i−1) that receives the i-th sub-macro instruction may generate and output “(n−1)×j+i”-th local memory instructions and “(n−1)×j+i”-th micro instructions. Each of the “(n−1)×j+i”-th local memory instructions output from the i-th instruction decoder and sequencer 620(i−1) may include a local memory command and a local memory address. The local memory command may be designated as “RD_LM,” indicating a read operation for the i-th local memory. The local memory address may be specified as [(n−1)×j+i+c₁]×s, where c₁ denotes the local memory address included in the i-th sub-macro instruction, and s denotes the local memory incremental size. Each of the “(n−1)×j+i”-th micro instructions output from the i-th instruction decoder and sequencer 620(i−1) may include an operation type and a column address. The operation types included in the “(n−1)×j+i”-th micro instructions may be identical to the operation type included in the i-th sub-macro instruction. The column addresses included in the “(n−1)×j+i”-th micro instructions may be specified as (n−1)×j+i+c₂, where c₂ denotes the column address included in the i-th sub-macro instruction.

In the fourth example, where the macro instruction transmitted to the multicast interconnect 610 includes an operation type designated as “WRBIAS,” a channel mask, a local memory address, and a MAC latch ID, the i-th instruction decoder and sequencer 620(i−1) that receives the i-th sub-macro instruction may generate and output a i-th local memory instruction and the i-th micro instruction. In this case, i-th local memory instructions output from the i-th instruction decoder and sequencer 620(i−1) may include a local memory command and a local memory address. The local memory command may be designated as “RD_LM,” indicating a read operation for the i-th local memory. The local memory addresses may sequentially increase starting from the local memory address included in the i-th sub-macro instruction. The i-th micro instruction output from the i-th instruction decoder and sequencer 620(i−1) may include an operation type and a MAC latch ID. The operation types and the MAC latch ID included in the i-th micro instruction may be identical to the operation type and the MAC latch ID included in the i-th sub-macro instruction.

Among the first to j-th local memories 630(0)-630(j−1), the i-th local memory 630(i−1) may receive the first to m-th local memory instructions from the i-th instruction decoder and sequencer 620(i−1) among the first to j-th instruction decoder and sequencers 620(0)-620(j−1). Upon receiving the first to m-th local memory instructions from the i-th instruction decoder and sequencer 620(i−1), the i-th local memory 630(i−1) sequentially performs first to m-th read operations based on the first to m-th local memory instructions. Specifically, the i-th local memory 630(i−1) transmits data stored at storage locations designated by the local memory addresses included in the first to m-th local memory instructions to the i-th PIM controller 640(i−1).

Among the first to j-th local memories 630(0)-630(j−1), the i-th local memory 630(i−1) may also receive the “(n−1)×j+i”-th local memory instructions from the i-th instruction decoder and sequencer 620(i−1) among the first to j-th instruction decoder and sequencers 620(0)-620(j−1). Upon receiving the “(n−1)×j+i”-th local memory instructions from the i-th instruction decoder and sequencer 620(i−1), the i-th local memory 630(i−1) sequentially performs “(n−1)×j+i”-th read operations based on the “(n−1)×j+i”-th local memory instructions. Accordingly, the i-th local memory 630(i−1) transmits data stored at storage locations designated by the local memory addresses included in the “(n−1)×j+i”-th local memory instructions to the i-th PIM controller 640(i−1).

Among the first to j-th local memories 630(0)-630(j−1), the i-th local memory 630(i−1) may also receive an i-th local memory instruction from the i-th instruction decoder and sequencer 620(i−1) among the first to j-th instruction decoder and sequencers 620(0)-620(j−1). Upon receiving the i-th local memory instruction from the i-th instruction decoder and sequencer 620(i−1), the i-th local memory 630(i−1) sequentially performs an i-th read operation based on the i-th local memory instruction. Specifically, the i-th local memory 630(i−1) transmits data stored at a storage location designated by the local memory address included in the i-th local memory instruction to the i-th PIM controller 640(i−1).

Among the first to j-th PIM controllers 640(0)-640(j−1), the i-th PIM controller 640(i−1) may receive an i-th micro instruction set from the i-th instruction decoder and sequencer 620(i−1) among the first to j-th instruction decoder and sequencers 620(0)-620(j−1). In this case, the i-th PIM controller 640(i−1) generates and outputs an i-th PIM command set based on the first to m-th micro instructions included in the i-th micro instruction set. The i-th PIM command set may include an active PIM command and first to m-th PIM commands respectively corresponding to the first to m-th micro instructions. The active PIM command may include an “ACT” command, which activates a row, and a row address. Each of the first to m-th PIM commands may include an operation type, a row address, and a column address. The operation types, row addresses, and column addresses included in the first to m-th PIM commands may be identical to the operation types, row addresses, and column addresses included in the first to m-th micro instructions of the i-th micro instruction set. The i-th PIM controller 640(i−1) transmits the i-th PIM command set to the i-th PIM device through the i-th channel CH (i−1).

Among the first to j-th PIM controllers 640(0)-640(j−1), the i-th PIM controller 640(i−1) may receive first to m-th data from the i-th local memory 630(i−1) among the first to j-th local memories 630(0)-630(j−1), and may also receive an i-th micro instruction set from the i-th instruction decoder and sequencer 620(i−1) among the first to j-th instruction decoder and sequencers 620(0)-620(j−1). In this case, the i-th PIM controller 640(i−1) generates and outputs an i-th PIM command set based on the first to m-th data and the first to m-th micro instructions included in the i-th micro instruction set. The i-th PIM command set may include first to m-th PIM commands, each corresponding to each of the first to m-th data and each of the first to m-th micro instructions. Each of the first to m-th PIM commands may include an operation type, local memory data, and a column address. The local memory data included in each of the first to m-th PIM commands may be identical to the corresponding first to m-th data. The operation types and column addresses included in the first to m-th PIM commands may be identical to the operation types and column addresses included in the first to m-th micro instructions of the i-th micro instruction set. The i-th PIM controller 640(i−1) transmits the i-th PIM command set to the i-th PIM device through the i-th channel CH (i−1).

Among the first to j-th PIM controllers 640(0)-640(j−1), the i-th PIM controller 640(i−1) may receive “(n−1)×j+i”-th data from the i-th local memory 630(i−1) among the first to j-th local memories 630(0)-630(j−1), and may also receive “(n−1)×j+i”-th micro instructions from the i-th instruction decoder and sequencer 620(i−1) among the first to j-th instruction decoder and sequencers 620(0)-620(j−1). In this case, the i-th PIM controller 640(i−1) generates and outputs “(n−1)×j+i”-th PIM commands based on the “(n−1)×j+i”-th data and the “(n−1)×j+i”-th micro instructions. Each of the “(n−1)×j+i”-th PIM commands may include an operation type, local memory data, and a column address. The local memory data included in each of the “(n−1)×j+i”-th PIM commands may be identical to the corresponding “(n−1)×j+i”-th data. The operation types and column addresses included in each of the “(n−1)×j+i”-th PIM commands may be identical to the operation types and column addresses included in the corresponding “(n−1)×j+i”-th micro instructions. The i-th PIM controller 640(i−1) transmits the “(n−1)×j+i”-th PIM commands to the i-th PIM device through the i-th channel CH (i−1).

Among the first to j-th PIM controllers 640(0)-640(j−1), the i-th PIM controller 640(i−1) may receive i-th data from the i-th local memory 630(i−1) among the first to j-th local memories 630(0)-630(j−1), and may also receive i-th micro instructions from the i-th instruction decoder and sequencer 620(i−1) among the first to j-th instruction decoder and sequencers 620(0)-620(j−1). In this case, the i-th PIM controller 640(i−1) generates and outputs an i-th PIM command based on the i-th data and the i-th micro instructions. The i-th PIM command may include an operation type, local memory data, and a MAC latch ID. The local memory data included in the i-th PIM command may be identical to the corresponding i-th data. The operation type and the MAC latch ID included in the i-th PIM command may be identical to the operation type and the MAC latch ID included in the i-th micro instructions. The i-th PIM controller 640(i−1) transmits the i-th PIM command to the i-th PIM device through the i-th channel CH (i−1).

Among the first to j-th PIM devices 110(0)-110(j−1), the i-th PIM device 110(i−1) may receive the i-th PIM command set from the i-th PIM controller 640(i−1). When the i-th PIM command set includes first to m-th PIM commands, and the operation types of the first to m-th PIM commands are designated as “MAC,” the i-th PIM device 110(i−1) activates rows of memory banks specified by the row address included in the i-th active PIM command. Subsequently, processing elements included in the i-th PIM device 110(i−1) receive weight data stored in the columns specified by the column addresses among the activated rows of the memory banks, and vector data stored in storage locations of the global buffer specified by the same column addresses. The processing elements then perform MAC operations using the received weight data and vector data from the memory banks and the global buffer.

When the i-th PIM command set transmitted from the i-th PIM controller 640(i−1) includes first to m-th PIM commands, and the operation types of the first to m-th PIM commands are designated as “WRGB,” the i-th PIM device 110(i−1) stores the first to m-th local memory data as vector data into the first to m-th storage locations of the global buffer specified by the column addresses included in the first to m-th PIM commands.

Among the first to j-th PIM devices 110(0)-110(j−1), the i-th PIM device 110(i−1) may also receive the i-th PIM command from the i-th PIM controller 640(i−1). When the operation type of the i-th PIM command is designated as “WRBIAS,” the i-th PIM device 110(i−1) latches the local memory data included in the i-th PIM command as bias data into a latch circuit among the MAC latch circuits, the latch circuit being specified by the MAC latch ID included in the i-th PIM command.

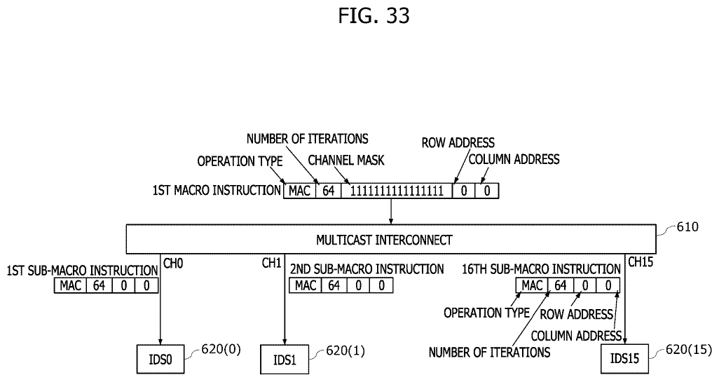

FIGS. 33 to 35 are diagrams illustrating a process of executing the first macro instruction of FIG. 7 in the PIM system of FIG. 32. In this example, it is assumed that the PIM system (20) includes the first through sixteenth channels (CH0-CH15). Additionally, it is assumed, for example, that the operation type, the number of operation repetitions, the channel mask, the row address, and the column address of the first macro instruction are set to “MAC,” “64,” “1111 1111 1111 1111,” “0,” and “0,” respectively.

Referring to FIG. 33, the multicast interconnect 610, upon receiving the first macro instruction, generates and outputs one or more sub-macro instructions based on the first macro instruction. Because the first through sixteenth bits of the channel mask included in the first macro instruction all have a binary value of “1,” the multicast interconnect 610 generates the first through sixteenth sub-macro instructions. The multicast interconnect 610 respectively transmits the first through sixteenth sub-macro instructions to the first through sixteenth instruction decoders and sequencers 620(0) to 620(15) through the first channel CH0 to the sixteenth channel CH15. Each of the first through sixteenth sub-macro instructions may include an operation type, a number of iterations, a row address, and a starting column address. The operation type, the number of iterations, the row address, and the starting column address included in the first through sixteenth sub-macro instructions are respectively identical to the operation type, the number of iterations, the row address, and the starting column address included in the first macro instruction. Accordingly, each of the first through sixteenth sub-macro instructions includes an operation type set to “MAC,” a number of iterations set to “64,” a row address set to “0,” and a column address set to “0.”

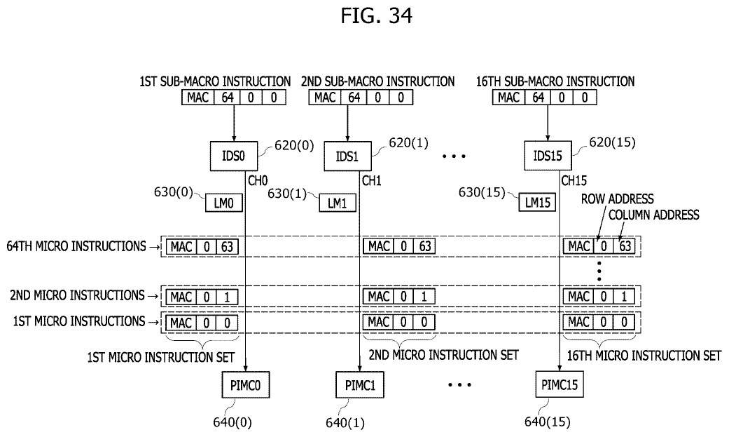

Referring to FIG. 34, each of the first through sixteenth instruction decoders and sequencers 620(0) to 620(15) generates a first through sixteenth micro instruction set, respectively, based on the first through sixteenth sub-macro instructions. Each of the first through sixteenth instruction decoders and sequencers 620(0) to 620(15) respectively transmits the first through sixteenth micro instruction sets to the first through sixteenth PIM controllers 640(0) to 640(15). As illustrated in FIG. 34, the first instruction decoder and sequencer 620(0) generates the first micro instruction set based on the first sub-macro instruction. The first instruction decoder and sequencer 620(0) transmits the first micro instruction set to the first PIM controller 640(0) through the first channel CH0. Similarly, the second instruction decoder and sequencer 620(1) generates the second micro instruction set based on the second sub-macro instruction, and transmits the second micro instruction set to the second PIM controller 640(1) through the second channel CH1. The sixteenth instruction decoder and sequencer 620(15) generates the sixteenth micro instruction set based on the sixteenth sub-macro instruction and transmits the sixteenth micro instruction set to the sixteenth PIM controller 640(15) through the sixteenth channel CH15.

The first through sixteenth micro instruction sets output from the first through sixteenth instruction decoders and sequencers 620(0) to 620(15) each include first through sixty-fourth micro instructions, respectively. As illustrated in FIG. 34, the first micro instruction set includes the first through sixty-fourth micro instructions. Similarly, the second micro instruction set and the sixteenth micro instruction set also include the first through sixty-fourth micro instructions. Each of the first through sixty-fourth micro instructions includes an operation type, a row address, and a column address. The operation type and the row address included in the first through sixty-fourth micro instructions are respectively identical to the operation type and the row address included in the corresponding first through sixteenth sub-macro instructions. The column address included in each of the first through sixty-fourth micro instructions is sequentially increased, starting from the starting column address included in the corresponding first through sixteenth sub-macro instructions. As illustrated in FIG. 34, the first micro instructions included in the first through sixteenth micro instruction sets each include an operation type set to “MAC,” a row address set to “0,” and a column address set to “0.” The second micro instructions included in the first through sixteenth micro instruction sets each include an operation type set to “MAC,” a row address set to “0,” and a column address set to “1.” Similarly, the sixty-fourth micro instructions included in the first through sixteenth micro instruction sets each include an operation type set to “MAC,” a row address set to “0,” and a column address set to “63.”

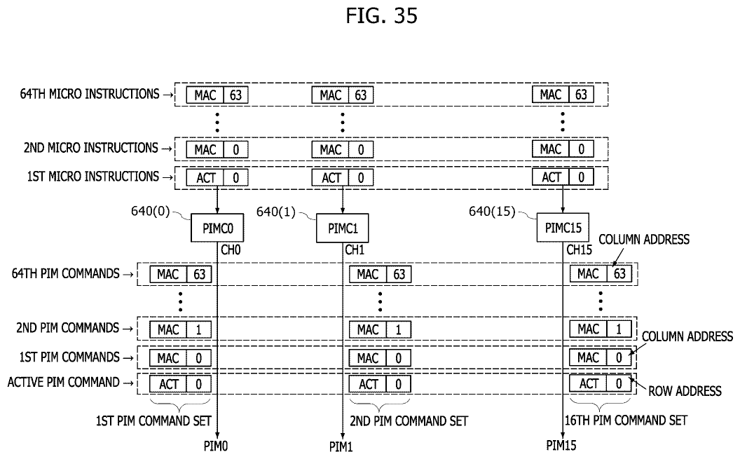

Referring to FIG. 35, each of the first through sixteenth PIM controllers 640(0) to 640(15) generates and outputs a first through sixteenth PIM command set, respectively, based on the first through sixteenth micro instruction sets. Each of the first through sixteenth PIM command sets includes an active PIM command and first through sixty-fourth PIM commands. For example, the first PIM controller 640(0) generates the first PIM command set, including the active PIM command and the first through sixty-fourth PIM commands, based on the first through sixty-fourth micro instructions included in the first micro instruction set. Similarly, the second PIM controller 640(1) generates the second PIM command set, including the active PIM command and the first through sixty-fourth PIM commands, based on the first through sixty-fourth micro instructions included in the second micro instruction set. Likewise, the sixteenth PIM controller 640(15) generates the sixteenth PIM command set based on the sixteenth micro instruction set.

Each of the active PIM commands included in the first through sixteenth PIM command sets includes an active command designated as “ACT” and a row address designated as “0.” Each of the first PIM commands included in the first through sixteenth PIM command sets includes an operation type set to “MAC” and a column address set to “0.” Each of the second PIM commands included in the first through sixteenth PIM command sets includes an operation type set to “MAC” and a column address set to “1.” Similarly, each of the sixty-fourth PIM commands included in the first through sixteenth PIM command sets includes an operation type set to “MAC” and a column address set to “63.”

Although not illustrated in the drawing, each of the first through sixteenth PIM devices 110(0)-110(15), upon receiving the first through sixteenth PIM command sets, respectively, activates a row of a memory bank designated by the row address “0” included in the active PIM command. Subsequently, the processing elements included in each of the first through sixteenth PIM devices 110(0)-110(15) receive weight data stored in the column designated by the column address among the activated rows of the memory banks, and vector data stored in a storage location designated by the column address among the storage locations of the global buffer. Furthermore, the processing elements included in each of the first through sixteenth PIM devices 110(0)-110(15) perform MAC operations using the received weight data from the memory banks and the vector data from the global buffer.

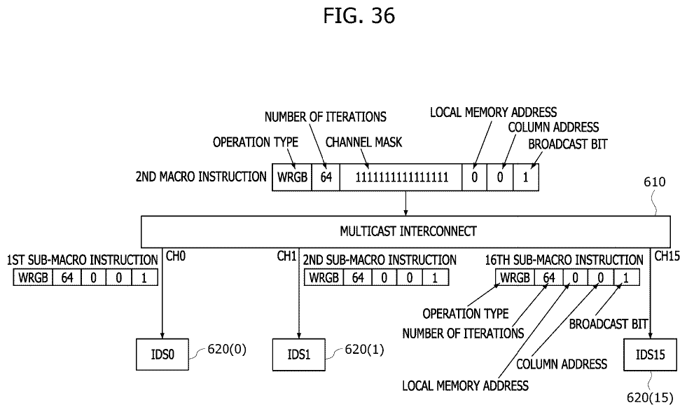

FIGS. 36 to 39 are diagrams illustrating an example process of executing the second macro instruction of FIG. 11 in the PIM system of FIG. 32. In this example, it is assumed that the PIM system 20 includes first through sixteenth channels CH0 to CH15. It is further assumed that the operation type, number of iterations, channel mask, local memory address, column address, and broadcast bit of the second macro instruction are respectively set to “WRGB,” “64,” “1111 1111 1111 1111,” “0,” “0,” and “1.”

Referring to FIG. 36, the multicast interconnect 610, upon receiving the second macro instruction, generates and outputs one or more sub-macro instructions based on the second macro instruction. Because the first through sixteenth bits of the channel mask included in the second macro instruction all have a binary value of “1,” the multicast interconnect 610 generates the first through sixteenth sub-macro instructions. The multicast interconnect 610 respectively transmits the first through sixteenth sub-macro instructions to the first through sixteenth instruction decoders and sequencers 620(0) to 620(15) through the first through sixteenth channels CH0 to CH15. As illustrated in FIG. 36, the multicast interconnect 610 transmits the first sub-macro instruction to the first instruction decoder and sequencer 620(0) through the first channel CH0. The multicast interconnect 610 transmits the second sub-macro instruction to the second instruction decoder and sequencer 620(1) through the second channel CH1. Similarly, the multicast interconnect 610 transmits the sixteenth sub-macro instruction to the sixteenth instruction decoder and sequencer 620(15) through the sixteenth channel CH15.

Each of the first through sixteenth sub-macro instructions may include an operation type, a number of iterations, a local memory address, a starting column address, and a broadcast bit. The operation type, number of iterations, local memory address, column address, and broadcast bit included in each of the first through sixteenth sub-macro instructions are identical to the operation type, number of iterations, local memory address, starting column address, and broadcast bit included in the second macro instruction. Accordingly, each of the first through sixteenth sub-macro instructions includes an operation type set to “WRGB,” a number of iterations set to “64,” a local memory address set to “0,” a column address set to “0,” and a broadcast bit set to “1.”

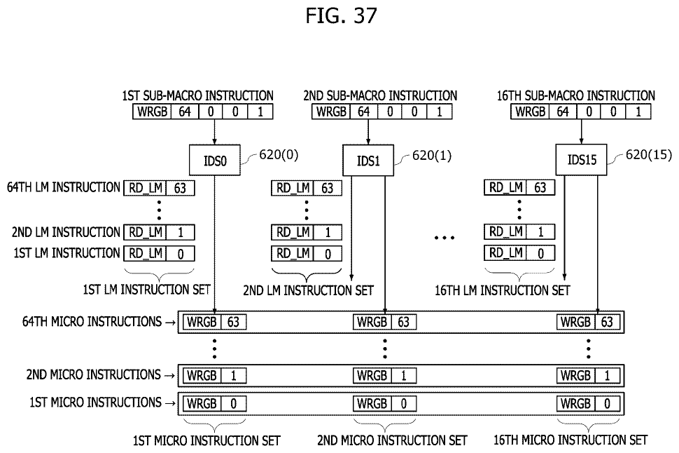

Referring to FIG. 37, each of the first through sixteenth instruction decoders and sequencers 620(0) to 620(15) generates and outputs a first through sixteenth local memory instruction set, respectively, based on the first through sixteenth sub-macro instructions. Additionally, each of the first through sixteenth instruction decoders and sequencers 620(0) to 620(15) generates and outputs a first through sixteenth micro instruction set, respectively, based on the first through sixteenth sub-macro instructions. Each of the first through sixteenth instruction decoders and sequencers 620(0) to 620(15) respectively transmits the first through sixteenth local memory instruction sets to the first through sixteenth local memories 630(0) to 630(15), and respectively transmits the first through sixteenth micro instruction sets to the first through sixteenth PIM controllers 640(0) to 640(15).

As illustrated in FIG. 37, the first instruction decoder and sequencer 620(0) generates the first local memory instruction set and the first micro instruction set based on the first sub-macro instruction. The first instruction decoder and sequencer 620(0) transmits the first local memory instruction set to the first local memory 630(0), and also transmits the first micro instruction set to the first PIM controller 640(0) through the first channel CH0. Similarly, the second instruction decoder and sequencer 620(1) generates the second local memory instruction set and the second micro instruction set based on the second sub-macro instruction. The second instruction decoder and sequencer 620(1) transmits the second local memory instruction set to the second local memory 630(1), and transmits the second micro instruction set to the second PIM controller 640(1) through the second channel CH1. The sixteenth instruction decoder and sequencer 620(15) generates the sixteenth local memory instruction set and the sixteenth micro instruction set based on the sixteenth sub-macro instruction. Likewise, the sixteenth instruction decoder and sequencer 620(15) transmits the sixteenth local memory instruction set to the sixteenth local memory 630(15), and transmits the sixteenth micro instruction set to the sixteenth PIM controller 640(15) through the sixteenth channel CH15.

Each of the first through sixteenth local memory instruction sets generated by the first through sixteenth instruction decoders and sequencers 620(0) to 620(15) includes a first through sixty-fourth local memory instruction. Each of the first through sixty-fourth local memory instructions includes a local memory command and a local memory address. The local memory command is designated as “RD_LM,” which instructs a read operation from the local memory. The local memory address sequentially increases from the starting address, which is the local memory address included in the corresponding sub-macro instruction, across the first through sixty-fourth local memory instructions.

As illustrated in FIG. 37, the first local memory instructions included in the first through sixteenth local memory instruction sets each include a local memory command designated as “RD_LM” and a local memory address designated as “0.” The second local memory instructions included in the first through sixteenth local memory instruction sets each include a local memory command designated as “RD_LM” and a local memory address designated as “1.” Similarly, the sixty-fourth local memory instructions included in the first through sixteenth local memory instruction sets each include a local memory command designated as “RD_LM” and a local memory address designated as “63.”

Each of the first through sixteenth micro instruction sets output from the first through sixteenth instruction decoders and sequencers 620(0) to 620(15) includes a first through sixty-fourth micro instruction. Each of the first through sixty-fourth micro instructions includes an operation type and a column address. The operation type is designated as “WRGB,” which instructs a write operation to the global buffer. The column address sequentially increases from the starting column address, which is the column address included in the corresponding sub-macro instruction, across the first through sixty-fourth micro instructions.

As illustrated in FIG. 37, the first micro instructions included in the first through sixteenth micro instruction sets each include an operation type designated as “WRGB” and a column address designated as “0.” The second micro instructions included in the first through sixteenth micro instruction sets each include an operation type designated as “WRGB” and a column address designated as “1.” Similarly, the sixty-fourth micro instructions included in the first through sixteenth micro instruction sets each include an operation type designated as “WRGB” and a column address designated as “63.”

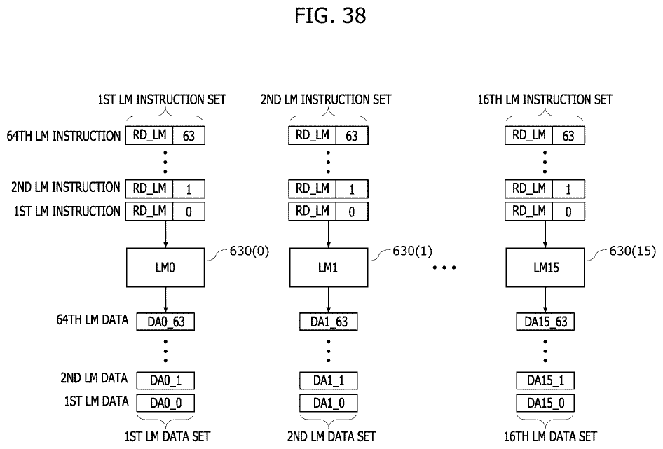

Referring to FIG. 38, each of the first through sixteenth local memories LM0 630(0) to LM15 630(15), upon receiving the respective first through sixteenth local memory instruction sets, outputs a corresponding first through sixteenth local memory data set. Each of the first through sixteenth local memory data sets includes first through sixty-fourth local memory data. As illustrated in FIG. 38, the first local memory 630(0) outputs the first local memory data DA0_0 stored in a storage location of the first local memory 630(0), designated by the local memory address “0” included in the first local memory instruction of the first local memory instruction set. Subsequently, the first local memory 630(0) outputs the second local memory data DA0_1 stored in a storage location of the first local memory 630(0), designated by the local memory address “1” included in the second local memory instruction of the first local memory instruction set. Finally, the first local memory 630(0) outputs the sixty-fourth local memory data DA0_63 stored in a storage location of the first local memory 630(0), designated by the local memory address “63” included in the sixty-fourth local memory instruction of the first local memory instruction set.

In the same manner, the second local memory 630(1) outputs the first local memory data DA1_0 stored in a storage location of the second local memory 630(1), designated by the local memory address “0” included in the first local memory instruction of the second local memory instruction set. Subsequently, the second local memory 630(1) outputs the second local memory data DA1_1 stored in a storage location of the second local memory 630(1), designated by the local memory address “1” included in the second local memory instruction of the second local memory instruction set. Finally, the second local memory 630(1) outputs the sixty-fourth local memory data DA1_63 stored in a storage location of the second local memory 630(1), designated by the local memory address “63” included in the sixty-fourth local memory instruction of the second local memory instruction set.

Similarly, the sixteenth local memory 630(15) outputs the first local memory data DA15_0 stored in a storage location of the sixteenth local memory 630(15), designated by the local memory address “0” included in the first local memory instruction of the sixteenth local memory instruction set. Subsequently, the sixteenth local memory 630(15) outputs the second local memory data DA15_1 stored in a storage location of the sixteenth local memory 630(15), designated by the local memory address “1” included in the second local memory instruction of the sixteenth local memory instruction set. Finally, the sixteenth local memory 630(15) outputs the sixty-fourth local memory data DA15_63 stored in a storage location of the sixteenth local memory 630(15), designated by the local memory address “63” included in the sixty-fourth local memory instruction of the sixteenth local memory instruction set.

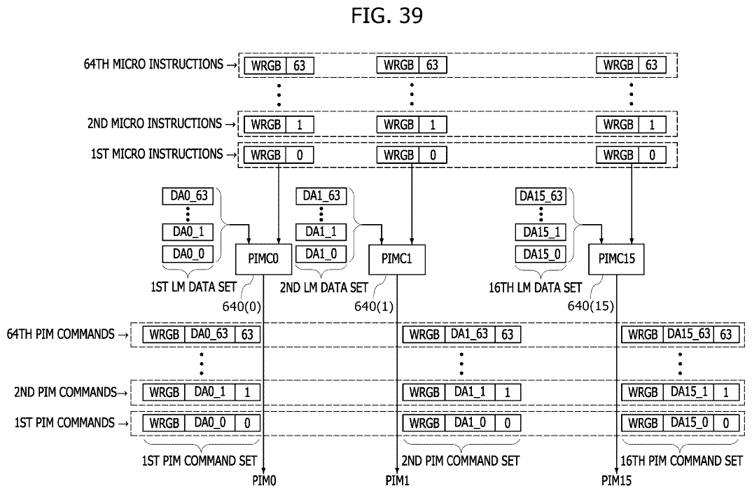

Referring to FIG. 39, each of the first through sixteenth PIM controllers 640(0) to 640(15) receives a corresponding first through sixteenth local memory data set from the first through sixteenth local memories 630(0) to 630(15), respectively. Specifically, the first PIM controller 640(0) sequentially receives the first through sixty-fourth local memory data DA0_O to DA0_63 included in the first local memory data set from the first local memory 630(0). The second PIM controller 640(1) sequentially receives the first through sixty-fourth local memory data DA1_0 to DA1_63 included in the second local memory data set from the second local memory 630(1). Similarly, the sixteenth PIM controller 640(15) sequentially receives the first through sixty-fourth local memory data DA15_0 to DA15_63 included in the sixteenth local memory data set from the sixteenth local memory 630(15).

The first through sixteenth PIM controllers 640(0) to 640(15) also receives a first through sixteenth micro instruction set from the first through sixteenth instruction decoders and sequencers 620(0) to 620(15), respectively. Specifically, the first PIM controller 640(0) sequentially receives the first through sixty-fourth micro instructions included in the first micro instruction set from the first instruction decoder and sequencer 620(0). The second PIM controller 640(1) sequentially receives the first through sixty-fourth micro instructions included in the second micro instruction set from the second instruction decoder and sequencer 620(1). Similarly, the sixteenth PIM controller 640(15) sequentially receives the first through sixty-fourth micro instructions included in the sixteenth micro instruction set from the sixteenth instruction decoder and sequencer 620(15).

Each of the first through sixteenth PIM controllers 640(0) to 640(15) generates and outputs a corresponding first through sixteenth PIM command set. Each of the first through sixteenth PIM command sets includes first through sixty-fourth PIM commands. Each of the first through sixty-fourth PIM commands includes an operation type, local memory data, and a column address. The operation type included in each of the first through sixty-fourth PIM commands is designated as “WRGB.” The local memory data included in each of the first through sixty-fourth PIM commands corresponds to the local memory data included in the respective local memory data set. The column address included in each of the first through sixty-fourth PIM commands corresponds to the column address included in the respective micro instruction set.

As illustrated in FIG. 39, the first PIM controller 640(0) outputs a first PIM command including an operation type designated as “WRGB,” local memory data “DA0_0,” and a column address “0.” Subsequently, the first PIM controller 640(0) outputs a second PIM command including an operation type designated as “WRGB,” local memory data “DA0_1,” and a column address “1.” In the same manner, the first PIM controller 640(0) sequentially outputs the third through sixty-third PIM commands. Finally, the first PIM controller 640(0) outputs a sixty-fourth PIM command including an operation type designated as “WRGB,” local memory data “DA0_63,” and a column address “63.” Similarly, the second PIM controller 640(1) outputs a first PIM command including an operation type designated as “WRGB,” local memory data “DA1_0,” and a column address “0.” Subsequently, the second PIM controller 640(1) outputs a second PIM command including an operation type designated as “WRGB,” local memory data “DA1_1,” and a column address “1.” In the same manner, the second PIM controller 640(1) sequentially outputs the third through sixty-third PIM commands. Finally, the second PIM controller 640(1) outputs a sixty-fourth PIM command including an operation type designated as “WRGB,” local memory data “DA1_63,” and a column address “63.” Similarly, the sixteenth PIM controller 640(15) outputs a first PIM command including an operation type designated as “WRGB,” local memory data “DA15_0,” and a column address “0.” Subsequently, the sixteenth PIM controller 640(15) outputs a second PIM command including an operation type designated as “WRGB,” local memory data “DA15_1,” and a column address “1.” In the same manner, the sixteenth PIM controller 640(15) sequentially outputs the third through sixty-third PIM commands. Finally, the sixteenth PIM controller 640(15) outputs a sixty-fourth PIM command including an operation type designated as “WRGB,” local memory data “DA15_63,” and a column address “63.”

Although not illustrated in the drawings, each of the first through sixteenth PIM devices 110(0) to 110(15), upon receiving the respective first through sixteenth PIM command sets, stores the first through sixty-fourth local memory data included in the first through sixty-fourth PIM commands into sixty-four storage locations of the global buffer designated by the column addresses included in the first through sixty-fourth PIM commands. For example, the first PIM device 110(0) stores the first local memory data “DA0_O” into a storage location of the global buffer designated by the column address “0” included in the first PIM command of the first PIM command set. Subsequently, the first PIM device 110(0) stores the second local memory data “DA0_1” into a storage location of the global buffer designated by the column address “1” included in the second PIM command of the first PIM command set. In the same manner, the first PIM device 110(0) stores the third through sixty-third local memory data into storage locations of the global buffer designated by the column addresses included in the third through sixty-third PIM commands of the first PIM command set. Finally, the first PIM device 110(0) stores the sixty-fourth local memory data “DA0_63” into a storage location of the global buffer designated by the column address “63” included in the sixty-fourth PIM command of the first PIM command set.

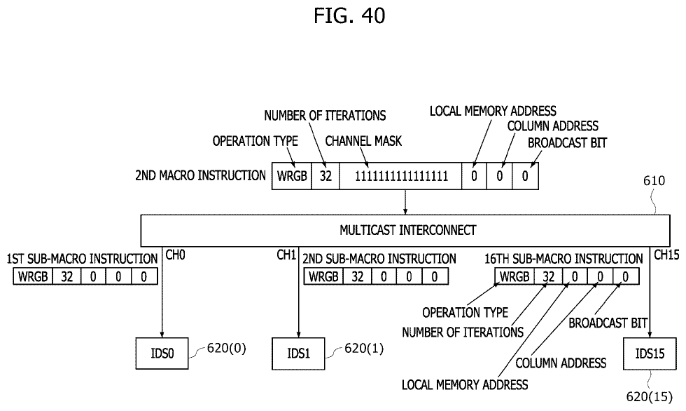

FIGS. 40 to 42 are diagrams illustrating another example process of executing the second macro instruction of FIG. 11 in the PIM system of FIG. 32. In this example, it is assumed that the PIM system 20 includes first through sixteenth channels CH0 to CH15. It is further assumed that the operation type, number of iterations, channel mask, local memory address, column address, and broadcast bit of the second macro instruction are respectively set to “WRGB,” “32,” “1111 1111 1111 1111,” “0,” “0,” and “0.” In the case of the second macro instruction described with reference to FIGS. 36 to 39, the number of iterations is “64,” and the broadcast bit has a value of “1.” In contrast, in this example, the second macro instruction differs in that the number of iterations is “32,” and the broadcast bit has a value of “0.”

Referring to FIG. 40, the multicast interconnect 610, upon receiving the second macro instruction, generates and outputs one or more sub-macro instructions based on the second macro instruction. Because the first through sixteenth bits of the channel mask included in the second macro instruction all have a binary value of “1,” the multicast interconnect 610 generates the first through sixteenth sub-macro instructions. The multicast interconnect 610 transmits the first through sixteenth sub-macro instructions respectively to the first through sixteenth instruction decoders and sequencers 620(0) to 620(15) through the first through sixteenth channels CH0 to CH15. Specifically, as illustrated in FIG. 40, the first sub-macro instruction is transmitted from the multicast interconnect 610 to the first instruction decoder and sequencer 620(0) through the first channel CH0. The second sub-macro instruction is transmitted from the multicast interconnect 610 to the second instruction decoder and sequencer 620(1) through the second channel CH1. Similarly, the sixteenth sub-macro instruction is transmitted from the multicast interconnect 610 to the sixteenth instruction decoder and sequencer 620(15) through the sixteenth channel CH15.

Each of the first through sixteenth sub-macro instructions may include an operation type, a number of iterations, a local memory address, a column address, and a broadcast bit. The operation type, number of iterations, local memory address, column address, and broadcast bit included in each of the first through sixteenth sub-macro instructions are respectively identical to the operation type, number of iterations, local memory address, column address, and broadcast bit included in the second macro instruction. Accordingly, each of the first through sixteenth sub-macro instructions includes an operation type set to “WRGB,” a number of iterations set to “32,” a local memory address set to “0,” a column address set to “0,” and a broadcast bit set to “0.”

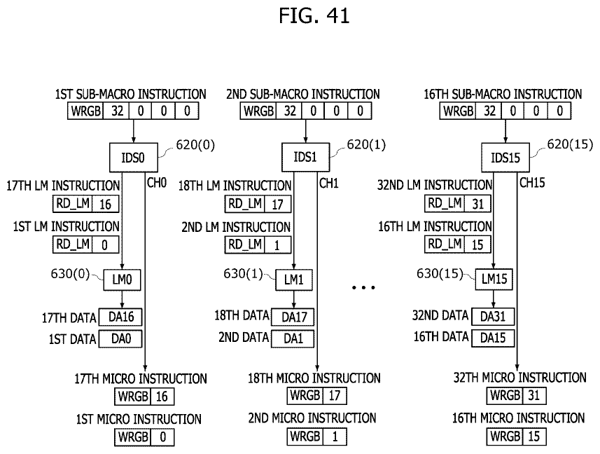

Referring to FIG. 41, because the broadcast bit included in each of the first through sixteenth sub-macro instructions is set to a binary value of “0,” each of the first through sixteenth instruction decoders and sequencers 620(0) to 620(15) generates and outputs first through thirty-second local memory instructions and first through thirty-second micro instructions. Specifically, each of the first through sixteenth instruction decoders and sequencers 620(0) to 620(15) outputs the first through sixteenth local memory instructions, respectively. The first through sixteenth local memory instructions are transmitted respectively to the first through sixteenth local memories 630(0) to 630(15). Subsequently, each of the first through sixteenth instruction decoders and sequencers 620(0) to 620(15) outputs the seventeenth through thirty-second local memory instructions, respectively. The seventeenth through thirty-second local memory instructions are transmitted respectively to the first through sixteenth local memories 630(0) to 630(15).

Each of the first through thirty-second local memory instructions includes a local memory command and a local memory address. The local memory command included in each of the first through thirty-second local memory instructions is designated as “RD_LM,” which instructs a read operation from the local memory. The local memory addresses included in the first through thirty-second local memory instructions sequentially increase, starting from the local memory address “0” included in each of the first through sixteenth sub-macro instructions.

As illustrated in FIG. 41, the local memory address included in the first local memory instruction output from the first instruction decoder and sequencer 620(0) is designated as “0.” The local memory address included in the second local memory instruction output from the second instruction decoder and sequencer 620(1) is designated as “1.” Similarly, the local memory address included in the sixteenth local memory instruction output from the sixteenth instruction decoder and sequencer 620(15) is designated as “15.” Subsequently, the local memory address included in the seventeenth local memory instruction output from the first instruction decoder and sequencer 620(0) is designated as “16,” and the local memory address included in the eighteenth local memory instruction output from the second instruction decoder and sequencer 620(1) is designated as “17.” In the same manner, the local memory address included in the thirty-second local memory instruction output from the sixteenth instruction decoder and sequencer 620(15) is designated as “31.”

Upon transmission of the first through sixteenth local memory instructions, the first through sixteenth local memories 630(0) to 630(15) respectively output the first through sixteenth local memory data DA0 to DA15. Subsequently, upon transmission of the seventeenth through thirty-second local memory instructions, the first through sixteenth local memories 630(0) to 630(15) respectively output the seventeenth through thirty-second local memory data DA16 to DA31. The first through sixteenth local memory data DA0 to DA15 output from the first through sixteenth local memories 630(0) to 630(15) are data stored in storage locations designated by the local memory addresses “0” to “15,” respectively. Similarly, the seventeenth through thirty-second local memory data DA16 to DA31 output from the first through sixteenth local memories 630(0) to 630(15) are data stored in storage locations designated by the local memory addresses “16” to “31,” respectively.

Meanwhile, each of the first through sixteenth instruction decoders and sequencers 620(0) to 620(15) outputs the first through sixteenth micro instructions. The first through sixteenth micro instructions are respectively output through the first through sixteenth channels CH0 to CH15. Subsequently, each of the first through sixteenth instruction decoders and sequencers 620(0) to 620(15) outputs the seventeenth through thirty-second micro instructions, respectively. The seventeenth through thirty-second micro instructions are also output through the first through sixteenth channels CH0 to CH15, respectively. Each of the first through thirty-second micro instructions includes an operation type and a column address. The operation type included in each of the first through thirty-second micro instructions is designated as “WRGB.” The column addresses included in the first through thirty-second micro instructions sequentially increase starting from the column address “0” included in each of the first through sixteenth sub-macro instructions.

As illustrated in FIG. 41, the column address included in the first micro instruction output from the first instruction decoder and sequencer 620(0) is designated as “0,” and the column address included in the second micro instruction output from the second instruction decoder and sequencer 620(1) is designated as “1.” Similarly, the column address included in the sixteenth micro instruction output from the sixteenth instruction decoder and sequencer 620(15) is designated as “15.” Subsequently, the column address included in the seventeenth micro instruction output from the first instruction decoder and sequencer 620(0) is designated as “16,” and the column address included in the eighteenth micro instruction output from the second instruction decoder and sequencer 620(1) is designated as “17.” In the same manner, the column address included in the 32nd micro instruction output from the sixteenth instruction decoder and sequencer 620(15) is designated as “31.”

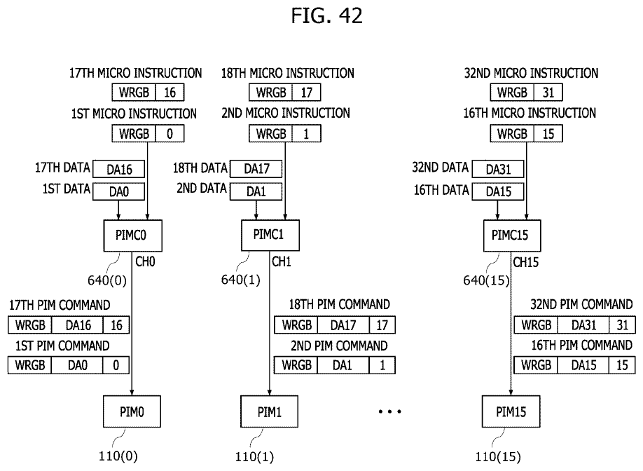

Referring to FIG. 42, each of the first through sixteenth PIM controllers 640(0) to 640(15) receives the first through sixteenth local memory data DA0 to DA15 from the first through sixteenth local memories 630(0) to 630(15), respectively, and also receives the first through sixteenth micro instructions from the first through sixteenth instruction decoders and sequencers 620(0) to 620(15), respectively. Subsequently, each of the first through sixteenth PIM controllers 640(0) to 640(15) receives the seventeenth through thirty-second local memory data DA16 to DA31 from the first through sixteenth local memories 630(0) to 630(15), respectively, and also receives the seventeenth through thirty-second micro instructions from the first through sixteenth instruction decoders and sequencers 620(0) to 620(15), respectively.

Upon receiving the first through sixteenth local memory data DA0 to DA15 and the first through sixteenth micro instructions, each of the first through sixteenth PIM controllers 640(0) to 640(15) generates and outputs the first through sixteenth PIM commands. Subsequently, upon receiving the seventeenth through thirty-second local memory data DA16 to DA31 and the seventeenth through thirty-second micro instructions, each of the first through sixteenth PIM controllers 640(0) to 640(15) generates and outputs the seventeenth through thirty-second PIM commands. The first through sixteenth PIM commands are transmitted respectively to the first through sixteenth PIM devices 110(0) to 110(15) through the first through sixteenth channels CH0 to CH15. Similarly, the seventeenth through thirty-second PIM commands are transmitted respectively to the first through sixteenth PIM devices 110(0) to 110(15) through the first through sixteenth channels CH0 to CH15.

Each of the first through thirty-second PIM commands includes an operation type, local memory data, and a column address. The operation type included in each of the first through thirty-second PIM commands is designated as “WRGB.” The first through thirty-second local memory data included in the first through thirty-second PIM commands correspond respectively to the first through thirty-second local memory data DA0 to DA31 transmitted from the first through sixteenth local memories 630(0) to 630(15). The first through sixteenth column addresses included in the first through sixteenth PIM commands correspond respectively to the first through sixteenth column addresses included in the first through sixteenth micro instructions. Similarly, the seventeenth through thirty-second column addresses included in the seventeenth through thirty-second PIM commands correspond respectively to the seventeenth through thirty-second column addresses included in the seventeenth through thirty-second micro instructions.

As illustrated in FIG. 42, the first PIM controller 640(0) outputs a first PIM command including an operation type designated as “WRGB,” the first local memory data “DA0,” and the first column address “0.” Subsequently, the first PIM controller 640(0) outputs a seventeenth PIM command including an operation type designated as “WRGB,” the seventeenth local memory data “DA16,” and the seventeenth column address “16.” Similarly, the second PIM controller 640(1) outputs a second PIM command including an operation type designated as “WRGB,” the second local memory data “DA1,” and the second column address “1.” Subsequently, the second PIM controller 640(1) outputs an eighteenth PIM command including an operation type designated as “WRGB,” the eighteenth local memory data “DA17,” and the eighteenth column address “17.” In the same manner, the sixteenth PIM controller 640(15) outputs a sixteenth PIM command including an operation type designated as “WRGB,” the sixteenth local memory data “DA15,” and the sixteenth column address “15.” Subsequently, the sixteenth PIM controller 640(15) outputs a thirty-second PIM command including an operation type designated as “WRGB,” the thirty-second local memory data “DA31,” and the thirty-second column address “31.”

Although not illustrated in the drawings, each of the first through sixteenth PIM devices 110(0) to 110(15), upon receiving the first through sixteenth PIM commands, respectively stores the first through sixteenth local memory data DA0 to DA15 into storage locations of the global buffer designated by the respective column addresses included in the first through sixteenth PIM commands. Similarly, each of the first through sixteenth PIM devices 110(0) to 110(15), upon receiving the seventeenth through thirty-second PIM commands, respectively stores the seventeenth through thirty-second local memory data DA16 to DA31 into storage locations of the global buffer designated by the respective column addresses included in the seventeenth through thirty-second PIM commands.

For example, the first PIM device 110(0) stores the first local memory data “DA0” into a storage location of the global buffer designated by the column address “0” included in the first PIM command. The second PIM device 110(1) stores the second local memory data “DA1” into a storage location of the global buffer designated by the column address “1” included in the second PIM command. In the same manner, the sixteenth PIM device 110(15) stores the sixteenth local memory data “DA15” into a storage location of the global buffer designated by the column address “15” included in the sixteenth PIM command. Subsequently, the first PIM device 110(0) stores the seventeenth local memory data “DA16” into a storage location of the global buffer designated by the column address “16” included in the seventeenth PIM command. The second PIM device 110(1) stores the eighteenth local memory data “DA17” into a storage location of the global buffer designated by the column address “17” included in the eighteenth PIM command. Similarly, the sixteenth PIM device 110(15) stores the thirty-second local memory data “DA31” into a storage location of the global buffer designated by the column address “31” included in the thirty-second PIM command.

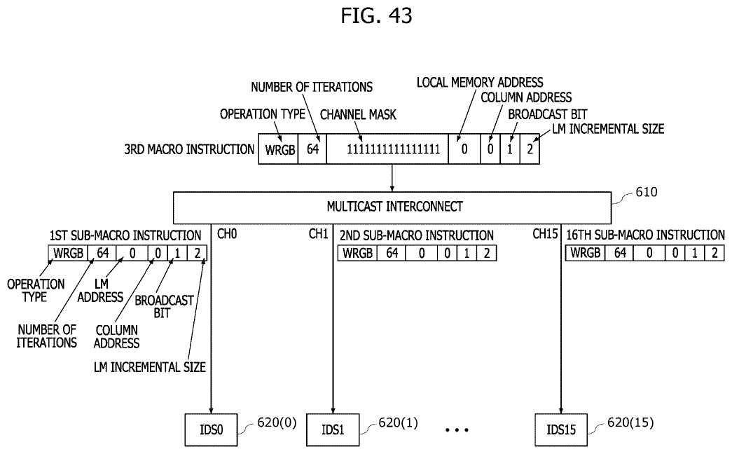

FIGS. 43 to 46 are diagrams illustrating an example process of executing the third macro instruction of FIG. 19 in the PIM system of FIG. 32. In this example, it is assumed that the PIM system 20 includes first through sixteenth channels CH0 to CH15. It is further assumed that the operation type, number of iterations, channel mask, local memory address, column address, broadcast bit, and local memory increment size of the third macro instruction are respectively set to “WRGB,” “64,” “1111 1111 1111 1111,” “0,” “0,” “1,” and “2.”

Referring to FIG. 43, the multicast interconnect 610, upon receiving the third macro instruction, generates and outputs one or more sub-macro instructions based on the third macro instruction. Because the first through sixteenth bits of the channel mask included in the third macro instruction all have a binary value of “1,” the multicast interconnect 610 generates the first through sixteenth sub-macro instructions. The multicast interconnect 610 transmits the first through sixteenth sub-macro instructions respectively to the first through sixteenth instruction decoders and sequencers 620(0) to 620(15) through the first through sixteenth channels CH0 to CH15. Each of the first through sixteenth sub-macro instructions may include an operation type, a number of iterations, a local memory address, a column address, a broadcast bit, and a local memory incremental size. The operation type, number of iterations, local memory address, column address, broadcast bit, and local memory incremental size included in each of the first through sixteenth sub-macro instructions are respectively identical to those included in the third macro instruction. Accordingly, each of the first through sixteenth sub-macro instructions includes an operation type set to “WRGB,” a number of iterations set to “64,” a local memory address set to “0,” a column address set to “0,” a broadcast bit set to “1,” and a local memory incremental size set to “2.”

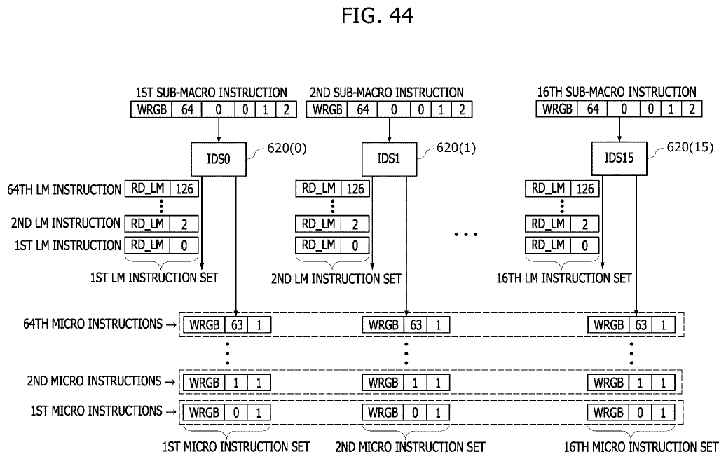

Referring to FIG. 44, each of the first through sixteenth instruction decoders and sequencers 620(0) to 620(15) generates and outputs a first through sixteenth local memory instruction set and a first through sixteenth micro instruction set based on the respective first through sixteenth sub-macro instructions. Each of the first through sixteenth instruction decoders and sequencers 620(0) to 620(15) transmits the first through sixteenth local memory instruction sets to the first through sixteenth local memories 630(0) to 630(15), respectively. Additionally, each of the first through sixteenth instruction decoders and sequencers 620(0) to 620(15) transmits the first through sixteenth micro instruction sets to the first through sixteenth PIM controllers 640(0) to 640(15), respectively.

As illustrated in FIG. 44, the first instruction decoder and sequencer 620(0) generates the first local memory instruction set and the first micro instruction set based on the first sub-macro instruction. The first instruction decoder and sequencer 620(0) transmits the first local memory instruction set to the first local memory 630(0) and transmits the first micro instruction set to the first PIM controller 640(0) through the first channel CH0. Similarly, the second instruction decoder and sequencer 620(1) generates the second local memory instruction set and the second micro instruction set based on the second sub-macro instruction. The second instruction decoder and sequencer 620(1) transmits the second local memory instruction set to the second local memory 630(1) and the second micro instruction set to the second PIM controller 640(1) through the second channel CH1. Likewise, the sixteenth instruction decoder and sequencer 620(15) generates the sixteenth local memory instruction set and the sixteenth micro instruction set based on the sixteenth sub-macro instruction and transmits the sixteenth local memory instruction set to the sixteenth local memory 630(15) and the sixteenth micro instruction set to the sixteenth PIM controller 640(15) through the sixteenth channel CH15.

Each of the first through sixteenth local memory instruction sets generated by the first through sixteenth instruction decoders and sequencers 620(0) to 620(15) includes a first through sixty-fourth local memory instruction. Each of the first through sixty-fourth local memory instructions includes a local memory command and a local memory address. The local memory command is designated as “RD_LM,” which instructs a read operation from the local memory. The local memory address sequentially increases from the starting address included in the sub-macro instruction, incrementing by the local memory incremental size “2” for each instruction. As illustrated in FIG. 44, the first local memory instructions included in the first through sixteenth local memory instruction sets each include a local memory command designated as “RD_LM” and a local memory address designated as “0.” The second local memory instructions each include a local memory command “RD_LM” and a local memory address designated as “2.” Similarly, the sixty-fourth local memory instructions each include a local memory command “RD_LM” and a local memory address designated as “126.”

Each of the first through sixteenth micro instruction sets output from the first through sixteenth instruction decoders and sequencers 620(0) to 620(15) includes a first through sixty-fourth micro instruction. Each of the first through sixty-fourth micro instructions includes an operation type and a column address. The operation type is designated as “WRGB,” which instructs a write operation to the global buffer. The column address sequentially increases from the starting column address included in the sub-macro instruction. As illustrated in FIG. 44, the first micro instructions each include an operation type designated as “WRGB” and a column address designated as “0.” The second micro instructions each include an operation type designated as “WRGB” and a column address designated as “1.” Similarly, the sixty-fourth micro instructions each include an operation type designated as “WRGB” and a column address designated as “63.”

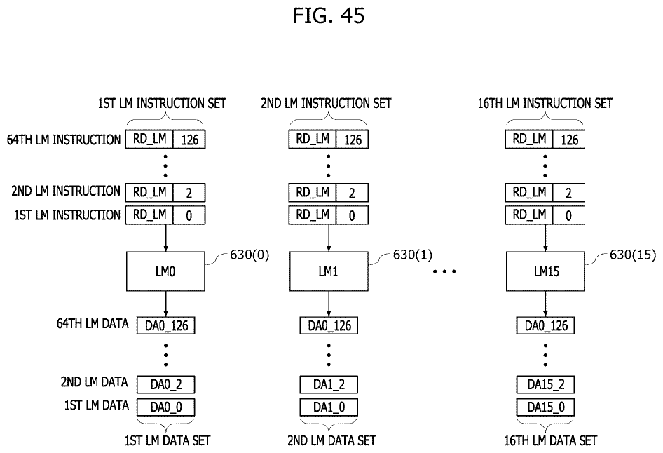

Referring to FIG. 45, each of the first through sixteenth local memories LM0 630(0) to LM15 630(15), upon receiving the first through sixteenth local memory instruction sets, respectively outputs a first through sixteenth local memory data set. Each of the first through sixteenth local memory data sets includes first through sixty-fourth local memory data. As illustrated in FIG. 45, the first local memory 630(0) outputs the first local memory data DA0_O stored at the storage location designated by the local memory address “0” included in the first local memory instruction of the first local memory instruction set. Subsequently, the first local memory 630(0) outputs the second local memory data DA0_2 stored at the storage location designated by the local memory address “2” included in the second local memory instruction of the first local memory instruction set. Finally, the first local memory 630(0) outputs the sixty-fourth local memory data DA0_126 stored at the storage location designated by the local memory address “126” included in the sixty-fourth local memory instruction of the first local memory instruction set.

In the same manner, the second local memory 630(1) outputs the first local memory data DA1_0 stored at the storage location designated by the local memory address “0” included in the first local memory instruction of the second local memory instruction set. Subsequently, the second local memory 630(1) outputs the second local memory data DA1_2 stored at the storage location designated by the local memory address “2” included in the second local memory instruction of the second local memory instruction set. Finally, the second local memory 630(1) outputs the sixty-fourth local memory data DA1_126 stored at the storage location designated by the local memory address “126” included in the sixty-fourth local memory instruction of the second local memory instruction set.

In the same manner, the sixteenth local memory 630(15) outputs the first local memory data DA15_0 stored at the storage location designated by the local memory address “0” included in the first local memory instruction of the sixteenth local memory instruction set. Subsequently, the sixteenth local memory 630(15) outputs the second local memory data DA15_2 stored at the storage location designated by the local memory address “2” included in the second local memory instruction of the sixteenth local memory instruction set. Finally, the sixteenth local memory 630(15) outputs the sixty-fourth local memory data DA15_126 stored at the storage location designated by the local memory address “126” included in the sixty-fourth local memory instruction of the sixteenth local memory instruction set.

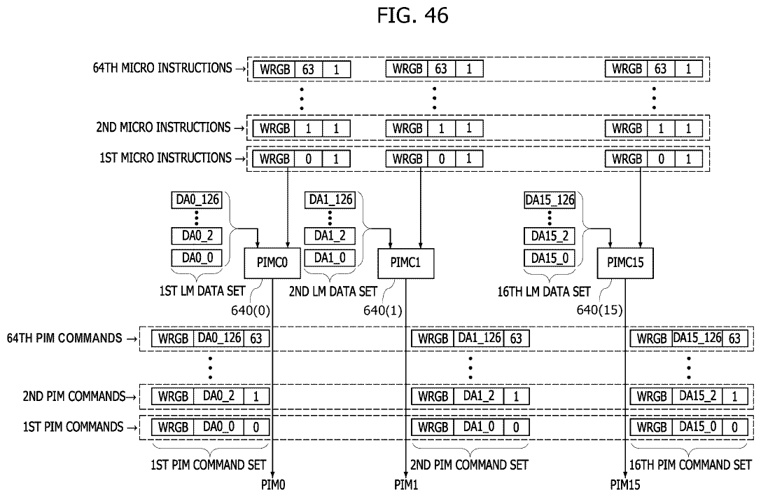

Referring to FIG. 46, each of the first through sixteenth PIM controllers 640(0) to 640(15) receives the first through sixteenth local memory data sets from the first through sixteenth local memories 630(0) to 630(15), respectively. Specifically, the first PIM controller 640(0) sequentially receives the first through sixty-fourth local memory data DA0_O to DA0_126 included in the first local memory data set from the first local memory 630(0). Similarly, the second PIM controller 640(1) sequentially receives the first through sixty-fourth local memory data DA1_0 to DA1_126 included in the second local memory data set from the second local memory 630(1). Likewise, the sixteenth PIM controller 640(15) sequentially receives the first through sixty-fourth local memory data DA15_0 to DA15_126 included in the sixteenth local memory data set from the sixteenth local memory 630(15).

Each of the first through sixteenth PIM controllers 640(0) to 640(15) also receives the first through sixteenth micro instruction sets from the first through sixteenth instruction decoders and sequencers 620(0) to 620(15), respectively. Specifically, the first PIM controller 640(0) sequentially receives the first through sixty-fourth micro instructions included in the first micro instruction set from the first instruction decoder and sequencer 620(0). Similarly, the second PIM controller 640(1) sequentially receives the first through sixty-fourth micro instructions included in the second micro instruction set from the second instruction decoder and sequencer 620(1). Likewise, the sixteenth PIM controller 640(15) sequentially receives the first through sixty-fourth micro instructions included in the sixteenth micro instruction set from the sixteenth instruction decoder and sequencer 620(15).

Each of the first through sixteenth PIM controllers 640(0) to 640(15) generates and outputs a first through sixteenth PIM command set, respectively. Each of the first through sixteenth PIM command sets includes first through sixty-fourth PIM commands. Each of the first through sixty-fourth PIM commands includes an operation type, local memory data, and a column address. The operation type included in each of the first through sixty-fourth PIM commands is designated as “WRGB.” The local memory data included in each of the first through sixty-fourth PIM commands corresponds to the local memory data included in the respective local memory data set. The column address included in each of the first through sixty-fourth PIM commands corresponds to the column address included in the respective micro instruction set.

As illustrated in FIG. 46, the first PIM controller 640(0) outputs a first PIM command including an operation type designated as “WRGB,” the first local memory data “DA0_O,” and a first column address “0.” Subsequently, the first PIM controller 640(0) outputs a second PIM command including an operation type designated as “WRGB,” the second local memory data “DA0_2,” and a second column address “1.” In the same manner, the first PIM controller 640(0) sequentially outputs third through sixty-third PIM commands. Finally, the first PIM controller 640(0) outputs a sixty-fourth PIM command including an operation type designated as “WRGB,” the sixty-fourth local memory data “DA0_126,” and a column address “63.” Similarly, the second PIM controller 640(1) outputs a first PIM command including an operation type designated as “WRGB,” the first local memory data “DA1_0,” and a first column address “0.” Subsequently, the second PIM controller 640(1) outputs a second PIM command including an operation type designated as “WRGB,” the second local memory data “DA1_2,” and a second column address “1.” In the same manner, the second PIM controller 640(1) sequentially outputs third through sixty-third PIM commands. Finally, the second PIM controller 640(1) outputs a sixty-fourth PIM command including an operation type designated as “WRGB,” the sixty-fourth local memory data “DA1_126,” and a column address “63.” Likewise, the sixteenth PIM controller 640(15) outputs a first PIM command including an operation type designated as “WRGB,” the first local memory data “DA15_0,” and a first column address “0.” Subsequently, the sixteenth PIM controller 640(15) outputs a second PIM command including an operation type designated as “WRGB,” the second local memory data “DA15_2,” and a second column address “1.” In the same manner, the sixteenth PIM controller 640(15) sequentially outputs third through sixty-third PIM commands. Finally, the sixteenth PIM controller 640(15) outputs a sixty-fourth PIM command including an operation type designated as “WRGB,” the sixty-fourth local memory data “DA15_126,” and a column address “63.”

Although not illustrated in the drawings, each of the first through sixteenth PIM devices 110(0) to 110(15), upon receiving the respective first through sixteenth PIM command sets, stores the first through sixty-fourth local memory data corresponding to the column addresses designated by the first through sixty-fourth PIM commands into sixty-four storage locations of the global buffer. For example, the first PIM device 110(0) stores the first local memory data “DA0_O” into the storage location of the global buffer designated by the column address “0” included in the first PIM command. Subsequently, the first PIM device 110(0) stores the second local memory data “DA0_2” into the storage location designated by the column address “1” included in the second PIM command. In the same manner, the first PIM device 110(0) stores the third through sixty-third local memory data into the respective storage locations designated by the third through sixty-third PIM commands. Finally, the first PIM device 110(0) stores the sixty-fourth local memory data “DA0_126” into the storage location designated by the column address “63” included in the sixty-fourth PIM command.

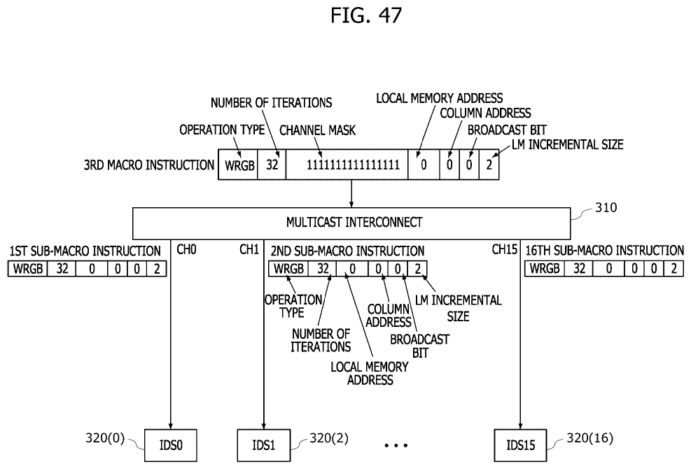

FIGS. 47 to 49 are diagrams illustrating another example process of executing the third macro instruction of FIG. 19 in the PIM system of FIG. 32. In this example, it is assumed that the PIM system 20 includes first through sixteenth channels CH0 to CH15. It is further assumed that the operation type, number of iterations, channel mask, local memory address, column address, broadcast bit, and local memory incremental size of the third macro instruction are respectively set to “WRGB,” “64,” “1111 1111 1111 1111,” “0,” “0,” “0,” and “2.”

Referring to FIG. 47, the multicast interconnect 610, upon receiving the third macro instruction, generates and outputs one or more sub-macro instructions based on the third macro instruction. Because the first through sixteenth bits of the channel mask included in the third macro instruction all have binary values of “1,” the multicast interconnect 610 generates a first through sixteenth sub-macro instruction. The multicast interconnect 610 transmits the first through sixteenth sub-macro instructions to the first through sixteenth instruction decoders and sequencers 620(0) to 620(15) through the first through sixteenth channels CH0 to CH15, respectively. Specifically, as illustrated in FIG. 47, the multicast interconnect 610 transmits the first sub-macro instruction to the first instruction decoder and sequencer 620(0) through the first channel CH0. The second sub-macro instruction is transmitted from the multicast interconnect 610 to the second instruction decoder and sequencer 620(1) through the second channel CH1. Likewise, the sixteenth sub-macro instruction is transmitted from the multicast interconnect 610 to the sixteenth instruction decoder and sequencer 620(15) through the sixteenth channel CH15.

Each of the first through sixteenth sub-macro instructions may include an operation type, a number of iterations, a local memory address, a column address, a broadcast bit, and a local memory incremental size. The operation type, number of iterations, local memory address, column address, broadcast bit, and local memory incremental size included in each of the first through sixteenth sub-macro instructions are identical to those included in the third macro instruction. Accordingly, each of the first through sixteenth sub-macro instructions includes an operation type set to “WRGB,” a number of iterations set to “32,” a local memory address set to “0,” a column address set to “0,” a broadcast bit set to “0,” and a local memory incremental size set to “2.”

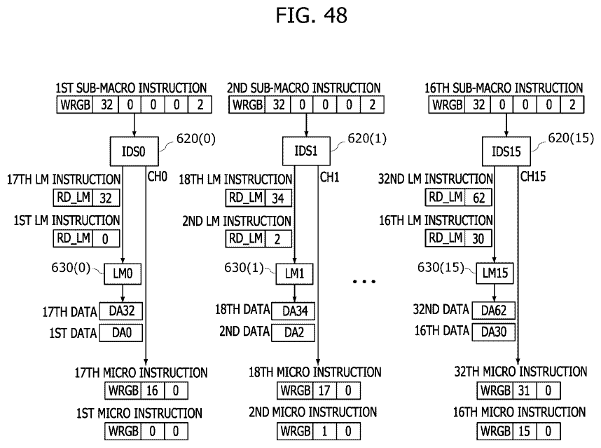

Referring to FIG. 48, because the broadcast bit included in each of the first through sixteenth sub-macro instructions is set to a binary value of “0,” the first through sixteenth instruction decoders and sequencers 620(0) to 620(15) generate and output first through thirty-second local memory instructions and first through thirty-second micro instructions, respectively. Specifically, the first through sixteenth instruction decoders and sequencers 620(0) to 620(15) output the first through sixteenth local memory instructions, respectively. The first through sixteenth local memory instructions are transmitted to the first through sixteenth local memories 630(0) to 630(15), respectively. Subsequently, the first through sixteenth instruction decoders and sequencers 620(0) to 620(15) output the seventeenth through thirty-second local memory instructions, respectively. The seventeenth through thirty-second local memory instructions are also transmitted to the first through sixteenth local memories 630(0) to 630(15), respectively.

The first through thirty-second local memory instructions each include a local memory command and a local memory address. The local memory command included in each of the first through thirty-second local memory instructions is designated as “RD_LM,” indicating a read operation from the local memory. The local memory addresses included in the first through thirty-second local memory instructions sequentially increase from the local memory address “0,” which is included in the first through sixteenth sub-macro instructions, in increments of the local memory incremental size “2.”

As illustrated in FIG. 48, the first local memory address included in the first local memory instruction output from the first instruction decoder and sequencer 620(0) is designated as “0.” The second local memory address included in the second local memory instruction output from the second instruction decoder and sequencer 620(1) is designated as “2.” Similarly, the sixteenth local memory address included in the sixteenth local memory instruction output from the sixteenth instruction decoder and sequencer 620(15) is designated as “30.” Subsequently, the seventeenth local memory address included in the seventeenth local memory instruction output from the first instruction decoder and sequencer 620(0) is designated as “32.” The eighteenth local memory address included in the eighteenth local memory instruction output from the second instruction decoder and sequencer 620(1) is designated as “34.” Likewise, the thirty-second local memory address included in the thirty-second local memory instruction output from the sixteenth instruction decoder and sequencer 620(15) is designated as “62.”

When the first through sixteenth local memory instructions are transmitted, the first through sixteenth local memories 630(0) to 630(15) output corresponding first through sixteenth local memory data DA0, DA2, . . . , DA30, respectively. Subsequently, when the seventeenth through thirty-second local memory instructions are transmitted, the first through sixteenth local memories 630(0) to 630(15) output corresponding seventeenth through thirty-second local memory data DA32, DA34, . . . , DA62, respectively. The first through sixteenth local memory data DA0, DA2, . . . , DA30 output from the first through sixteenth local memories 630(0) to 630(15) are data stored in storage locations designated by the local memory addresses “0,” “2,” . . . , “30.” Similarly, the seventeenth through thirty-second local memory data DA32, DA34, . . . , DA62 output from the first through sixteenth local memories 630(0) to 630(15) are data stored in storage locations designated by the local memory addresses “32,” “34,” . . . , “62.”

Meanwhile, the first through sixteenth instruction decoders and sequencers 620(0) to 620(15) output the first through sixteenth micro instructions, respectively. The first through sixteenth micro instructions are output through the first through sixteenth channels CH0 to CH15, respectively. Subsequently, the first through sixteenth instruction decoders and sequencers 620(0) to 620(15) output the seventeenth through thirty-second micro instructions, respectively. The seventeenth through thirty-second micro instructions are also output through the first through sixteenth channels CH0 to CH15, respectively. Each of the first through thirty-second micro instructions includes an operation type designated as “WRGB,” a column address, and a broadcast bit designated as “0.” The column addresses included in the first through thirty-second micro instructions sequentially increase from the column address “0,” which is included in the first through sixteenth sub-macro instructions.

As illustrated in FIG. 48, the column address included in the first micro instruction output from the first instruction decoder and sequencer 620(0) is designated as “0.” The column address included in the second micro instruction output from the second instruction decoder and sequencer 620(1) is designated as “1.” Similarly, the column address included in the sixteenth micro instruction output from the sixteenth instruction decoder and sequencer 620(15) is designated as “15.” Subsequently, the column address included in the seventeenth micro instruction output from the first instruction decoder and sequencer 620(0) is designated as “16.” The column address included in the eighteenth micro instruction output from the second instruction decoder and sequencer 620(1) is designated as “17.” Similarly, the column address included in the thirty-second micro instruction output from the sixteenth instruction decoder and sequencer 620(15) is designated as “31.”

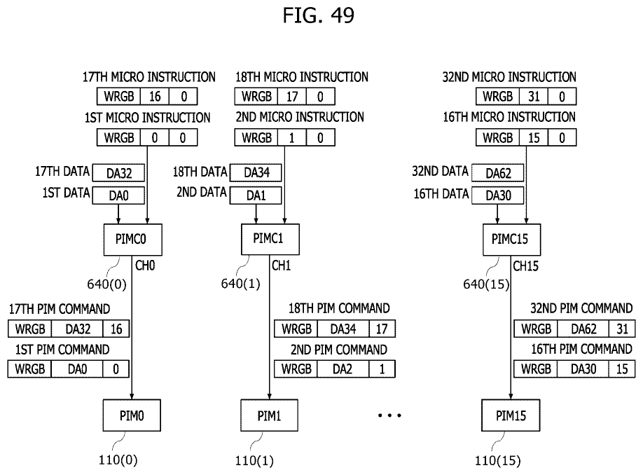

Referring to FIG. 49, the first PIM controller 640(0) to the sixteenth PIM controller 640(15) sequentially receive the first to sixteenth local memory data DA0, DA2, . . . , DA30 from the first local memory 630(0) to the sixteenth local memory 630(15), respectively, and also receive the first to sixteenth micro instructions from the first instruction decoder and sequencer 620(0) to the sixteenth instruction decoder and sequencer 620(15), respectively. Subsequently, the first PIM controller 640(0) to the sixteenth PIM controller 640(15) sequentially receive the seventeenth to thirty-second local memory data DA32, DA34, . . . , DA62 from the first local memory 630(0) to the sixteenth local memory 630(15), respectively, and also sequentially receive the seventeenth to thirty-second micro instructions from the first instruction decoder and sequencer 620(0) to the sixteenth instruction decoder and sequencer 620(15), respectively.

When the first to sixteenth local memory data DA0, DA2, . . . , DA30 and the first to sixteenth micro instructions are received, the first PIM controller 640(0) to the sixteenth PIM controller 640(15) generate and output the first to sixteenth PIM commands, respectively. Subsequently, when the seventeenth to thirty-second local memory data DA32, DA34, . . . , DA62 and the seventeenth to thirty-second micro instructions are received, the first PIM controller 640(0) to the sixteenth PIM controller 640(15) generate and output the seventeenth to thirty-second PIM commands, respectively.

The first to sixteenth PIM commands are transmitted to the first to sixteenth PIM devices 110(0) to 110(15) through the first to sixteenth channels CH0 to CH15, respectively. Similarly, the seventeenth to thirty-second PIM commands are transmitted to the first to sixteenth PIM devices 110(0) to 110(15) through the first to sixteenth channels CH0 to CH15, respectively. Each of the first to thirty-second PIM commands includes an operation type, local memory data, and a column address. The operation type included in each of the first to thirty-second PIM commands is designated as “WRGB.” The first to thirty-second local memory data DA0, DA2, . . . , DA30, DA32, DA34, . . . , DA62 included in the first to thirty-second PIM commands correspond respectively to the first to thirty-second local memory data transmitted from the first to sixteenth local memories 630(0) to 630(15). The first to sixteenth column addresses included in the first to sixteenth PIM commands correspond respectively to the first to sixteenth column addresses included in the first to sixteenth micro instructions. Likewise, the seventeenth to thirty-second column addresses included in the seventeenth to thirty-second PIM commands correspond respectively to the seventeenth to thirty-second column addresses included in the seventeenth to thirty-second micro instructions.

As illustrated in FIG. 49, the first PIM controller 640(0) outputs a first PIM command including an operation type designated as “WRGB,” the first local memory data DA0, and a first column address “0.” Subsequently, the first PIM controller 640(0) outputs a seventeenth PIM command including the operation type designated as “WRGB,” the seventeenth local memory data DA32, and a seventeenth column address “16.” Similarly, the second PIM controller 640(1) outputs a second PIM command including the operation type designated as “WRGB,” the second local memory data DA2, and a second column address “1.” Subsequently, the second PIM controller 640(1) outputs an eighteenth PIM command including the operation type designated as “WRGB,” the eighteenth local memory data DA34, and an eighteenth column address “17.” Likewise, the sixteenth PIM controller 640(15) outputs a sixteenth PIM command including the operation type designated as “WRGB,” the sixteenth local memory data DA30, and a sixteenth column address “15.” Subsequently, the sixteenth PIM controller 640(15) outputs a thirty-second PIM command including the operation type designated as “WRGB,” the thirty-second local memory data DA62, and a thirty-second column address “31.”

Although not explicitly shown in the drawings, the first to sixteenth PIM devices 110(0) to 110(15), upon receiving the first to sixteenth PIM commands, respectively store the first to sixteenth local memory data DA0, DA2, . . . , DA30 in storage locations of a global buffer designated by the respective column addresses included in the corresponding PIM commands. Similarly, the first to sixteenth PIM devices 110(0) to 110(15), upon receiving the seventeenth to thirty-second PIM commands, respectively store the seventeenth to thirty-second local memory data DA32, DA34, . . . , DA62 in storage locations of the global buffer designated by the respective column addresses included in the corresponding PIM commands.

For example, the first PIM device 110(0) stores the first local memory data DA0 in the storage location of the global buffer designated by the first PIM command's column address “0.” The second PIM device 110(1) stores the second local memory data DA2 in the storage location of the global buffer designated by the second PIM command's column address “1.” Similarly, the sixteenth PIM device 110(15) stores the sixteenth local memory data DA30 in the storage location of the global buffer designated by the sixteenth PIM command's column address “15.” Continuing, the first PIM device 110(0) stores the seventeenth local memory data DA32 in the storage location of the global buffer designated by the seventeenth PIM command's column address “16.” The second PIM device 110(1) stores the eighteenth local memory data DA34 in the storage location of the global buffer designated by the eighteenth PIM command's column address “17.” Similarly, the sixteenth PIM device 110(15) stores the thirty-second local memory data DA62 in the storage location of the global buffer designated by the thirty-second PIM command's column address “31.”

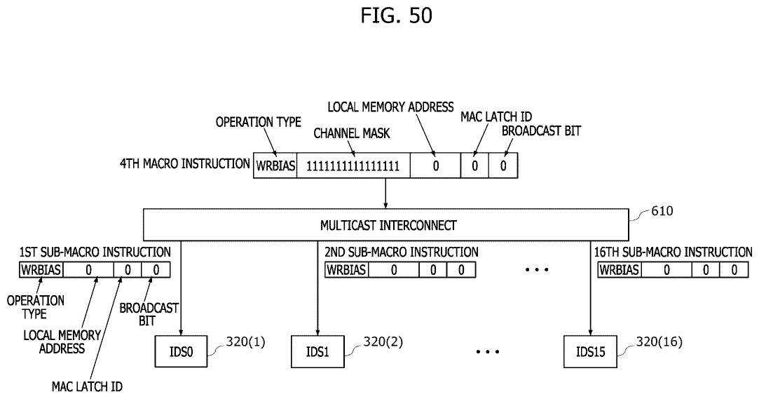

FIGS. 50 to 52 are diagrams illustrating a process of executing the fourth macro instruction of FIG. 28 in the PIM system of FIG. 32. In this example, it is assumed that the PIM system 20 includes first to sixteenth channels CH0 to CH15. It is further assumed that an operation type, a channel mask, a local memory address, a MAC latch ID, and a broadcast bit of the fourth macro instruction are respectively set to “WRBIAS,” “1111 1111 1111 1111,” “0,” “0,” and “0.”

Referring to FIG. 50, a multicast interconnect 610, upon receiving the fourth macro instruction, generates and outputs one or more sub-macro instructions based on the fourth macro instruction. Because the first to sixteenth bits of the channel mask included in the fourth macro instruction each have a binary value of “1,” the multicast interconnect 610 generates a first sub-macro instruction to a sixteenth sub-macro instruction. The multicast interconnect 610 transmits the first to sixteenth sub-macro instructions respectively to a first instruction decoder and sequencer 620(0) to a sixteenth instruction decoder and sequencer 620(15) through a first channel CH0 to a sixteenth channel CH15. Specifically, as illustrated in FIG. 50, the first sub-macro instruction is transmitted from the multicast interconnect 610 to the first instruction decoder and sequencer 620(0) through the first channel CH0. Similarly, the second sub-macro instruction is transmitted to the second instruction decoder and sequencer 620(1) through the second channel CH1, and the sixteenth sub-macro instruction is transmitted to the sixteenth instruction decoder and sequencer 620(15) through the sixteenth channel CH15.

Each of the first to sixteenth sub-macro instructions may include an operation type, a local memory address, a MAC latch ID, and a broadcast bit. The operation type, the local memory address, the MAC latch ID, and the broadcast bit included in each of the first to sixteenth sub-macro instructions are identical to the operation type, the local memory address, the MAC latch ID, and the broadcast bit included in the fourth macro instruction, respectively. Accordingly, each of the first to sixteenth sub-macro instructions includes the operation type set to “WRBIAS,” the local memory address set to “0,” the MAC latch ID set to “0,” and the broadcast bit set to “0.” In some cases, when the broadcast bit set to a binary value of “0” in the fourth macro instruction is omitted, the first to sixteenth sub-macro instructions may also omit the broadcast bit.

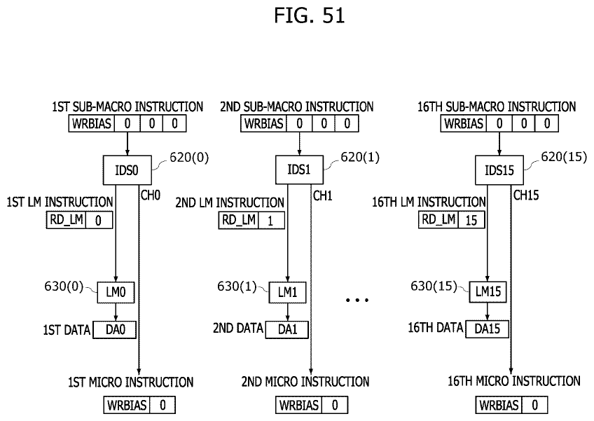

Referring to FIG. 51, each of a first instruction decoder and sequencer 620(0) to a sixteenth instruction decoder and sequencer 620(15) generates and outputs a first to sixteenth local memory instruction and a first to sixteenth micro instruction. Specifically, the first instruction decoder and sequencer 620(0) to the sixteenth instruction decoder and sequencer 620(15) respectively output the first to sixteenth local memory instructions. The first to sixteenth local memory instructions are transmitted respectively to a first local memory 630(0) to a sixteenth local memory 630(15). Each of the first to sixteenth local memory instructions includes a local memory command and a local memory address. The local memory command included in each local memory instruction is designated as “RD_LM,” which indicates a read operation for the local memory. The local memory addresses included in the first to sixteenth local memory instructions sequentially increase starting from the local memory address “0” included in the corresponding sub-macro instructions. As illustrated in FIG. 51, the first local memory address output from the first instruction decoder and sequencer 620(0) is designated as “0,” the second local memory address output from the second instruction decoder and sequencer 620(1) is designated as “1,” and similarly, the sixteenth local memory address output from the sixteenth instruction decoder and sequencer 620(15) is designated as “15.”

When the first to sixteenth local memory instructions are transmitted, the first local memory 630(0) to the sixteenth local memory 630(15) respectively output first to sixteenth local memory data DA0 to DA15. The first to sixteenth local memory data DA0 to DA15 output from the local memories 630(0) to 630(15) correspond to the data stored at the storage locations designated by the local memory addresses “0” to “15,” respectively.

Meanwhile, the first instruction decoder and sequencer 620(0) to the sixteenth instruction decoder and sequencer 620(15) respectively output the first to sixteenth micro instructions. The first to sixteenth micro instructions are respectively transmitted through the first to sixteenth channels CH0 to CH15. Each of the first to sixteenth micro instructions includes an operation type designated as “WRBIAS” and a MAC latch ID. The column addresses included in the first to sixteenth micro instructions sequentially increase starting from the column address “0” included in the corresponding sub-macro instructions. As illustrated in FIG. 51, the column address of the first micro instruction output from the first instruction decoder and sequencer 620(0) is “0,” the column address of the second micro instruction output from the second instruction decoder and sequencer 620(1) is “1,” and similarly, the column address of the sixteenth micro instruction output from the sixteenth instruction decoder and sequencer 620(15) is “15.”

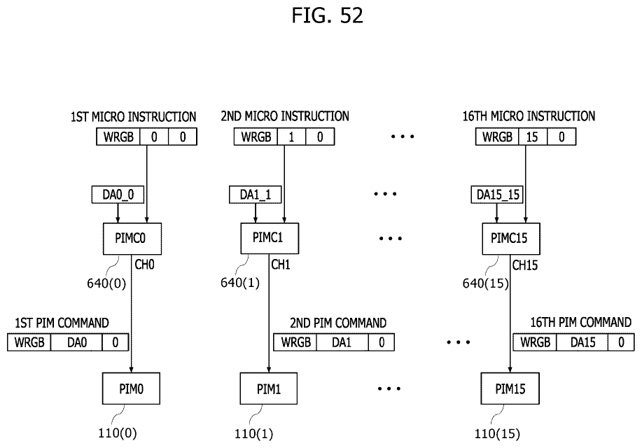

Referring to FIG. 52, each of a first PIM controller 640(0) to a sixteenth PIM controller 640(15) sequentially receives first to sixteenth local memory data DA0 to DA15 from a corresponding first to sixteenth local memory 630(0) to 630(15), and also sequentially receives first to sixteenth micro instructions from a first to a sixteenth instruction decoder and sequencer 620(0) to 620(15). When the first to sixteenth local memory data DA0 to DA15 and the first to sixteenth micro instructions are transmitted, the first to sixteenth PIM controllers 640(0) to 640(15) generate and output corresponding first to sixteenth PIM commands, respectively. The first to sixteenth PIM commands are respectively transmitted to a first to a sixteenth PIM device 110(0) to 110(15) through corresponding first to sixteenth channels CH0 to CH15.

Each of the first to sixteenth PIM commands includes an operation type, local memory data, and a MAC latch ID. The operation type included in each PIM command is designated as “WRBIAS.” The local memory data included in each PIM command corresponds to the local memory data DA0 to DA15 received from the local memories 630(0) to 630(15), respectively. The MAC latch IDs included in the first to sixteenth PIM commands are identical to the MAC latch IDs included in the corresponding first to sixteenth micro instructions. As illustrated in FIG. 52, the first PIM controller 640(0) outputs the first PIM command including the operation type designated as “WRBIAS,” the first local memory data DA0, and the MAC latch ID “0.” Similarly, the second PIM controller 640(1) outputs the second PIM command including the operation type designated as “WRBIAS,” the second local memory data DA1, and the MAC latch ID “0.” In the same manner, the sixteenth PIM controller 640(15) outputs the sixteenth PIM command including the operation type designated as “WRBIAS,” the sixteenth local memory data DA15, and the MAC latch ID “0.”

Although not illustrated in the drawings, each of a first PIM device 110(0) to a sixteenth PIM device 110(15), upon receiving a corresponding one of the first to sixteenth PIM commands, respectively latches a corresponding one of the first to sixteenth local memory data DA0 to DA15 into a latch circuit designated by a corresponding one of the first to sixteenth MAC latch IDs included in the respective PIM commands. For example, the first PIM device 110(0) latches the first local memory data DA0 into a latch circuit designated by the first MAC latch ID “0” included in the first PIM command. The second PIM device 110(1) latches the second local memory data DA1 into a latch circuit designated by the second MAC latch ID “0” included in the second PIM command. In the same manner, the sixteenth PIM device 110(15) latches the sixteenth local memory data DA15 into a latch circuit designated by the MAC latch ID “0” included in the sixteenth PIM command.

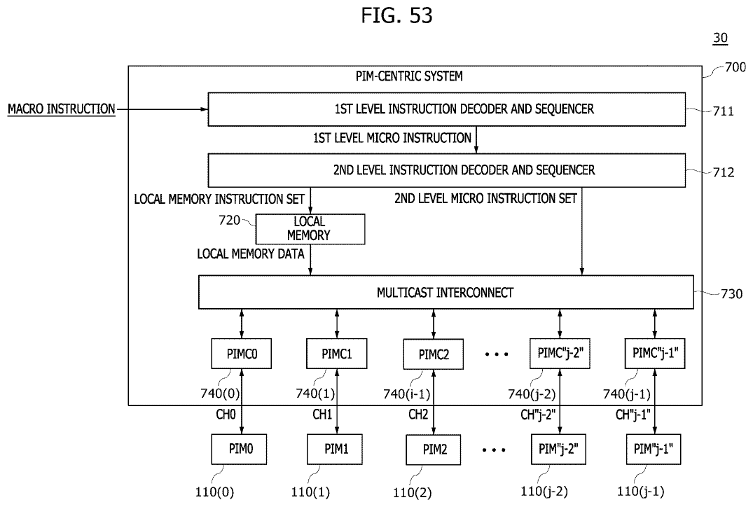

FIG. 53 is a block diagram illustrating yet another embodiment of the PIM system according to the present disclosure.

Referring to FIG. 53, a PIM system 10 includes a plurality of PIM devices, for example, a first to a j-th PIM device (PIM0 to PIM“j−1”) 110(0) to 110(j−1), and a PIM-centric system 700. The first to j-th PIM devices 110(0) to 110(j−1) and the PIM-centric system 700 are respectively coupled through a first to j-th channels CH0 to CH“j−1.” Here, the first to j-th channels CH0 to CH“j−1” represent physical connections between the first to j-th PIM devices 110(0) to 110(j−1) and the PIM-centric system 700. Each of the first to j-th channels CH0 to CH“j−1” has an independent data bus. Accordingly, signal transmission between the first to j-th PIM devices 110(0) to 110(j−1) and the PIM-centric system 700 may be performed simultaneously through the first to j-th channels CH0 to CH“j−1.” As illustrated in FIG. 53, the first PIM device 110(0) is coupled to the PIM-centric system 700 through the first channel CH0. The second PIM device 110(1) is coupled to the PIM-centric system 700 through the second channel CH1. The third PIM device 110(2) is coupled to the PIM-centric system 700 through the third channel CH2. The “(j−1)”-th PIM device 110(j−2) is coupled to the PIM-centric system 700 through the “(j−1)”-th channel CH“j−2,” and the j-th PIM device 110(j−1) is coupled to the PIM-centric system 700 through the j-th channel CH“j−1.” Although not illustrated in FIG. 53, in another embodiment, two or more PIM devices may share a single channel to be coupled to the PIM-centric system 700. In this case, the PIM system 30 may include a number of PIM devices that is a multiple of “j.” The structure and operations of the first to j-th PIM devices 110(0) to 110(j−1) may be the same as those described with reference to FIGS. 1 to 3.

The PIM-centric system 700 controls operations of the first to j-th PIM devices 110(0) to 110(j−1). The PIM-centric system 700 may be coupled to a host. The PIM-centric system 700 may also be coupled to another PIM-centric system included in a different PIM system. The PIM-centric system 700 may receive macro instructions from the host. Based on the macro instructions transmitted from the host, the PIM-centric system 700 may generate one or more PIM command sets. The PIM-centric system 700 may transmit one or more PIM commands or one or more PIM command sets to one or more of the first to j-th PIM devices 110(0) to 110(j−1).

The PIM-centric system 700 may include a first-level instruction decoder and sequencer 711, a second-level instruction decoder and sequencer 712, a local memory 720, a multicast interconnect 730, and first to j-th PIM controllers 740(0) to 740(j−1). The first-level instruction decoder and sequencer 711 is coupled to the second-level instruction decoder and sequencer 712. The second-level instruction decoder and sequencer 712 is coupled to the local memory 720 and the multicast interconnect 730. The multicast interconnect 730 is coupled to the local memory 720. Further, the multicast interconnect 730 is coupled to the first to j-th PIM controllers 740(0) to 740(j−1). The first to j-th PIM controllers 740(0) to 740(j−1) are respectively coupled to the first to j-th PIM devices 110(0) to 110(j−1) through the first to j-th channels CH0 to CH“j−1.”

Although not illustrated in FIG. 53, similarly to the PIM-centric system 200 of the PIM system 10 described with reference to FIG. 1, the PIM-centric system 700 may include a host interface, a network router, and a computation unit. In this case, the host interface may be coupled to the first-level instruction decoder and sequencer 711, the network router may be coupled to the multicast interconnect 730, and the computation unit may be coupled to the second-level instruction decoder and sequencer 712 and the multicast interconnect 730.

The first-level instruction decoder and sequencer 711 may receive a macro instruction transmitted from a host to the PIM-centric system 700. In one example, the macro instruction transmitted to the first-level instruction decoder and sequencer 711 may include an operation type, a matrix row count, a matrix column count, a starting bias address, a starting input vector address, a starting row address, a starting column address, a starting bank address, and a starting channel. The operation type may be designated as a command specifying a matrix-vector multiplication operation, for example, “GEMV.” The matrix row count indicates the number of rows of a weight matrix used for the matrix-vector multiplication operation. The matrix column count indicates the number of columns of the weight matrix used for the matrix-vector multiplication operation. The starting bias address indicates a starting address in a local memory where bias data is stored. The starting input vector address indicates a starting address in a local memory where input vector data is stored. The starting row address indicates a row address of memory banks where weight data used for the matrix-vector multiplication operation is stored. The starting column address indicates a starting column address of the memory banks where the weight data is stored. The starting bank address indicates a starting bank address of the memory banks where the weight data is stored. The starting channel indicates a starting channel among a plurality of channels that is enabled.

The first-level instruction decoder and sequencer 711 may generate and output one or more first-level micro instructions based on the macro instruction. The first-level instruction decoder and sequencer 711 may transmit the first-level micro instructions to the second-level instruction decoder and sequencer 712. The first-level micro instruction output from the first-level instruction decoder and sequencer 711 may be a lower-level macro instruction corresponding to the received macro instruction. For example, the operation designated by the macro instruction may be achieved through the sequential execution of a plurality of sub-operations. The first first-level micro instruction output from the first-level instruction decoder and sequencer 711 specifies a first sub-operation to be performed first among the plurality of sub-operations. The next first-level micro instruction output specifies a second sub-operation to be performed following the first sub-operation. The last first-level micro instruction output specifies a sub-operation to be performed last among the plurality of sub-operations.

In one embodiment, the first-level micro instruction output from the first-level instruction decoder and sequencer 711 may correspond to the first macro instruction 510 described with reference to FIG. 7, the second macro instruction 520 described with reference to FIG. 11, the third macro instruction 530 described with reference to FIG. 19, or the fourth macro instruction 540 described with reference to FIG. 28. In one embodiment, the first-level instruction decoder and sequencer 711 may first output a first-level instruction corresponding to the fourth macro instruction, then output a first-level instruction corresponding to the second macro instruction, and finally output a first-level instruction corresponding to the first macro instruction. In another embodiment, the first-level instruction decoder and sequencer 711 may first output a first-level instruction corresponding to the fourth macro instruction, then output a first-level instruction corresponding to the third macro instruction, and finally output a first-level instruction corresponding to the first macro instruction.

The second-level instruction decoder and sequencer 712 may output a second-level micro instruction set based on the first-level micro instruction. The second-level instruction decoder and sequencer 712 may also output a local memory instruction set along with the second-level micro instruction set. In one embodiment, when the first-level micro instruction corresponds to the first macro instruction, the second-level instruction decoder and sequencer 712 may output only the second-level micro instruction set without outputting the local memory instruction set. In another embodiment, when the first-level micro instruction corresponds to the second macro instruction, the third macro instruction, or the fourth macro instruction, the second-level instruction decoder and sequencer 712 may output the second-level micro instruction set together with the local memory instruction set. The second-level instruction decoder and sequencer 712 may transmit the second-level micro instruction set to the multicast interconnect 730. The second-level instruction decoder and sequencer 712 may transmit the local memory instruction set to the local memory 720.

In one embodiment, when a first-level micro instruction corresponding to the first macro instruction, in which the operation type is designated as “MAC,” is transmitted, the second-level instruction decoder and sequencer 712 generates and outputs a second-level micro instruction set including first to “m”-th micro instructions. Here, “m” represents the operation number of iterations included in the first-level micro instruction. In this case, the process of generating the first to “m”-th micro instructions included in the second-level micro instruction set may be the same as the process of generating the first to sixty-fourth micro instructions described with reference to FIG. 8. Accordingly, the first to “m”-th micro instructions included in the second-level micro instruction set may include an operation type, a channel mask, a row address, and a column address.

In one embodiment, when a first-level micro instruction corresponding to the second macro instruction or the third macro instruction, in which the operation type is designated as “WRGB” and the broadcast bit has a binary value of “1,” is transmitted, the second-level instruction decoder and sequencer 712 generates and outputs a second-level micro instruction set including first to “m”-th micro instructions and a local memory instruction set including first to “m”-th local memory instructions. In this case, each of the first to “m”-th micro instructions may include an operation type, a channel mask, a column address, and a broadcast bit. Each of the first to “m”-th local memory instructions may include a local memory command and a local memory address. When a first-level micro instruction corresponding to the second macro instruction or the third macro instruction, in which the operation type is designated as “WRGB” and the broadcast bit has a binary value of “0,” is transmitted, the second-level instruction decoder and sequencer 712 generates and outputs a second-level micro instruction set including “m×t” micro instructions and a local memory instruction set including “m×t” local memory instructions. Here, “t” represents the number of bits having a binary value of “1” among the bits of the channel mask included in the first-level micro instruction. In this case, each of the “m×t” micro instructions included in the second-level micro instruction set may include an operation type, a channel mask, a column address, and a broadcast bit. Each of the “m×t” local memory instructions included in the local memory instruction set may include a local memory command and a local memory address.

When the broadcast bit included in the first-level micro instruction has a binary value of “1,” the process of generating the first to “m”-th micro instructions included in the second-level micro instruction set and the first to “m”-th local memory instructions included in the local memory instruction set may be the same as the process of generating the first to sixty-fourth micro instructions and the first to sixty-fourth local memory instructions described with reference to FIG. 12. When the first-level micro instruction includes both a broadcast bit having a binary value of “1” and a local memory increment size, the process of generating the first to “m”-th micro instructions included in the second-level micro instruction set and the first to “m”-th local memory instructions included in the local memory instruction set may be the same as the process of generating the first to sixty-fourth micro instructions and the first to sixty-fourth local memory instructions described with reference to FIG. 20. Accordingly, the first to “m”-th micro instructions included in the second-level micro instruction set may include an operation type, a channel mask, a column address, and a broadcast bit. Additionally, the first to “m”-th local memory instructions included in the local memory instruction set may include a local memory command and a local memory address.

When the broadcast bit included in the first-level micro instruction has a binary value of “0,” the process of generating the “m×t” micro instructions included in the second-level micro instruction set and the “m×t” local memory instructions included in the local memory instruction set may be the same as the process of generating 512 micro instructions and 512 local memory instructions described with reference to FIG. 15. When the first-level micro instruction includes both a broadcast bit having a binary value of “0” and a local memory increment size, the process of generating the “m×t” micro instructions included in the second-level micro instruction set and the “m×t” local memory instructions included in the local memory instruction set may be the same as the process of generating 512 micro instructions and 512 local memory instructions described with reference to FIG. 24.

In one embodiment, when a second-level micro instruction set and a local memory instruction set are generated based on a first-level micro instruction corresponding to the fourth macro instruction, in which the operation type is designated as “WRBIAS,” the second-level micro instruction set output from the second-level instruction decoder and sequencer 712 may include “t” micro instructions, and the local memory instruction set may include “t” local memory instructions. In this case, each of the “t” micro instructions included in the second-level micro instruction set may include an operation type, a channel mask, a MAC latch ID, and a broadcast bit. Each of the “t” local memory instructions included in the local memory instruction set may include a local memory command and a local memory address. The process of generating the “t” micro instructions included in the second-level micro instruction set and the “t” local memory instructions included in the local memory instruction set may be the same as the process of generating the first to sixteenth micro instructions and the first to sixteenth local memory instructions described with reference to FIG. 29.

When the local memory instruction set is transmitted from the second-level instruction decoder and sequencer 712, the local memory 720 performs a local memory operation based on the local memory instruction set. In one embodiment, when the local memory instruction set is generated based on a first-level micro instruction corresponding to the second macro instruction or the third macro instruction, the local memory 720 outputs vector data stored in storage locations designated by the local memory addresses included in the first to “m”-th local memory instructions and transmits the vector data to the multicast interconnect 730. In another embodiment, when the local memory instruction set is generated based on a first-level micro instruction corresponding to the fourth macro instruction, the local memory 720 outputs bias data stored in storage locations designated by the local memory addresses included in the first to j-th local memory instructions and transmits the bias data to the multicast interconnect 730.

When the second-level micro instruction set is transmitted from the second-level instruction decoder and sequencer 712 to the multicast interconnect 730, the multicast interconnect 730 may generate one or more sub-micro instruction sets based on the second-level micro instruction set. When the second-level micro instruction set and local memory data are respectively transmitted from the second-level instruction decoder and sequencer 712 and the local memory 720 to the multicast interconnect 730, the multicast interconnect 730 may generate one or more sub-micro instruction sets based on the second-level micro instruction set and the local memory data.

When the first-level micro instruction corresponds to the first macro instruction in which the operation type is designated as “MAC,” the multicast interconnect 730 generates and outputs at least one of the first to j-th sub-micro instruction sets based on the first to “m”-th micro instructions transmitted from the second-level instruction decoder and sequencer 712. Each of the sub-micro instruction sets may include first to “m”-th sub-micro instructions. Each of the first to “m”-th sub-micro instructions may include an operation type designated as “MAC,” a row address, and a column address. The process of generating at least one of the first to j-th sub-micro instruction sets may be performed in the same manner as the process of generating the first to sixteenth sub-micro instruction sets described with reference to FIG. 9.

When the first-level micro instruction corresponds to the second macro instruction or the third macro instruction in which the operation type is designated as “WRGB” and the broadcast bit has a binary value of “1,” the multicast interconnect 730 generates and outputs at least one of the first to j-th sub-micro instruction sets based on the first to “m”-th micro instructions and the first to “m”-th local memory data transmitted from the second-level instruction decoder and sequencer 712. Each of the sub-micro instruction sets may include first to “m”-th sub-micro instructions. Each of the first to “m”-th sub-micro instructions may include an operation type designated as “WRGB,” local memory data, and a column address. The process of generating at least one of the first to j-th sub-micro instruction sets may be performed in the same manner as the process of generating the first to sixteenth sub-micro instruction sets described with reference to FIG. 13 or FIG. 22.

When the first-level micro instruction corresponds to the second macro instruction or the third macro instruction, in which the operation type is designated as “WRGB” and the broadcast bit has a binary value of “0,” the multicast interconnect 730 generates and outputs “m×t” sub-micro instruction sets based on the “m×t” micro instructions and the “m×t” pieces of local memory data transmitted from the second-level instruction decoder and sequencer 712. The process of generating the “m×t” sub-micro instruction sets may be performed in the same manner as the process of generating the first to 512th sub-micro instruction sets described with reference to FIG. 17 or FIG. 26.

When the first-level micro instruction corresponds to the fourth macro instruction, in which the operation type is designated as “WRBIAS,” the multicast interconnect 730 generates and outputs “t” sub-micro instruction sets. Specifically, when the “i”-th micro instruction is transmitted to the multicast interconnect 730, the multicast interconnect 730 generates the “i”-th sub-micro instruction set. Conversely, when the “i”-th micro instruction is not transmitted to the multicast interconnect 730, the multicast interconnect 730 does not generate the “i”-th sub-micro instruction set. In one embodiment, the “i”-th sub-micro instruction set may include an operation type designated as “WRGB,” local memory data, and a MAC latch ID. The process of generating at least one of the first to j-th sub-micro instruction sets may be performed in the same manner as the process of generating the first to sixteenth sub-micro instruction sets described with reference to FIG. 30.

The multicast interconnect 730 transmits the sub-micro instruction sets to the PIM controllers. In one embodiment, when the first-level micro instruction has an operation type designated as “MAC,” or an operation type designated as “WRGB” with a broadcast bit having a binary value of “1,” the “i”-th sub-micro instruction set generated by the multicast interconnect 730 is transmitted to the “i”-th PIM controller 740(i−1) via the “i”-th channel CH(i−1). In this case, the multicast interconnect 730 sequentially transmits the first to “m”-th sub-micro instructions included in the “i”-th sub-micro instruction set to the “i”-th PIM controller 740(i−1). The process of transmitting the “i”-th sub-micro instruction set to the “i”-th PIM controller 740(i−1) may be performed in the same manner as the process of transmitting the first to sixteenth sub-micro instruction sets to the first to sixteenth PIM controllers 260(0)-260(15), as described with reference to FIG. 9 or FIG. 13.

In another embodiment, when the first-level micro instruction has an operation type designated as “WRGB” and a broadcast bit having a binary value of “0,” the “(n−1)×j+i”-th sub-micro instruction sets generated by the multicast interconnect 730 are transmitted to the “i”-th PIM controller 740(i−1) via the “i”-th channel CH (i−1), where “n” is a natural number from 1 to “m.” Specifically, first, when “n”=1, the “i”-th sub-micro instruction set is transmitted to the “i”-th PIM controller 740(i−1) via the “i”-th channel CH (i−1). Next, when “n”=2, the “j+i”-th sub-micro instruction set is transmitted to the “i”-th PIM controller 740(i−1) via the “i”-th channel CH (i−1). Then, when “n”=3, the “2×j+i”-th sub-micro instruction set is transmitted to the “i”-th PIM controller 740(i−1) via the “i”-th channel CH (i−1). Finally, when “n”=“m,” the “(m−1)×j+i”-th sub-micro instruction set is transmitted to the “i”-th PIM controller 740(i−1) via the “i”-th channel CH (i−1). This process may be performed in the same manner as the process of transmitting the first to 512th sub-micro instruction sets as described with reference to FIG. 17 or FIG. 26.

In yet another embodiment, when the first-level micro instruction has an operation type designated as “WRBIAS” and a broadcast bit having a binary value of “0,” the “i”-th sub-micro instruction set generated by the multicast interconnect 730 is transmitted to the “i”-th PIM controller 740(i−1) via the “i”-th channel CH (i−1). This process may be performed in the same manner as the process of transmitting the first to sixteenth sub-micro instruction sets as described with reference to FIG. 30.

The first PIM controller 740(0) to the j-th PIM controller 740(j−1) may receive the sub-micro instruction sets from the multicast interconnect 730. Upon receiving a sub-micro instruction set, the first PIM controller 740(0) to the j-th PIM controller 740(j−1) generates and outputs a PIM command set based on the received sub-micro instruction set.

In one embodiment, when the first-level micro instruction corresponds to the first macro instruction in which the operation type is designated as “MAC,” upon reception of the “i”-th sub-micro instruction set from the multicast interconnect 730, the “i”-th PIM controller 740(i−1) generates the “i”-th PIM command set corresponding to the “i”-th sub-micro instruction set. This process may be performed in the same manner as the process of generating the first to sixteenth PIM command sets as described with reference to FIG. 10. The “i”-th PIM command set may include an active PIM command and first to “m”-th PIM commands. The active PIM command is a command, such as an “ACT” command, for activating a row specified by an operation type and a row address, and includes the row address. Each of the first to “m”-th PIM commands may include an operation type designated as “MAC” and a column address. The “i”-th PIM controller 740(i−1) transmits the “i”-th PIM command set to the “i”-th PIM device 110(i−1) via the “i”-th channel CH (i−1).

In another embodiment, when the first-level micro instruction corresponds to the second macro instruction or the third macro instruction, in which the operation type is designated as “WRGB” and the broadcast bit has a binary value of “1,” upon reception of the “i”-th sub-micro instruction set from the multicast interconnect 730, the “i”-th PIM controller 740(i−1) generates the “i”-th PIM command set corresponding to the “i”-th sub-micro instruction set. This process may be performed in the same manner as the process of generating the first to sixteenth PIM command sets as described with reference to FIG. 14 or FIG. 23. The “i”-th PIM command set may include first to “m”-th PIM commands. Each of the first to “m”-th PIM commands may include an operation type designated as “WRGB,” local memory data, and a column address. The “i”-th PIM controller 740(i−1) transmits the “i”-th PIM command set to the “i”-th PIM device 110(i−1) via the “i”-th channel CH (i−1).

In another embodiment, when the first-level micro instruction corresponds to the second macro instruction or the third macro instruction in which the operation type is designated as “WRGB” and the broadcast bit has a binary value of “0,” upon reception of the “(n−1)×j+i”-th sub-micro instruction set from the multicast interconnect 730, the “i”-th PIM controller 740(i−1) generates the “(n−1)×j+i”-th PIM command set corresponding to the “(n−1)×j+i”-th sub-micro instruction set. This process may be performed in the same manner as the process of generating the first to 512th PIM command sets as described with reference to FIG. 18 or FIG. 27. Each of the “(n−1)×j+i”-th PIM command sets may include an operation type designated as “WRGB,” local memory data, and a column address. The “i”-th PIM controller 740(i−1) transmits the “(n−1)×j+i”-th PIM command set to the “i”-th PIM device 110(i−1) via the “i”-th channel CH(i−1).

In another embodiment, when the first-level micro instruction corresponds to the fourth macro instruction in which the operation type is designated as “WRBIAS,” upon reception of the “i”-th sub-micro instruction set from the multicast interconnect 730, the “i”-th PIM controller 740(i−1) generates the “i”-th PIM command set corresponding to the “i”-th sub-micro instruction set. This process may be performed in the same manner as the process of generating the first to sixteenth PIM command sets as described with reference to FIG. 31. The “i”-th PIM command set may include an operation type designated as “WRBIAS,” local memory data, and a MAC latch ID. The “i”-th PIM controller 740(i−1) transmits the “i”-th PIM command set to the “i”-th PIM device 110(i−1) via the “i”-th channel CH (i−1).

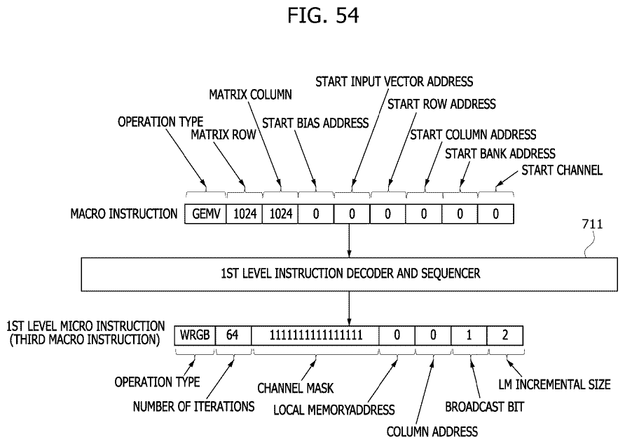

FIG. 54 is a diagram illustrating an example operation of a first-level instruction decoder and sequencer included in the PIM system of FIG. 53. In this example, it is assumed that the PIM system of FIG. 53 includes first to sixteenth channels.

Referring to FIG. 54, the macro instruction input to the first-level instruction decoder and sequencer 711 may include an operation type, a matrix row, a matrix column, a start bias address, a start input vector address, a start row address, a start column address, a start bank address, and a start channel. In the present example, the operation type of the macro instruction is designated as “GEMV,” and the matrix row and matrix column are respectively designated as “1024.” Further, the start bias address, the start input vector address, the start row address, the start column address, the start bank address, and the start channel are all designated as “0.”

The operation designated by the operation type “GEMV” is a General Matrix-Vector Product (GEMV) operation. In one embodiment, the GEMV operation may be used in the operation process of a MLP in deep learning. The GEMV operation performed in the PIM system 30 of FIG. 53 includes a “WRBIAS” operation, a “WRGB” operation, and a “MAC” operation. Through the WRBIAS operation, bias data are stored in the MAC latch circuits of the first to j-th PIM devices (110(0)-110(j−1)) included in the PIM system 30. Through the WRGB operation, vector data are stored in the global buffers of the first to j-th PIM devices (110(0)-110(j−1)) included in the PIM system 30. Through the MAC operation, MAC operations are performed between the weight data configuring the matrix and the vector data in the processing units of the first to j-th PIM devices (110(0)-110(j−1)) included in the PIM system 30.

The matrix row and matrix column included in the macro instruction respectively indicate the number of rows and the number of columns of the matrix used for the GEMV operation. The start bias address indicates the start address of the local memory where the bias data are stored. The start input vector address indicates the start address of the global buffer where the vector data are stored. The start row address, start column address, and start bank address respectively indicate the start row address, the start column address, and the start bank address of the memory bank where the weight data are stored. The start channel indicates the starting channel among the channels where the MAC operations are to be performed.

When a macro instruction having the operation type designated as “GEMV” is input, the first-level instruction decoder and sequencer 711 first generates and outputs a first-level micro instruction corresponding to the fourth macro instruction 540 of FIG. 28, which has the operation type designated as “WRBIAS.” Subsequently, the first-level instruction decoder and sequencer 711 generates and outputs a first-level micro instruction corresponding to the second macro instruction 520 of FIG. 11 or the third macro instruction 530 of FIG. 19, each having the operation type designated as “WRGB.” Finally, the first-level instruction decoder and sequencer 711 generates and outputs a first-level micro instruction corresponding to the first macro instruction 510 of FIG. 7, which has the operation type designated as “MAC.” As illustrated in FIG. 54, the first-level instruction decoder and sequencer 711 may output a first-level micro instruction corresponding to the third macro instruction 530 of FIG. 19, having the operation type designated as “WRGB.” In this case, as described with reference to FIG. 19, the first-level micro instruction may include the operation type designated as “WRGB,” the number of iterations, the channel mask, the local memory address, the column address, the broadcast bit, and the local memory incremental size.

Because the PIM system 30 includes the first to sixteenth channels, and the start channel included in the macro instruction is “0,” a single WRGB operation is simultaneously performed in the first to sixteenth PIM devices. Because the matrix column included in the macro instruction is “1024,” the WRGB operation for storing the vector data in the global buffer is performed 64 times in repetition. That is, in the first-level instruction decoder and sequencer 711, the number of iterations included in the first-level micro instruction is designated as “64,” and the channel mask is designated as “1111 1111 1111 1111.” Because the start input vector address included in the macro instruction is “0,” the local memory address included in the first-level micro instruction generated by the first-level instruction decoder and sequencer 711 is designated as “0.” Because the start column address included in the macro instruction is “0,” the column address included in the first-level micro instruction generated by the first-level instruction decoder and sequencer 711 is also designated as “0.” The first-level instruction decoder and sequencer 711 may designate the broadcast bit and the local memory incremental size as “1” and “2,” respectively. The processing procedure of the first-level micro instruction configured as described above may be performed in the same manner as the procedures described with reference to FIGS. 20 to 23.

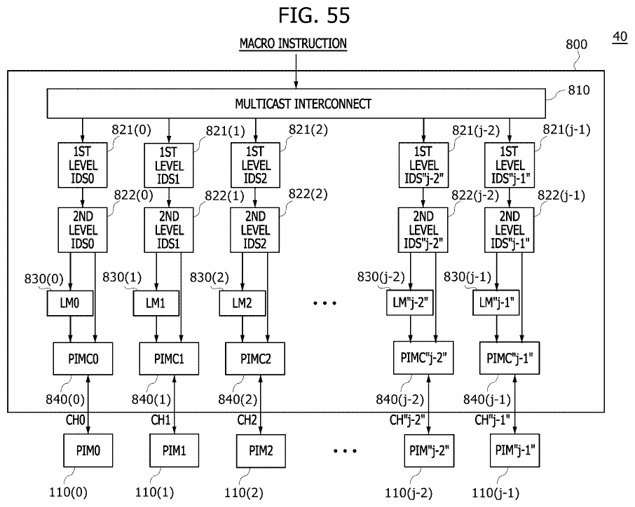

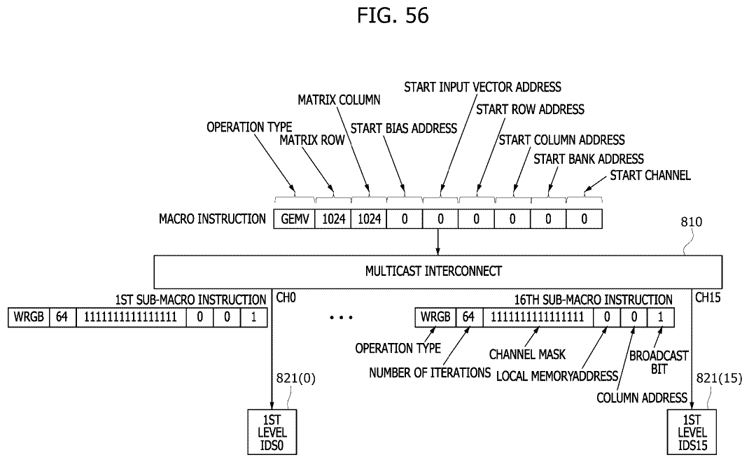

FIG. 55 is a block diagram illustrating another embodiment of the PIM system according to the present disclosure. And FIG. 56 is a diagram illustrating an example operation of a multicast interconnect included in the PIM system of FIG. 55.

Referring to FIG. 55, a PIM system 40 includes a plurality of PIM devices, for example, a first to a j-th PIM device 110(0)-110(j−1), and a PIM-centric system 800. The coupling structure between the first to the j-th PIM devices 110(0)-110(j−1) and the PIM-centric system 800 may be identical to the coupling structure between the first to the j-th PIM devices PIM0-PIM“j−1” 110(0)-110(j−1) and the PIM-centric system 600 described with reference to FIG. 32. The PIM-centric system 800 controls operations of the first to the j-th PIM devices 110(0)-110(j−1). The PIM-centric system 800 may be coupled to a host or a PIM-centric system included in another PIM system. The PIM-centric system 800 may receive a macro instruction from the host. In one embodiment, the PIM-centric system 800 may include a multicast interconnect 810, first-level instruction decoders and sequencers 821(0)-821(j−1), second-level instruction decoders and sequencers 822(0)-822(j−1), local memories 830(0)-830(j−1), and PIM controllers 840(0)-840(j−1).

The PIM-centric system 800 of the PIM system 40 according to this embodiment may be configured identically to the PIM-centric system 600 of the PIM system 20 described with reference to FIG. 32, except for some components. One of the differences is that the multicast interconnect 610 included in the PIM-centric system 600 of the PIM system 20 described with reference to FIG. 32 receives a macro instruction and outputs one or more sub-macro instructions, whereas the multicast interconnect 810 included in the PIM-centric system 800 of the PIM system 40 according to this embodiment receives a macro instruction and outputs one or more first-level micro instructions. Another difference is that while the PIM-centric system 600 of the PIM system 20 described with reference to FIG. 32 includes first to j-th instruction decoders and sequencers 821(0)-821(j−1), the PIM-centric system 800 of the PIM system 40 according to this embodiment includes first to j-th first-level instruction decoders and sequencers 821(0)-821(j−1) and first to j-th second-level instruction decoders and sequencers 822(0)-822(j−1). Hereinafter, redundant descriptions will be omitted, and only the differences from the PIM system 20 described with reference to FIG. 32 will be explained.

Referring to FIG. 56, the multicast interconnect 810 receives a macro instruction. The macro instruction input to the multicast interconnect 810 may be a higher-level macro instruction than the first macro instruction described with reference to FIG. 7, the second macro instruction described with reference to FIG. 11, the third macro instruction described with reference to FIG. 19, and the fourth macro instruction described with reference to FIG. 28. As illustrated in FIG. 56, the macro instruction input to the multicast interconnect 810 may include an operation type designated as “GEMV,” a matrix row and a matrix column each designated as “1024,” and a start bias address, a start input vector address, a start row address, a start column address, a start bank address, and a start channel, each designated as “0.” The description of the macro instruction with reference to FIG. 54 may equally apply to the macro instruction input to the multicast interconnect 810 in the present embodiment.

Taking an example where the number of channels (i.e., “j”) is 16, the multicast interconnect 810 generates and outputs one or more sub-macro instructions based on the macro instruction including the operation type designated as “GEMV.” The number of sub-macro instructions generated by the multicast interconnect 810 may be determined based on the matrix row, the matrix column, the start bank address, and the start channel included in the macro instruction. In the present embodiment, where the matrix row and the matrix column are each designated as “1024,” and the start bank address and the start channel are each designated as “0,” the multicast interconnect 810 generates and outputs a first to a sixteenth sub-macro instruction. In this case, the multicast interconnect 810 transmits the first to the sixteenth sub-macro instructions respectively to the first to the sixteenth first-level instruction decoders and sequencers 821(0)-821(15) through the first to the sixteenth channels CH0-CH15. The first to the sixteenth sub-macro instructions output from the multicast interconnect 810 may be configured similarly to the first macro instruction described with reference to FIG. 7, the second macro instruction described with reference to FIG. 11, the third macro instruction described with reference to FIG. 19, or the fourth macro instruction described with reference to FIG. 28. In the example illustrated in FIG. 56, the first to the sixteenth sub-macro instructions output from the multicast interconnect 810 may include an operation type designated as “WRGB,” a number of iterations designated as “64,” a channel mask designated as “1111 1111 1111 1111,” a local memory address and a column address each designated as “0,” and a broadcast bit designated as “1.”

Referring again to FIG. 55, each of the first to j-th first-level instruction decoders and sequencers 821(0)-821(j−1) generates and outputs a first-level micro instruction based on the sub-macro instruction transmitted from the multicast interconnect 810. Specifically, when the i-th sub-macro instruction (“i” being a natural number from 1 to j) is transmitted from the multicast interconnect 810, the i-th first-level instruction decoder and sequencer 821(i−1) generates and outputs the i-th first-level micro instruction based on the i-th sub-macro instruction. In one embodiment, the i-th first-level micro instruction may be identical to the i-th sub-macro instruction, except that the channel mask is omitted. The i-th first-level instruction decoder and sequencer 821(i−1) transmits the i-th first-level micro instruction to the i-th second-level instruction decoder and sequencer 822(i−1).

In one embodiment, when the i-th first-level micro instruction corresponds to the first macro instruction described with reference to FIG. 7, the i-th first-level micro instruction output from the i-th first-level instruction decoder and sequencer 821(i−1) may be configured identically to the sub-macro instruction output from the multicast interconnect 610 described with reference to FIG. 33. When the i-th first-level micro instruction corresponds to the second macro instruction described with reference to FIG. 11, the i-th first-level micro instruction output from the i-th first-level instruction decoder and sequencer 821(i−1) may be configured identically to the sub-macro instruction output from the multicast interconnect 610 described with reference to FIG. 36 or FIG. 40. When the i-th first-level micro instruction corresponds to the third macro instruction described with reference to FIG. 19, the i-th first-level micro instruction output from the i-th first-level instruction decoder and sequencer 821(i−1) may be configured identically to the sub-macro instruction output from the multicast interconnect 610 described with reference to FIG. 43 or FIG. 45. When the i-th first-level micro instruction corresponds to the fourth macro instruction described with reference to FIG. 28, the i-th first-level micro instruction output from the i-th first-level instruction decoder and sequencer 821(i−1) may be configured identically to the sub-macro instruction output from the multicast interconnect 610 described with reference to FIG. 48.

The first to j-th second-level instruction decoders and sequencers 822(0)-822(j−1) are capable of receiving the first to j-th first-level micro instructions from the first to j-th first-level instruction decoders and sequencers 821(0)-821(j−1), respectively. Specifically, among the first to j-th second-level instruction decoders and sequencers 822(0)-822(j−1), the i-th second-level instruction decoder and sequencer 822(i−1) may receive the i-th first-level micro instruction from the i-th first-level instruction decoder and sequencer 821(i−1) among the first to j-th first-level instruction decoders and sequencers 821(0)-821(j−1). In one embodiment, the i-th second-level instruction decoder and sequencer 822(i−1) may generate and output the i-th second-level micro instruction set based on the i-th first-level micro instruction. In another embodiment, the i-th second-level instruction decoder and sequencer 822(i−1) may generate and output the i-th local memory instruction set and the i-th second-level micro instruction set based on the i-th first-level micro instruction.

More specifically, in one embodiment, when the i-th first-level micro instruction having an operation type designated as “MAC” is input, the i-th second-level instruction decoder and sequencer 822(i−1) generates and outputs the i-th second-level micro instruction set. This process may be identical to the output operations of the first to sixteenth micro instruction sets from the first to sixteenth instruction decoders and sequencers 620(0)-620(15) described with reference to FIG. 34. That is, similar to the first to sixteenth micro instruction sets described with reference to FIG. 34, the i-th second-level micro instruction set output from the i-th second-level instruction decoder and sequencer 822(i−1) includes the first to m-th micro instructions. Each of the first to m-th micro instructions may include an operation type designated as “MAC,” a row address, and a column address. The operation types and row addresses included in the first to m-th micro instructions may be identical to the operation type and row address included in the i-th first-level micro instruction, respectively. The column addresses included in the first to m-th micro instructions may sequentially increase starting from the start column address included in the i-th first-level micro instruction. The i-th second-level instruction decoder and sequencer 822(i−1) transmits the i-th second-level micro instruction set to the i-th PIM controller 840(i−1) among the first to j-th PIM controllers 840(0)-840(j−1).

In one embodiment, when the i-th first-level micro instruction has an operation type designated as “WRGB” and a broadcast bit designated as “1,” the i-th second-level instruction decoder and sequencer 822(i−1) generates and outputs the i-th local memory instruction set and the i-th second-level micro instruction set. This process may be identical to the output operations of the first to sixteenth local memory instruction sets and the first to sixteenth micro instruction sets from the first to sixteenth instruction decoders and sequencers 620(0)-620(15) described with reference to FIGS. 37 and 44. That is, similar to the first to sixteenth local memory instruction sets described with reference to FIGS. 37 and 44, the i-th local memory instruction set output from the i-th second-level instruction decoder and sequencer 822(i−1) includes the first to m-th local memory instructions. Also, similar to the first to sixteenth micro instruction sets described with reference to FIGS. 37 and 44, the i-th second-level micro instruction set output from the i-th second-level instruction decoder and sequencer 822(i−1) includes the first to m-th micro instructions.

Each of the first to m-th local memory instructions may include a local memory command and a local memory address. The local memory command may be designated as “RD_LM,” which instructs a read operation for the i-th local memory 830(i−1). The local memory addresses may sequentially increase starting from the local memory address included in the i-th first-level micro instruction. Each of the first to m-th micro instructions may include an operation type designated as “WRGB” and a column address. The column addresses included in the first to m-th micro instructions may sequentially increase starting from the start column address included in the i-th first-level micro instruction. The i-th second-level instruction decoder and sequencer 822(i−1) transmits the i-th local memory instruction set to the i-th local memory 830(i−1) and transmits the i-th second-level micro instruction set to the i-th PIM controller 840(i−1).

In one embodiment, when the i-th first-level micro instruction has an operation type designated as “WRGB” and a broadcast bit designated as “0,” the i-th second-level instruction decoder and sequencer 822(i−1) generates and outputs the “(n−1)×j+i”-th local memory instruction sets and the “(n−1)×j+i”-th second-level micro instruction sets, where “n” is a natural number from 1 to m. This process may be identical to the output operations of the first to thirty-second local memory instructions and the first to thirty-second micro instructions from the first to sixteenth instruction decoders and sequencers 620(0)-620(15) described with reference to FIGS. 41 and 48. Specifically, each of the “(n−1)×j+i”-th local memory instructions output from the i-th second-level instruction decoder and sequencer 822(i−1) may include a local memory command and a local memory address. The local memory command may be designated as “RD_LM,” which instructs a read operation for the i-th local memory 830(i−1). The local memory addresses may sequentially increase starting from the local memory address included in the i-th first-level micro instruction. Each of the “(n−1)×j+i”-th second-level micro instructions output from the i-th second-level instruction decoder and sequencer 822(i−1) may include an operation type designated as “WRGB” and a column address. The column addresses included in the “(n−1)×j+i”-th second-level micro instructions may sequentially increase starting from the start column address included in the i-th first-level micro instruction or may increment according to a unit size specified by the local memory increment size. The i-th second-level instruction decoder and sequencer 822(i−1) transmits the “(n−1)×j+i”-th local memory instructions to the i-th local memory 830(i−1), and transmits the “(n−1)×j+i”-th second-level micro instructions to the i-th PIM controller 840(i−1).

In one embodiment, when the i-th first-level micro instruction has an operation type designated as “WRBIAS” and a broadcast bit designated as “1,” the i-th second-level instruction decoder and sequencer 822(i−1) generates and outputs the i-th local memory instruction and the i-th second-level micro instruction. This process may be identical to the output operations of the first to sixteenth local memory instructions and the first to sixteenth micro instructions from the first to sixteenth instruction decoders and sequencers 620(0)-620(15) described with reference to FIG. 51. Specifically, in the same manner as the first to sixteenth local memory instructions described with reference to FIG. 51, the i-th local memory instruction output from the i-th second-level instruction decoder and sequencer 822(i−1) may include a local memory command and a local memory address. The local memory command may be designated as “RD_LM,” instructing a read operation on the i-th local memory 830(i−1). The local memory address may sequentially increase starting from the local memory address included in the i-th first-level micro instruction. In addition, similar to the first to sixteenth micro instructions described with reference to FIG. 51, the i-th second-level micro instruction output from the i-th second-level instruction decoder and sequencer 822(i−1) may include an operation type designated as “WRBIAS” and a MAC latch ID. The MAC latch ID may be identical to the MAC latch ID included in the i-th first-level micro instruction. The i-th second-level instruction decoder and sequencer 822(i−1) transmits the i-th local memory instruction set to the i-th local memory 830(i−1), and transmits the i-th second-level micro instruction set to the i-th PIM controller 840(i−1).

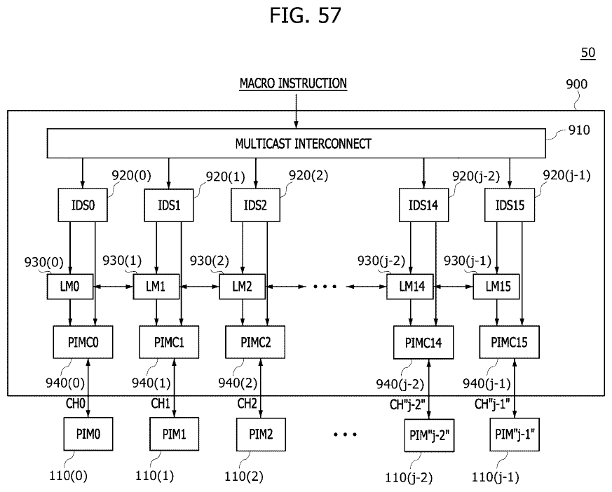

FIG. 57 is a block diagram illustrating still another embodiment of the PIM system according to the present disclosure.

Referring to FIG. 57, a PIM system 50 includes a plurality of PIM devices, for example, a first to a j-th PIM devices 110(0)-110(j−1), and a PIM-centric system 900. The coupling structure between the first to j-th PIM devices 110(0)-110(j−1) and the PIM-centric system 900 may be identical to the coupling structure between the first to j-th PIM devices (PIM0-PIM“j−1”) 110(0)-110(j−1) and the PIM-centric system 600, as described with reference to FIG. 32. The PIM-centric system 900 controls the operations of the first to j-th PIM devices 110(0)-110(j−1). The PIM-centric system 900 may be coupled to a host or to another PIM-centric system included in a different PIM system. The PIM-centric system 900 may receive macro instructions from the host. In one embodiment, the PIM-centric system 900 may include a multicast interconnect 910, first to j-th instruction decoders and sequencers 920(0)-920(j−1), first to j-th local memories 930(0)-930(j−1), and first to j-th PIM controllers 940(0)-940(j−1).

The multicast interconnect 910, the first to j-th instruction decoders and sequencers 920(0)-920(j−1), and the first to j-th PIM controllers 940(0)-940(j−1) included in the PIM-centric system 900 of the PIM system 50 according to this embodiment may be identical to the multicast interconnect 610, the first to j-th instruction decoders and sequencers 620(0)-620(j−1), and the first to j-th PIM controllers 640(0)-640(j−1) included in the PIM-centric system 600 of the PIM system 20 described with reference to FIG. 32. Accordingly, redundant descriptions will be omitted below.

In the PIM system 50 according to the present embodiment, the first to j-th local memories 930(0)-930(j−1) included in the PIM-centric system 900 are configured to perform data transmission and reception with adjacent local memories. As illustrated in FIG. 57, the first local memory 930(0) may transmit data to the second local memory 930(1) and may also receive data from the second local memory 930(1). The second local memory 930(1) may transmit data to the first local memory 930(0) and the third local memory 930(2), and may also receive data from the first local memory 930(0) and the third local memory 930(2). The third local memory 930(2) may transmit data to the second local memory 930(1) and a fourth local memory (not shown), and may also receive data from the second local memory 930(1) and the fourth local memory. The (j−1)th local memory 930(j−2) may transmit data to the (j−2)th local memory (not shown) and the jth local memory 930(j−1), and may also receive data from the (j−2)th local memory and the jth local memory 930(j−1). The jth local memory 930(j−1) may transmit data to the (j−1)th local memory 930(j−2) and may also receive data from the (j−1)th local memory 930(j−2). Although not explicitly illustrated in the drawing, data transmission may also be performed between the first local memory 930(0) and the jth local memory 930(j−1).

According to the PIM system 50 of the present embodiment, information indicating data transmission among the first to j-th local memories 930(0)-930(j−1) may be included in the macro instruction. In one embodiment, the macro instruction may include a source channel designating a source local memory having data to be transmitted, a destination channel designating a destination local memory where the data is ultimately received, a source address designating an address of the source local memory, a destination address designating an address of the destination local memory, and an operation size designating the size of the data to be transmitted. In one embodiment, the PIM system 50 according to the present example may perform collective communication operations such as gather operations and reduce operations through data transmission among the first to j-th local memories 930(0)-930(j−1).

A limited number of possible embodiments for the present teachings have been presented above for illustrative purposes. Those of ordinary skill in the art will appreciate that various modifications, additions, and substitutions are possible. While this patent document contains many specifics, these should not be construed as limitations on the scope of the present teachings or of what may be claimed, but rather as descriptions of features that may be specific to particular embodiments. Certain features that are described in this patent document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

What is claimed is:

1. A processing-in-memory (PIM) system comprising:
a plurality of PIM devices; and
a PIM-centric system configured to control the plurality of PIM devices,
wherein the PIM-centric system comprises:
an instruction decoder and sequencer configured to receive a macro instruction and generate and output a plurality of micro instructions based on the macro instruction;
a multicast interconnect configured to output one or more sub-micro instruction sets based on the plurality of micro instructions; and
a plurality of PIM controllers each coupled to the plurality of PIM devices via a plurality of channels, the plurality of PIM controllers configured to generate and output one or more PIM command sets based on the one or more sub-micro instruction sets.

2. The PIM system of claim 1,
wherein each of the plurality of PIM devices comprises:
a plurality of memory banks configured to store weight data used as a first operand for a general matrix-vector multiplication (GEMV) operation;
a global buffer configured to store vector data used as a second operand for the GEMV operation; and
a plurality of processing elements configured to perform multiply-accumulate (MAC) operations on the weight data and the vector data.

3. The PIM system of claim 2,
wherein each of the plurality of processing elements comprises:
a multiplication circuit configured to perform a multiplication operation on the weight data and the vector data to output multiplication data;
an addition circuit configured to perform an addition operation on the multiplication data output from the multiplication circuit to output addition data; and
an accumulator configured to perform an accumulation operation on the addition data and latch data.

4. The PIM system of claim 3,
wherein the accumulator comprises:
an accumulation adder configured to perform an accumulation operation on the addition data and the latch data to output accumulation data; and
a MAC latch circuit configured to latch the accumulation data output from the accumulation adder.

5. The PIM system of claim 1,
wherein the plurality of channels comprises first to j-th channels, where “j” is a natural number of 2 or greater;
wherein the plurality of PIM devices comprises first to j-th PIM devices;
wherein the plurality of PIM controllers comprises first to j-th PIM controllers;
wherein the multicast interconnect is coupled to the first to j-th PIM controllers through the first to j-th channels, respectively; and
wherein the first to j-th PIM controllers are coupled to the first to j-th PIM devices through the first to j-th channels, respectively.

6. The PIM system of claim 5,
wherein the macro instruction is a first macro instruction, a second macro instruction, a third macro instruction, or a fourth macro instruction,
wherein the first macro instruction includes a first operation type designating execution of a MAC operation in the plurality of PIM devices,
wherein the second macro instruction and the third macro instruction include a second operation type designating a global buffer write operation to store vector data into global buffers of the plurality of PIM devices, and
wherein the fourth macro instruction includes a third operation type designating a bias data write operation to store bias data into latch circuits of the plurality of PIM devices.

7. The PIM system of claim 6,
wherein the first macro instruction further includes a number of iterations, a channel mask, a row address, and a column address,
wherein the number of iterations included in the first macro instruction is set to a number “m” (where “m” is a natural number of 2 or greater) indicating the number of times the MAC operation is performed,
wherein the channel mask included in the first macro instruction includes first to j-th bits corresponding to first to j-th channels,
wherein the row address included in the first macro instruction designates a row of a memory bank in which the weight data used for the MAC operation is stored, and
wherein the column address included in the first macro instruction designates a column of the memory bank in which the weight data is stored.

8. The PIM system of claim 7,
wherein when the first macro instruction is transmitted, the instruction decoder and sequencer is configured to output first to m-th micro instructions,
wherein each of the first to m-th micro instructions includes an operation type, a channel mask, a row address, and a column address.

9. The PIM system of claim 8,
wherein the operation type included in each of the first to m-th micro instructions is the first operation type,
wherein the channel mask and the row address included in each of the first to m-th micro instructions are respectively identical to the channel mask and the row address included in the first macro instruction, and
wherein the column address included in each of the first to m-th micro instructions is sequentially increased starting from a starting column address included in the first macro instruction.

10. The PIM system of claim 9,
wherein the first to m-th micro instructions respectively include first to m-th channel masks,
wherein each of the first to m-th channel masks includes first to j-th bits, and
wherein the first to j-th bits included in each of the first to m-th channel masks are identical to the first to j-th bits of the channel mask included in the first macro instruction.

11. The PIM system of claim 10,
wherein the number of the one or more sub-micro instruction sets output from the multicast interconnect is determined based on the first to j-th bits included in each of the first to m-th channel masks.

12. The PIM system of claim 10,
wherein, when an i-th bit (where “i” is a natural number from 1 to j) among the first to j-th bits included in each of the first to m-th channel masks has a first binary value, the multicast interconnect is configured to generate an i-th sub-micro instruction set, and
wherein, when the i-th bit among the first to j-th bits included in each of the first to m-th channel masks has a second binary value, the multicast interconnect is configured not to generate the i-th sub-micro instruction set.

13. The PIM system of claim 12,
wherein the i-th sub-micro instruction set includes first to m-th sub-micro instructions,
wherein each of the first to m-th sub-micro instructions includes an operation type, a row address, and a column address.

14. The PIM system of claim 13,
wherein the operation type included in each of the first to m-th sub-micro instructions is designated as the first operation type,
wherein the row addresses included in the first to m-th sub-micro instructions are identical to the row addresses included in the first to m-th micro instructions, and
wherein the column addresses included in the first to m-th sub-micro instructions are identical to the column addresses included in the first to m-th micro instructions.

15. The PIM system of claim 13,
wherein the multicast interconnect is configured to sequentially transmit the first to m-th sub-micro instructions included in the i-th sub-micro instruction set to an i-th PIM controller among the first to j-th PIM controllers through an i-th channel among the first to j-th channels.

16. The PIM system of claim 15,
wherein the i-th PIM controller generates an i-th PIM command set based on the first to m-th sub-micro instructions included in the i-th sub-micro instruction set,
wherein the i-th PIM command set includes an active PIM command and first to m-th PIM commands.

17. The PIM system of claim 16,
wherein the i-th PIM controller transmits the i-th PIM command set to an i-th PIM device among the first to j-th PIM devices through the i-th channel.

18. The PIM system of claim 16,
wherein the active PIM command includes an active command and a row address, and
wherein each of the first to m-th PIM commands includes an operation type and a column address,
wherein the active command included in the active PIM command is designated as a command for activating a row of a memory bank indicated by the row address included in the active PIM command,
wherein the row address included in the active PIM command is identical to the row addresses included in the first to m-th sub-micro instructions of the i-th sub-micro instruction set,
wherein the operation type included in each of the first to m-th PIM commands is designated as the first operation type, and
wherein the column addresses included in the first to m-th PIM commands are identical to the column addresses included in the first to m-th sub-micro instructions included in the i-th sub-micro instruction set.

19. The PIM system of claim 6, further comprising a local memory coupled to the instruction decoder and sequencer and the multicast interconnect.

20. The PIM system of claim 19,
wherein the second macro instruction further includes a number of iterations, a channel mask, a local memory address, a column address, and a broadcast bit,
wherein the number of iterations included in the second macro instruction is set to a number “m” (where “m” is a natural number of 2 or more) indicating the number of times the global buffer write operation is performed,
wherein the channel mask included in the second macro instruction includes first to j-th bits corresponding respectively to the first to j-th channels,
wherein the local memory address included in the second macro instruction designates a storage location accessed in the local memory,
wherein the column address included in the second macro instruction designates a storage location in the global buffers where the vector data is stored, and
wherein the broadcast bit included in the second macro instruction is set to a first binary value for indicating a broadcasting operation or a second binary value for indicating a non-broadcasting operation.

21. The PIM system of claim 20,
wherein when the second macro instruction is transmitted and the broadcast bit included in the second macro instruction has the first binary value, the instruction decoder and sequencer is configured to output first to m-th local memory instructions and first to m-th micro instructions,
wherein each of the first to m-th local memory instructions includes a local memory command and a local memory address, and
wherein each of the first to m-th micro instructions includes an operation type, a channel mask, a column address, and a broadcast bit.

22. The PIM system of claim 21,
wherein the local memory command included in each of the first to m-th local memory instructions is a read command for the local memory,
wherein the local memory addresses included in each of the first to m-th local memory instructions sequentially increase starting from the local memory address included in the second macro instruction,
wherein the operation type included in each of the first to m-th micro instructions is the second operation type,
wherein the channel mask and the broadcast bit included in each of the first to m-th micro instructions are respectively identical to the channel mask and the broadcast bit included in the second macro instruction, and
wherein the column addresses included in each of the first to m-th micro instructions sequentially increase starting from the column address included in the second macro instruction.

23. The PIM system of claim 22,
wherein the first to m-th micro instructions each include first to j-th channel masks,
wherein each of the first to m-th channel masks includes first to j-th bits, and
wherein the first to j-th bits included in each of the first to m-th channel masks have the same binary values as the first to j-th bits included in the channel mask of the second macro instruction.

24. The PIM system of claim 23,
wherein the local memory outputs data stored at storage locations designated by the local memory addresses included in the first to m-th local memory instructions as first to m-th local memory data and transmits the first to m-th local memory data to the multicast interconnect.

25. The PIM system of claim 24,
wherein the multicast interconnect generates and outputs one or more sub-micro instruction sets based on the first to m-th micro instructions and the first to m-th local memory data,
wherein the number of the one or more sub-micro instruction sets output from the multicast interconnect is determined by the first to j-th bits included in each of the first to m-th channel masks.

26. The PIM system of claim 25,
wherein when an i-th bit (where i is a natural number from 1 to j) among the first to j-th bits included in each of the first to m-th channel masks has a first binary value, the multicast interconnect is configured to generate an i-th sub-micro instruction set, and
wherein when the i-th bit among the first to j-th bits included in each of the first to m-th channel masks has a second binary value, the multicast interconnect is configured not to generate the i-th sub-micro instruction set.

27. The PIM system of claim 26,
wherein the i-th sub-micro instruction set includes first to m-th sub-micro instructions,
wherein each of the first to m-th sub-micro instructions includes an operation type, local memory data, and a column address.

28. The PIM system of claim 27,
wherein the operation types included in each of the first to m-th sub-micro instructions are designated as the second operation type,
wherein the local memory data included in each of the first to m-th sub-micro instructions is identical to the corresponding one of the first to m-th local memory data, and
wherein the column addresses included in each of the first to m-th sub-micro instructions are identical to the corresponding column addresses included in the first to m-th micro instructions.

29. The PIM system of claim 26,
wherein the multicast interconnect sequentially transmits the first to m-th sub-micro instructions included in the i-th sub-micro instruction set to an i-th PIM controller among the first to j-th PIM controllers via an i-th channel among the first to j-th channels.

30. The PIM system of claim 29,
wherein the i-th PIM controller generates an i-th PIM command set based on the first to m-th sub-micro instructions included in the i-th sub-micro instruction set,
wherein the i-th PIM command set includes first to m-th PIM commands, and
wherein the i-th PIM controller transmits the i-th PIM command set to an i-th PIM device among the first to j-th PIM devices via the i-th channel.

31. The PIM system of claim 30,
wherein each of the first to m-th PIM commands includes an operation type, local memory data, and a column address,
wherein the operation types included in each of the first to m-th PIM commands are designated as the second operation type,
wherein the local memory data included in each of the first to m-th PIM commands is identical to the local memory data included in the first to m-th sub-micro instructions of the i-th sub-micro instruction set, and
wherein the column addresses included in each of the first to m-th PIM commands are identical to the column addresses included in the first to m-th sub-micro instructions of the i-th sub-micro instruction set.

32. The PIM system of claim 20,
wherein when the second macro instruction is transmitted, and t bits among the bits of the channel mask included in the second macro instruction have the first binary value and the broadcast bit included in the second macro instruction has the second binary value, the instruction decoder and sequencer is configured to output m×t local memory instructions and m×t micro instructions,
wherein each of the m×t local memory instructions includes a local memory command and a local memory address, and
wherein each of the m×t micro instructions includes an operation type, a channel mask, a column address, and a broadcast bit.

33. The PIM system of claim 32,
wherein the local memory command included in each of the m×t local memory instructions is a read command for the local memory,
wherein the local memory addresses included in the m×t local memory instructions sequentially increase starting from the local memory address included in the second macro instruction,
wherein the operation type included in each of the m×t micro instructions is designated as the second operation type,
wherein the column addresses included in the m×t micro instructions sequentially increase starting from the column address included in the second macro instruction, and
wherein the broadcast bit included in each of the m×t micro instructions is identical to the broadcast bit included in the second macro instruction.

34. The PIM system of claim 33,
wherein the m×t micro instructions include m×t channel masks,
wherein the m×t channel masks are divided into first to m-th groups,
wherein each of the first to m-th groups includes t channel masks, each having first to j-th bits.

35. The PIM system of claim 34,
wherein among the t channel masks included in each of the first to m-th groups, each i-th (where i is a natural number from 1 to j) channel mask is configured with an identical binary stream.

36. The PIM system of claim 35,
wherein among the first to j-th bits included in the i-th channel mask of each of the first to m-th groups, the i-th bit, which is the channel bit, has the first binary value, and remaining bits except for the channel bit are all set to the second binary value.

37. The PIM system of claim 36,
wherein the local memory outputs the data stored at storage locations designated by the local memory addresses included in the m×t local memory instructions as m×t local memory data and transmits the m×t local memory data to the multicast interconnect.

38. The PIM system of claim 37,
wherein the multicast interconnect generates the one or more sub-micro instruction sets based on the m×t local memory data and the m×t micro instructions,
wherein the number of the one or more sub-micro instruction sets generated by the multicast interconnect is identical to the number of the m×t micro instructions.

39. The PIM system of claim 38,
wherein when the m×t micro instructions and the m×t local memory data are transmitted, the multicast interconnect is configured to generate m×t sub-micro instruction sets,
wherein the m×t sub-micro instruction sets include “(n−1)×j+i”-th sub-micro instruction sets (where n is a natural number from 1 to m).

40. The PIM system of claim 39,
wherein each of the “(n−1)×j+i”-th sub-micro instruction sets includes an operation type, local memory data, and a column address.

41. The PIM system of claim 40,
wherein the operation type included in each of the “(n−1)×j+i”-th sub-micro instruction sets is designated as the second operation type,
the local memory data included in the “(n−1)×j+i”-th sub-micro instruction sets is identical to the “(n−1)×j+i”-th local memory data among the first to m-th local memory data, and
the column addresses included in the “(n−1)×j+i”-th sub-micro instruction sets are identical to the column addresses included in the “(n−1)×j+i”-th micro instructions among the first to m-th micro instructions.

42. The PIM system of claim 39,
wherein the multicast interconnect is configured to transmit the “(n−1)×j+i”-th sub-micro instruction sets to the i-th PIM controller among the first to j-th PIM controllers via the i-th channel among the first to j-th channels.

43. The PIM system of claim 42,
wherein the i-th PIM controller generates the “(n−1)×j+i”-th PIM command sets based on the “(n−1)×j+i”-th sub-micro instruction sets, and transmits the “(n−1)×j+i”-th PIM command sets to the i-th PIM device among the first to j-th PIM devices via the i-th channel.

44. The PIM system of claim 42,
wherein each of the “(n−1)×j+i”-th PIM command sets includes an operation type, local memory data, and a column address,
wherein the operation types included in each of the “(n−1)×j+i”-th PIM command sets are designated as the second operation type,
wherein the local memory data included in the “(n−1)×j+i”-th PIM command sets is identical to the local memory data included in the “(n−1)×j+i”-th sub-micro instruction sets, and
wherein the column addresses included in the “(n−1)×j+i”-th PIM command sets are identical to the column addresses included in the “(n−1)×j+i”-th sub-micro instruction sets.

45. The PIM system of claim 19,
wherein the third macro instruction further includes a number of iterations, a channel mask, a local memory address, a column address, a broadcast bit, and a local memory incremental size,
wherein the operation number of iterations included in the third macro instruction is designated as “m” (where m is a natural number of 2 or greater) indicating the number of times the global buffer write operation is performed,
wherein the channel mask included in the third macro instruction includes the first to j-th bits corresponding to the first to j-th channels,
wherein the local memory address included in the third macro instruction designates a storage location for data access in the local memory,
the column address included in the third macro instruction designates a storage location where the vector data is stored in the global buffers,
the broadcast bit included in the third macro instruction is set to a first binary value indicating a broadcasting operation or a second binary value indicating a non-broadcasting operation, and
the local memory incremental size included in the third macro instruction designates the size by which the local memory address increases.

46. The PIM system of claim 45,
wherein when the third macro instruction is transmitted and the broadcast bit included in the third macro instruction has the first binary value, the instruction decoder and sequencer is configured to output first to m-th local memory instructions and first to m-th micro instructions,
wherein each of the first to m-th local memory instructions includes a local memory command and a local memory address, and
wherein each of the first to m-th micro instructions includes an operation type, a channel mask, a column address, and a broadcast bit.

47. The PIM system of claim 46,
wherein the local memory command included in each of the first to m-th local memory instructions is a read command for the local memory,
wherein the local memory addresses included in the first to m-th local memory instructions sequentially increase from the local memory address included in the third macro instruction by the size indicated by the local memory incremental size,
wherein the operation type included in each of the first to m-th micro instructions is designated as the second operation type,
wherein the channel mask and the broadcast bit included in each of the first to m-th micro instructions are identical to the channel mask and the broadcast bit included in the third macro instruction, respectively, and
wherein the column addresses included in the first to m-th micro instructions sequentially increase from the column address included in the third macro instruction.

48. The PIM system of claim 47,
wherein the first to m-th micro instructions respectively include first to m-th channel masks,
wherein each of the first to m-th channel masks includes first to j-th bits, and
wherein the first to j-th bits included in each of the first to m-th channel masks are identical to the first to j-th bits of the channel mask included in the third macro instruction.

49. The PIM system of claim 48,
wherein the local memory outputs the data stored at the locations designated by the local memory addresses included in the first to m-th local memory instructions as first to m-th local memory data and transmits the first to m-th local memory data to the multicast interconnect.

50. The PIM system of claim 49,
wherein the multicast interconnect generates and outputs one or more sub-micro instruction sets based on the first to m-th micro instructions and the first to m-th local memory data,
wherein the number of the one or more sub-micro instruction sets output from the multicast interconnect is determined by the first to j-th bits included in each of the first to m-th channel masks.

51. The PIM system of claim 50,
wherein when the i-th bit (where i is a natural number from 1 to j) among the first to j-th bits included in each of the first to m-th channel masks has the first binary value, the multicast interconnect is configured to generate the i-th sub-micro instruction set, and
wherein when the i-th bit among the first to j-th bits included in each of the first to m-th channel masks has the second binary value, the multicast interconnect is configured not to generate the i-th sub-micro instruction set.

52. The PIM system of claim 51,
wherein the i-th sub-micro instruction set includes first to m-th sub-micro instructions,
wherein each of the first to m-th sub-micro instructions includes an operation type, local memory data, and a column address.

53. The PIM system of claim 52,
wherein the operation types included in each of the first to m-th sub-micro instructions are designated as the second operation type,
wherein the local memory data included in each of the first to m-th sub-micro instructions is identical to the corresponding local memory data among the first to m-th local memory data, and
wherein the column addresses included in each of the first to m-th sub-micro instructions are identical to the corresponding column addresses included in the first to m-th micro instructions.

54. The PIM system of claim 51,
wherein the multicast interconnect sequentially transmits the first to m-th sub-micro instructions included in the i-th sub-micro instruction set to the i-th PIM controller among the first to j-th PIM controllers through the i-th channel among the first to j-th channels.

55. The PIM system of claim 54,
wherein the i-th PIM controller generates an i-th PIM command set based on the first to m-th sub-micro instructions included in the i-th sub-micro instruction set,
wherein the i-th PIM command set includes first to m-th PIM commands.

56. The PIM system of claim 55,
wherein the i-th PIM controller transmits the i-th PIM command set to the i-th PIM device among the first to j-th PIM devices through the i-th channel.

57. The PIM system of claim 56,
wherein each of the first to m-th PIM commands includes an operation type, local memory data, and a column address,
wherein the operation types included in the first to m-th PIM commands are designated as the second operation type,
wherein the local memory data included in the first to m-th PIM commands is identical to the local memory data included in the first to m-th sub-micro instructions of the i-th sub-micro instruction set, and
wherein the column addresses included in the first to m-th PIM commands are identical to the column addresses included in the first to m-th sub-micro instructions of the i-th sub-micro instruction set.

58. The PIM system of claim 45,
wherein when the third macro instruction is transmitted, and t bits among the bits of the channel mask included in the third macro instruction have the first binary value, and the broadcast bit included in the third macro instruction has the second binary value, the instruction decoder and sequencer is configured to output m×t local memory instructions and m×t micro instructions,
wherein each of the m×t local memory instructions includes a local memory command and a local memory address, and
wherein each of the m×t micro instructions includes an operation type, a channel mask, a column address, and a broadcast bit.

59. The PIM system of claim 58,
wherein the local memory command included in each of the m×t local memory instructions is a read command for the local memory,
wherein the local memory addresses included in the m×t local memory instructions sequentially increase using the local memory address included in the third macro instruction as a start address, with increments defined by the local memory increment size,
wherein the operation type included in each of the m×t micro instructions is the second operation type,
wherein the column addresses included in the m×t micro instructions sequentially increase using the column address included in the third macro instruction as a start column address, and
wherein the broadcast bit included in each of the m×t micro instructions is identical to the broadcast bit included in the third macro instruction.

60. The PIM system of claim 59,
wherein the m×t micro instructions each further include a channel mask,
wherein the m×t channel masks are divided into first to m-th groups, and
wherein each of the first to m-th groups includes t channel masks each having first to j-th bits.

61. The PIM system of claim 60,
wherein among the t channel masks included in each of the first to m-th groups, the i-th channel mask (where i is a natural number from 1 to j) included in each of the first to m-th groups is composed of an identical binary stream.

62. The PIM system of claim 61,
wherein among the first to j-th bits included in the i-th channel mask included in each of the first to m-th groups, the channel bit corresponding to the i-th bit has the first binary value, and
wherein among the first to j-th bits included in the i-th channel mask included in each of the first to m-th groups, remaining bits excluding the channel bit are all set to the second binary value.

63. The PIM system of claim 62,
wherein the local memory outputs the data stored at storage locations designated by the local memory addresses included in the m×t local memory instructions as m×t local memory data, and transmits the m×t local memory data to the multicast interconnect.

64. The PIM system of claim 63,
wherein the multicast interconnect generates the one or more sub-micro instruction sets based on the m×t local memory data and the m×t micro instructions,
wherein the number of sub-micro instruction sets generated from the multicast interconnect is identical to the number of the m×t micro instructions.

65. The PIM system of claim 64,
wherein when the m×t micro instructions and the m×t local memory instructions are transmitted, the multicast interconnect is configured to generate m×t sub-micro instruction sets,
wherein the m×t sub-micro instruction sets include “(n−1)×j+i”-th sub-micro instruction sets, where n is a natural number from 1 to m.

66. The PIM system of claim 65,
wherein each of the “(n−1)×j+i”-th sub-micro instruction sets includes an operation type, local memory data, and a column address.

67. The PIM system of claim 66,
wherein the operation type included in each of the “(n−1)×j+i”-th sub-micro instruction sets is designated as the second operation type,
wherein the local memory data included in each of the “(n−1)×j+i”-th sub-micro instruction sets is identical to the “(n−1)×j+i”-th local memory data among the first to m-th local memory data, and
wherein the column addresses included in each of the “(n−1)×j+i”-th sub-micro instruction sets are identical to the column addresses included in the “(n−1)×j+i”-th micro instructions among the first to m-th micro instructions.

68. The PIM system of claim 65,
wherein the multicast interconnect is configured to transmit the “(n−1)×j+i”-th sub-micro instruction sets to the i-th PIM controller among the first to j-th PIM controllers through the i-th channel among the first to j-th channels.

69. The PIM system of claim 68,
wherein the i-th PIM controller generates the “(n−1)×j+i”-th PIM command sets based on the “(n−1)×j+i”-th sub-micro instruction sets and transmits the “(n−1)×j+i”-th PIM command sets to the i-th PIM device among the first to j-th PIM devices through the i-th channel.

70. The PIM system of claim 68,
wherein each of the “(n−1)×j+i”-th PIM command sets includes an operation type, local memory data, and a column address,
wherein the operation types included in each of the “(n−1)×j+i”-th PIM command sets are designated as the second operation type,
wherein the local memory data included in each of the “(n−1)×j+i”-th PIM command sets are identical to the local memory data included in the “(n−1)×j+i”-th sub-micro instruction sets, and
wherein the column addresses included in each of the “(n−1)×j+i”-th PIM command sets are identical to the column addresses included in the “(n−1)×j+i”-th sub-micro instruction sets.

71. The PIM system of claim 19,
wherein the fourth macro instruction includes the third operation type, a channel mask, a local memory address, and a MAC latch ID,
wherein the channel mask included in the fourth macro instruction includes first to j-th bits respectively corresponding to the first to j-th channels,
wherein the local memory address included in the fourth macro instruction designates a starting storage location of the local memory where bias data is stored,
and wherein the MAC latch ID included in the fourth macro instruction designates a latch circuit where the bias data is latched.

72. The PIM system of claim 71,
wherein when the fourth macro instruction is transmitted, the instruction decoder and sequencer is configured to output first to j-th local memory instructions and first to j-th micro instructions,
wherein each of the first to j-th local memory instructions includes a local memory command and a local memory address,
and wherein each of the first to j-th micro instructions includes an operation type, a channel mask, and a MAC latch ID.

73. The PIM system of claim 72,
wherein the local memory command included in each of the first to j-th local memory instructions is a read command for the local memory,
wherein the local memory addresses included in the first to j-th local memory instructions sequentially increase starting from the local memory address included in the fourth macro instruction,
wherein the operation type included in each of the first to j-th micro instructions is the third operation type, and
wherein the MAC latch ID included in each of the first to j-th micro instructions is identical to the MAC latch ID included in the fourth macro instruction.

74. The PIM system of claim 73,
wherein the first to j-th micro instructions each include a first to j-th channel mask,
wherein each of the first to j-th channel masks includes first to j-th bits,
wherein, in the i-th channel mask among the first to j-th channel masks, the i-th bit among the first to j-th bits has a binary value identical to the i-th bit of the channel mask included in the fourth macro instruction, and
wherein all bits other than the i-th bit among the first to j-th bits are set to the second binary value.

75. The PIM system of claim 74,
wherein the local memory outputs the bias data stored in storage locations designated by the local memory addresses included in the first to j-th local memory instructions as first to j-th local memory data and transmits the data to the multicast interconnect.

76. The PIM system of claim 75,
wherein the multicast interconnect generates and outputs one or more sub-micro instruction sets based on the first to j-th micro instructions and the first to j-th local memory data,
wherein the number of the sub-micro instruction sets output from the multicast interconnect is identical to the number of channel masks among the first to j-th micro instructions that have a channel bit set to the first binary value.

77. The PIM system of claim 76,
wherein when the channel bit of the channel mask included in the i-th micro instruction among the first to j-th micro instructions has the first binary value, the multicast interconnect is configured to generate an i-th sub-micro instruction set, and
wherein when the channel bit of the channel mask included in the i-th micro instruction among the first to j-th micro instructions has the second binary value, the multicast interconnect is configured not to generate the i-th sub-micro instruction set.

78. The PIM system of claim 77,
wherein the i-th sub-micro instruction set includes an operation type, local memory data, and a MAC latch ID.

79. The PIM system of claim 78,
wherein the operation type included in the i-th sub-micro instruction is designated as the third operation type,
wherein the local memory data included in the i-th sub-micro instruction is identical to the i-th local memory data among the first to j-th local memory data, and
wherein the MAC latch ID included in the i-th sub-micro instruction is identical to the MAC latch ID included in the i-th micro instruction.

80. The PIM system of claim 77,
wherein when the i-th sub-micro instruction set is generated from the multicast interconnect, the multicast interconnect is configured to transmit the i-th sub-micro instruction set to the i-th PIM controller among the first to j-th PIM controllers through the i-th channel among the first to j-th channels.

81. The PIM system of claim 80,
wherein the i-th PIM controller generates i-th PIM command sets based on the i-th sub-micro instruction sets and transmits the i-th PIM command sets to the i-th PIM device among the first to j-th PIM devices through the i-th channel.

82. The PIM system of claim 80,
wherein the i-th PIM command set includes an operation type, local memory data, and a MAC latch ID,
wherein the operation type included in the i-th PIM command set is designated as the third operation type,
wherein the local memory data included in the i-th PIM command set is identical to the local memory data included in the i-th sub-micro instruction set, and
wherein the MAC latch ID included in the i-th PIM command set is identical to the MAC latch ID included in the i-th sub-micro instruction set.
